(19) United States
(12) Patent Application Publication
(10) Pub. No.: US 2026/0023245 A1
(43) Pub. Date: Jan. 22, 2026

(54) IMAGING LENS SYSTEM

(71) Applicant: Samsung Electro-Mechanics Co., Ltd., Suwon-si (KR)

(72) Inventors: Ji Su LEE, Suwon-si (KR); Yong Joo JO, Suwon-si (KR)

(73) Assignee: Samsung Electro-Mechanics Co., Ltd., Suwon-si (KR)

(21) Appl. No.: 19/088,333

(22) Filed: Mar. 24, 2025

(30) Foreign Application Priority Data
Jul. 22, 2024 (KR) 10-2024-0096679

(51) Int. Cl. G02B 13/00; G02B 9/64

(52) U.S. Cl. CPC G02B 13/0045; G02B 9/64

(57) ABSTRACT

An imaging lens system includes a first lens having a positive refractive power, a second lens having a refractive power, a third lens having a positive refractive power, a fourth lens having a refractive power and a convex image-side surface in a paraxial region thereof, a fifth lens having a refractive power, a sixth lens having a refractive power, a seventh lens having a refractive power and a convex image-side surface in a paraxial region thereof, and an eighth lens having a refractive power, a convex object-side surface in a paraxial region thereof, and an image-side surface having an inflection point, wherein the first to eight lenses are sequentially arranged along an optical axis from an object side toward an imaging plane, and −5.0<f6/f<2.0, where f6 is a focal length of the sixth lens, and f is a focal length of the imaging lens system.

### CROSS-REFERENCE TO RELATED APPLICATIONS

This application claims the benefit under 35 USC 119(a) of Korean Patent Application No. 10-2024-0096679 filed on Jul. 22, 2024, in the Korean Intellectual Property Office, the entire disclosure of which is incorporated herein by reference for all purposes.

### BACKGROUND

### 1. Field

The present disclosure relates to an imaging lens system having reduced chromatic aberration.

### 2. Description of Related Art

A camera module may be mounted on an electronic device to capture a still image or record a moving image. For example, a camera module may be mounted on a mobile phone, a laptop, a game console, or other electronic device.

As the performance of electronic devices including camera modules increases, a need for camera modules having a high performance, a high resolution and a small size increases. For example, an image sensor of the camera module is gradually becoming larger in order to implement a high-resolution camera module. However, the enlargement of the image sensor not only interferes with a miniaturization of the camera module, but also increases aberrations of an imaging lens system of the camera module.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an imaging lens system includes a first lens having a positive refractive power, a second lens having a refractive power, a third lens having a positive refractive power, a fourth lens having a refractive power and a convex image-side surface in a paraxial region thereof, a fifth lens having a refractive power; a sixth lens having a refractive power, a seventh lens having a refractive power and a convex image-side surface in a paraxial region thereof, and an eighth lens having a refractive power, a convex object-side surface in a paraxial region thereof, and an image-side surface having an inflection point, wherein the first to eighth lenses are sequentially arranged in ascending numerical order along an optical axis of the imaging lens system from an object side of the imaging lens system toward an imaging plane of the imaging lens system, and the imaging lens system satisfies the conditional expression −5.0<f6/f<2.0, where f6 is a focal length of the sixth lens, and f is a focal length of the imaging lens system.

The first lens may have a convex object-side surface in a paraxial region thereof.

The second lens may have a convex object-side surface in a paraxial region thereof.

The third lens may have a convex object-side surface in a paraxial region thereof.

The fourth lens may have a concave object-side surface in a paraxial region thereof.

The fifth lens may have a convex object-side surface in a paraxial region thereof.

The sixth lens may have a convex object-side surface in a paraxial region thereof.

The sixth lens may have a convex image-side surface in a paraxial region thereof.

The seventh lens may have a concave object-side surface in a paraxial region thereof.

The image-side surface of the eighth lens may be concave in a paraxial region thereof.

In another general aspect, an imaging lens system includes a first lens, a second lens, a third lens, a fourth lens, a fifth lens, a sixth lens, a seventh lens, and an eighth lens sequentially arranged in ascending numerical order along an optical axis of the imaging lens system from an object side of the imaging lens system toward an imaging plane of the imaging lens system, wherein two adjacent lenses among the first to eighth lenses are bonded to each other, and the imaging lens system satisfies the conditional expression 0.36<sumAG/f<0.50, where sumAG is a sum of air gaps along the optical axis between the first to eighth lenses, and f is a focal length of the imaging lens system.

The first lens may have a convex object-side surface in a paraxial region thereof.

The second lens may have a convex object-side surface in a paraxial region thereof.

The third lens may have a convex object-side surface in a paraxial region thereof.

The fourth lens may have a concave object-side surface in a paraxial region thereof.

The fifth lens may have a convex object-side surface in a paraxial region thereof.

The sixth lens may have a convex object-side surface in a paraxial region thereof.

The sixth lens may have a convex image-side surface in a paraxial region thereof.

The seventh lens may have a concave object-side surface in a paraxial region thereof.

The seventh lens may have a convex image-side surface in a paraxial region thereof.

Other features and aspects will be apparent from the following detailed description, the drawings, and the claims.

### BRIEF DESCRIPTION OF DRAWINGS

FIG. 1 is a configuration diagram of an imaging lens system according to a first embodiment of the present disclosure.

FIG. 2 illustrates aberration curves of the imaging lens system illustrated in FIG. 1.

FIG. 3 is a configuration diagram of an imaging lens system according to a second embodiment of the present disclosure.

FIG. 4 illustrates aberration curves of the imaging lens system illustrated in FIG. 3.

FIG. 5 is a configuration diagram of an imaging lens system according to a third embodiment of the present disclosure.

FIG. 6 illustrates aberration curves of the imaging lens system illustrated in FIG. 5.

FIG. 7 is a configuration diagram of an imaging lens system according to a fourth embodiment of the present disclosure.

FIG. 8 illustrates aberration curves of the imaging lens system illustrated in FIG. 7.

FIG. 9 is a configuration diagram of an imaging lens system according to a fifth embodiment of the present disclosure.

FIG. 10 illustrates aberration curves of the imaging lens system illustrated in FIG. 9.

FIG. 11 is a configuration diagram of an imaging lens system according to a sixth embodiment of the present disclosure.

FIG. 12 illustrates aberration curves of the imaging lens system illustrated in FIG. 11.

FIG. 13 is a configuration diagram of an imaging lens system according to a seventh embodiment of the present disclosure.

FIG. 14 illustrates aberration curves of the imaging lens system illustrated in FIG. 13.

FIG. 15 is a configuration diagram of an imaging lens system according to an eighth embodiment of the present disclosure.

FIG. 16 illustrates aberration curves of the imaging lens system illustrated in FIG. 15.

FIG. 17 is a configuration diagram of an imaging lens system according to a ninth embodiment of the present disclosure.

FIG. 18 illustrates aberration curves of the imaging lens system illustrated in FIG. 17.

FIG. 19 is a configuration diagram of an imaging lens system according to a tenth embodiment of the present disclosure.

FIG. 20 illustrates aberration curves of the imaging lens system illustrated in FIG. 19.

FIG. 21 is a configuration diagram of an imaging lens system according to an eleventh embodiment of the present disclosure.

FIG. 22 illustrates aberration curves of the imaging lens system illustrated in FIG. 21.

FIG. 23 is a configuration diagram of an imaging lens system according to a twelfth embodiment of the present disclosure.

FIG. 24 illustrates aberration curves of the imaging lens system illustrated in FIG. 23.

FIG. 25 is a configuration diagram of an imaging lens system according to a thirteenth embodiment of the present disclosure.

FIG. 26 illustrates aberration curves of the imaging lens system illustrated in FIG. 25.

FIG. 27 is a configuration diagram of an imaging lens system according to a fourteenth embodiment of the present disclosure.

FIG. 28 illustrates aberration curves of the imaging lens system illustrated in FIG. 27.

FIG. 29 is a configuration diagram of an imaging lens system according to a fifteenth embodiment of the present disclosure.

FIG. 30 illustrates aberration curves of the imaging lens system illustrated in FIG. 29.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

In lens configuration diagrams in the figures of the present application, a thickness, a size, and a shape of a lens may be somewhat exaggerated for ease of explanation, and in particular, a spherical shape or an aspherical shape shown in the lens configuration diagram is only illustrative, and is not limited to the shape shown.

In the present specification, a first lens refers to a lens most adjacent to an object (or a subject), and an eighth lens refers to a lens most adjacent to an imaging plane (or an image sensor).

In the present specification, a radius of curvature of a surface of a lens or other element, a thickness of a lens or other element, a distance from an object-side surface of the first lens to an imaging plane (TTL), a distance from an image-side surface of the eighth lens to the imaging plane (BFL) an image height (IMG HT), a focal length of a lens or an imaging lens system, and an air gap between lenses or other elements are expressed in millimeters (mm). A field of view (FOV) of the imaging lens system is expressed in degrees. An f-number of the imaging lens system is a dimensionless quantity.

A thickness of an element, an air gap between elements, TTL, and BFL are measured along an optical axis of the lens.

Also, in the descriptions of a shape of a lens, a statement that one surface is convex means that a paraxial region of the one surface is convex, and a statement that one surface is concave means that a paraxial region of the one surface is concave.

Therefore, even when it is stated that one surface of a lens is convex, an edge portion of the surface may be concave. Similarly, even when it is stated that one surface of a lens is concave, an edge portion of the lens may be convex.

A paraxial region of a lens surface is a very narrow region of the lens surface near an optical axis of the lens surface.

In greater detail, a paraxial region of a lens surface is a central portion of the lens surface surrounding and including the optical axis of the lens surface in which light rays incident to the lens surface make a small angle θ to the optical axis, and the approximations sin θ˜θ, tan θ˜θ, and cos θ˜1 are valid.

An imaging lens system according to a first aspect of the present disclosure may include a plurality of lenses. For example, an imaging lens system according to the first aspect may include a first lens, a second lens, a third lens, a fourth lens, a fifth lens, a sixth lens, a seventh lens, and an eighth lens sequentially arranged in ascending numerical order along an optical axis of the imaging lens system from an object side of the imaging lens system toward an imaging plane of the imaging lens system.

The imaging lens system according to the first aspect may include a lens having a positive refractive power. For example, in the imaging lens system according to the first aspect, the first and third lens may have a positive refractive power.

The imaging lens system according to the first aspect may include a lens having a convex surface in a paraxial region thereof. For example, in the imaging lens system according to the first aspect, the fourth lens may have a convex image-side surface in a paraxial region thereof, the sixth lens may have a convex image-side surface in a paraxial region thereof, and the seventh lens may have a convex image-side surface in a paraxial region thereof.

The imaging lens system according to the first aspect may satisfy a conditional expression. For example, the imaging lens system according to the first aspect may satisfy the conditional expression −5.0<f6/f<2.0, where f6 is a focal length of the sixth lens, and f is a focal length of the imaging lens system.

An imaging lens system according to a second aspect of the present disclosure may include a plurality of lenses. For example, an imaging lens system according to an aspect may include a first lens, a second lens, a third lens, a fourth lens, a fifth lens, a sixth lens, a seventh lens, and an eighth lens sequentially arranged in ascending numerical order along an optical axis of the imaging lens system from an object side of the imaging lens system toward an imaging plane of the imaging lens system.

In the imaging lens system according to the second aspect, a pair of lenses may be bonded to each other. For example, in the imaging lens system according to the second aspect, an image-side surface of the first lens and an object-side surface of the second lens may be bonded to each other. As another example, in the imaging lens system according to the second aspect, an image-side surface of the second lens and an object-side surface of the third lens may be bonded to each other. As another example, in the imaging lens system according to the second aspect, an image-side surface of the fourth lens and an object-side surface of the fifth lens may be bonded to each other. The surfaces of the lenses that are bonded to each other may be spherical or aspherical, but the shapes of these surfaces are not limited thereto.

The imaging lens system according to the second aspect may satisfy a conditional expression. For example, the imaging lens system according to the second aspect may satisfy the conditional expression 0.36<sumAG/f<0.50, where sumAG is a sum of air gaps along the optical axis between the first to eighth lenses (i.e., a sum of a distance along the optical axis from an image-side surface of the first lens to an object-side surface of the second lens, a distance along the optical axis from an image-side surface of the second lens to an object-side surface of the third lens, a distance along the optical axis from an image-side of the third lens to an object-side surface of the fourth lens, a distance along the optical axis from an image-side surface of the fourth lens to an object-side surface of the fifth lens, a distance along the optical axis from an image-side surface of the fifth lens to an object-side surface of the sixth lens, a distance along the optical axis from an image-side surface of the sixth lens to an object-side surface of the seventh lens, and a distance along the optical axis from an image-side surface of the seventh lens to an object-side surface of the eighth lens), and f is a focal length of the imaging lens system.

In the imaging lens system according to the second aspect, the bonded lenses may have certain characteristics. For example, the bonded surfaces of the bonded lenses (i.e., the image-side surface of the first lens and the object-side surface of the second lens, or the image-side surface of the second lens and the object-side surface of the third lens, or the image-side surface of the fourth lens and the object-side surface of the fifth lens) may be aspherical or spherical.

Additionally, the bonded lenses may be bonded to each other by a specific material. For example, the bonded lenses may be bonded to each other by an adhesive having a specific refractive index. The refractive index of the adhesive may be greater than a smallest refractive index among the bonded lenses, and less than a largest refractive index among the bonded lenses. As a specific example, when the bonded lenses are the first lens and the second lens, and the refractive index of the first lens is less than the refractive index of the second lens, the refractive index of the adhesive may be greater than the refractive index of the first lens, and less than the refractive index of the second lens. The adhesive may be applied as an adhesive layer having a specific thickness. For example, a thickness of the adhesive layer may be in a range of 1.0 μm to 50 μm.

An imaging lens system according to a third aspect of the present disclosure may include first to eighth lenses sequentially arranged in ascending numerical order along an optical axis of the imaging lens system from an object side of the imaging lens system toward an imaging plane of the imaging lens system, and may satisfy any one or any combination of any two or more of the following Conditional Expressions 1 to 15:

$$5 < \vert Va - Vb \vert < 50 \qquad ( Conditional Expression 1 )$$

$$0.01 < \vert Na - Nb \vert < 0.3 \qquad ( Conditional Expression 2 )$$

$$0 \leq \vert fa / Va - fb / Vb \vert < 2. \qquad ( Conditional Expression 3 )$$

$$0.5 < f 1 / f < 2. \qquad ( Conditional Expression 4 )$$

$$- 3. < f 2 / f < - 1. \qquad ( Conditional Expression 5 )$$

$$0 < f 3 / f < 5. \qquad ( Conditional Expression 6 )$$

$$- 3. < f 4 / ( f \times 100 ) < 3. \qquad ( Conditional Expression 7 )$$

$$- 7. < 15 / f < 10. \qquad ( Conditional Expression 8 )$$

$$- 5. < f 6 / f < 2. \qquad ( Conditional Expression 9 )$$

$$- 8. < f 7 / f < 12 \qquad ( Conditional Expression 10 )$$

$$- 2. < f 8 / f < 0 \qquad ( Conditional Expression 11 )$$

$$1. < TTL / f < 2. \qquad ( Conditional Expression 12 )$$

$$0 < BFL / f < 1. \qquad ( Conditional Expression 13 )$$

$$0.5 < TTL / ( 2 \times IMG HT ) < 0.8 \qquad ( Conditional Expression 14 )$$

$$1. < f - number < 3. \qquad ( Conditional Expression 15 )$$

In the above Conditional Expressions 1 to 15, Va is an Abbe number of an object-side lens of the bonded lenses, Vb is an Abbe number of an image-side lens of the bonded lenses,

Na is a refractive index of the object-side lens of the bonded lenses, Nb is a refractive index of the image-side lens of the bonded lenses, fa is a focal length of the object-side lens of the bonded lenses, fb is a focal length of the image-side lens of the bonded lenses, f1 is a focal length of the first lens, f2 is a focal length of the second lens, f3 is a focal length of the third lens, f4 is a focal length of the fourth lens, f5 is a focal length of the fifth lens, f6 is a focal length of the sixth lens, f7 is a focal length of the seventh lens, f8 is a focal length of the eighth lens, f is a focal length of the imaging lens system, TTL is a distance along the optical axis from an object-side surface of the first lens to the imaging plane, BFL is a distance along the optical axis from an image-side surface of the eighth lens to the imaging plane, IMG HT is a height of an image on the imaging plane, and is equal to one half of a diagonal length of the imaging plane, and f-number is an f-number of the imaging lens system.

Among Conditional Expressions 1 to 15 described above, Conditional Expression 3 including Abbe numbers and refractive indexes of the bonded lenses is a numerical range for improving chromatic aberration of an imaging lens system. For example, it may be difficult to improve chromatic aberration of an imaging lens system that is out of the numerical range of 0≤|fa/Va−fb/Vb|<2.0 (Conditional Expression 3).

Among Conditional Expressions 1 to 15 described above, Conditional Expressions 12 to 14 including a focal length f of an imaging lens system are numerical ranges for miniaturization and manufacturability of the imaging lens system. For example, an imaging lens system that does not satisfy the conditional expressions 0.5<f1/f<2.0, 1.0<TTL/f<2.0, and 0<BFL/f<1.0 (Conditional Expressions 12 to 14) may be difficult to miniaturize or manufacture.

The ranges of Conditional Expressions 8 to 10 described above may be further limited as in the following Conditional Expressions 16 to 18, and an imaging lens system according to the third aspect may satisfy any one or any combination of any two or more of the following Conditional Expressions 16 to 18:

$$- 7. < f 5 / f < 3. \qquad ( Conditional Expression 16 )$$

$$0 < f 6 / f < 2. \qquad ( Conditional Expression 17 )$$

$$- 7. < f 7 / f < 0 \qquad ( Conditional Expression 18 )$$

An imaging lens system according to a fourth aspect of the present disclosure may include first to eighth lenses sequentially arranged in ascending numerical order along an optical axis of the imaging lens system from an object side of the imaging lens system toward an imaging plane of the imaging lens system, and may satisfy any one or any combination of any two of more of the following Conditional Expressions 19 to 24:

$$- 2. < f 1 / f 8 < - 0.6 \qquad ( Conditional Expression 19 )$$

$$- 2. < f 2 / f 3 < - 0.2 \qquad ( Conditional Expression 20 )$$

$$- 1.6 < f 5 / f 7 < 1.6 \qquad ( Conditional Expression 21 )$$

$$- 2.4 < f 6 / f 8 < 4.6 \qquad ( Conditional Expression 22 )$$

$$- 2.6 < f 1 / f 8 + f 5 / f 7 < - 0.1 \qquad ( Conditional Expression 23 )$$

$$- 2.6 < f 2 / f 3 + f 6 / f 8 < - 1.6 \qquad ( Conditional Expression 24 )$$

The ranges of Conditional Expressions 19 to 22 described above may be further limited as in the following Conditional Expressions 25 to 28, and the imaging lens system according to the fourth aspect may satisfy any one or any combination of any two or more of the following Conditional Expressions 25 to 28:

$$- 1.8 < f 1 / f 8 < - 1.2 \qquad ( Conditional Expression 25 )$$

$$- 1.6 < f 2 / f 3 < - 0.4 \qquad ( Conditional Expression 26 )$$

$$- 0.4 < f 5 / f 7 < 1.2 \qquad ( Conditional Expression 27 )$$

$$- 1.4 < f 6 / f 8 < - 0.8 \qquad ( Conditional Expression 28 )$$

Conditional Expressions 25 to 28 described above are numerical ranges for limiting sizes of refractive powers of the first to third lenses and the fifth to eighth lenses. For example, lenses out of the numerical ranges of Conditional Expressions 25 to 28 may have too high or too low a refractive power, which may interfere with miniaturization of the imaging lens system.

An imaging lens system according to a fifth aspect of the present disclosure may include first to eighth lenses sequentially arranged in ascending numerical order along an optical axis of the imaging lens system from an object side of the imaging lens system toward an imaging plane of the imaging lens system and may satisfy any one or any combination of any two or more of the following Conditional Expressions 29 to 31:

$$- 4.20 < ( R 2 + R 3 + R 4 ) / ( R 7 + R 8 + R 9 ) < - 0.4 \qquad ( Conditional Expression 29 )$$

$$- 1. < ( R 2 + R 4 + R 8 ) / ( R 3 + R 5 + R 9 ) < 1. \qquad ( Conditional Expression 30 )$$

$$0.06 < ( R 2 - R 3 + R 4 - R 5 ) / ( R 8 + R 9 ) < 2.0 \qquad ( Conditional Expression 31 )$$

In the above Conditional Expressions 29 to 31, R2 is a radius of curvature of an image-side surface of the first lens, R3 is a radius of curvature of an object-side surface of the second lens, R4 is a radius of curvature of an image-side surface of the second lens, R5 is a radius of curvature of an object-side surface of the third lens, R7 is a radius of curvature of an object-side surface of the fourth lens, R8 is a radius of curvature of an image-side surface of the fourth lens, and R9 is a radius of curvature of an object-side surface of the fifth lens.

Conditional Expressions 29 to 31 described above may be numerical ranges for limiting sizes of the radiuses of curvature of the first to fifth lenses. For example, first to fifth lenses that are out of the numerical ranges of Conditional Expressions 29 to 31 described above may have a minimal effect on improving chromatic aberration.

An imaging lens system according to a sixth aspect of the present disclosure may include first to eighth lenses sequentially arranged in ascending numerical order along an optical axis of the imaging lens system from an object side of the imaging lens system toward an imaging plane of the imaging lens system and may satisfy any one or any combination of any two or more of the following Conditional Expressions 32 to 35:

$$0.4 < ( AG 12 + AG 23 ) / T 2 < 1.2 \qquad ( Conditional Expression 32 )$$

$$2.1 < TL 12 / ( T 1 + T 2 ) + TL 23 / ( T 2 + T 3 ) < 2.4 \qquad ( Conditional Expression 33 )$$

$$0.3 < sumAG / TTL < 0.40 \qquad ( Conditional Expression 34 )$$

$$0.36 < sumAG / f < 0.50 \qquad ( Conditional Expression 35 )$$

In the above Conditional Expressions 32 to 35, AG12 is an air gap along the optical axis between the first lens and second lens (i.e., a distance along the optical axis from an image-side surface of the first lens to an object-side surface of the second lens), AG23 is an air gap along the optical axis between the second lens and third lens (i.e., a distance along the optical axis from an image-side surface of the second lens to an object-side surface of the third lens), TL12 is a distance along the optical axis from an object-side surface of the first lens to the image side of the second lens, TL23 is a distance along the optical axis from the object-side surface of the second lens to an image-side surface of the third lens, T1 is a thickness of the first lens, T2 is a thickness of the second lens, and T3 is a thickness of the third lens.

Conditional Expressions 32 to 35 described above are numerical ranges for miniaturization and reducing chromatic aberration of the imaging lens system. For example, an imaging lens system that is out of the numerical ranges of Conditional Expressions 32 to 35 may be difficult to miniaturize or to improve chromatic aberration.

An imaging lens system according to a seventh aspect of the present disclosure may be configured to include two or more of the characteristics according to the first to sixth aspects.

For example, an imaging lens system according to the seventh aspect may satisfy any one or any combination of any two or more of the Conditional Expressions 1 to 35 according to the third to sixth aspects while including the characteristics of the first aspect.

As another example, an imaging lens system according to the seventh aspect may satisfy any one or any combination of any two or more Conditional Expressions 1 to 35 according to the third to sixth aspects while including the characteristics of the second aspect.

The imaging lens system according to the first to seventh aspects may include one or more lenses having the characteristics described below. For example, an imaging lens system according to the first aspect may include one of the first to eighth lenses having the characteristics described below. As another example, an imaging lens system according to the second aspect may include any combination of any two or more of the first to eighth lenses described below. However, the imaging lens system according to the above-described aspect may not necessarily include one of the first to eighth lenses described below. The characteristics of the first to eighth lenses are described below.

The first lens may have a refractive power. The first lens may have a positive refractive power. The first lens may have a convex shape in a paraxial region of one surface. For example, the first lens may have a convex object-side surface in a paraxial region thereof. The first lens may have an aspherical shape. For example, the first lens may have aspheric surfaces on both surfaces. The first lens may be made of a material having a high light transmittance and an excellent processability. For example, the first lens may be made of a glass material or a plastic material. The first lens may have characteristics advantageous for aberration improvement. For example, the first lens may have a refractive index of 1.5 or greater and an Abbe number of 65 or greater.

The second lens may have a refractive power. For example, the second lens may have a negative refractive power. The second lens may have a convex shape in a paraxial region of one surface. For example, the second lens may have a convex object-side surface in a paraxial region thereof. The second lens may have an aspherical shape. For example, both surfaces of the second lens may be aspherical. The second lens may be made of a material having a high light transmittance and an excellent processability. For example, the second lens may be made of a glass material or a plastic material. The second lens may have a higher refractive index than the first and third to eighth lenses. For example, the second lens may have a refractive index of 1.7 or greater.

The third lens may have a refractive power. For example, the third lens may have a positive refractive power. The third lens may have a convex shape in a paraxial region of one surface. For example, the third lens may have a convex object-side surface in a paraxial region thereof. The third lens may have an aspherical shape. For example, both surfaces of the third lens may be aspherical. The third lens may be made of a material having a high light transmittance and an excellent processability. For example, the third lens may be made of a glass material or a plastic material. The third lens may have characteristics advantageous for improving aberration. For example, the third lens may have a refractive index of 1.5 or more and an Abbe number of 50 or more.

The fourth lens may have a refractive power. For example, the fourth lens may have a positive refractive power or a negative refractive power. The fourth lens may have a concave shape in a paraxial region of one surface. For example, the fourth lens may have a concave object-side surface in a paraxial region thereof. The fourth lens may have an aspherical shape. For example, both surfaces of the fourth lens may be aspherical. The fourth lens may be made of a material having a high light transmittance and an excellent processability. For example, the fourth lens may be made of a glass material or a plastic material. The fourth lens may have characteristics advantageous for improving aberration. For example, the fourth lens may have a refractive index of 1.65 or more and an Abbe number of 28 or more.

The fifth lens may have a refractive power. For example, the fifth lens may have a positive refractive power or a negative refractive power. The fifth lens may have a concave shape in a paraxial region of one surface. For example, the fifth lens may have a concave object-side surface in a paraxial region thereof or a concave image-side surface in a paraxial region thereof. The fifth lens may have an aspherical shape. For example, both surfaces of the fifth lens may be aspherical. The fifth lens may be made of a material having a high light transmittance and an excellent processability. For example, the fifth lens may be made of a glass material or a plastic material. The fifth lens may have characteristics advantageous for improving aberration. For example, the fifth lens may have a refractive index of 1.5 or more and an Abbe number of 35 or more.

The sixth lens may have a refractive power. For example, the sixth lens may have a positive refractive power or a negative refractive power. The sixth lens may have a convex shape in a paraxial region of one surface. For example, the sixth lens may have a convex object-side surface in a paraxial region thereof or a convex image-side surface in a paraxial region thereof. The sixth lens may have an aspherical shape. For example, both surfaces of the sixth lens may be aspherical. The sixth lens may be made of a material having a high light transmittance and an excellent processability. For example, the sixth lens may be made of a glass material or a plastic material. The sixth lens may have characteristics advantageous for improving aberration. For example, the sixth lens may have a refractive index of 1.5 or more and an Abbe number of 50 or more.

The seventh lens may have a refractive power. For example, the seventh lens may have a positive refractive power or a negative refractive power. The seventh lens may have a convex shape in a paraxial region of one surface. For example, the seventh lens may have a convex image-side surface in a paraxial region thereof. The seventh lens may have an aspherical shape. For example, both surfaces of the seventh lens may be aspherical. The seventh lens may be made of a material having a high light transmittance and an excellent processability. For example, the seventh lens may be made of a glass material or a plastic material. The seventh lens may have characteristics advantageous for improving aberration. For example, the seventh lens may have a refractive index of 1.65 or more.

The eighth lens may have a refractive power. For example, the eighth lens may have a negative refractive power. The eighth lens may have a convex shape in a paraxial region of one surface. For example, the eighth lens may have a convex object-side surface in a paraxial region thereof. The eighth lens may have an aspherical shape. For example, both surfaces of the eighth lens may be aspherical. The eighth lens may have a shape having an inflection point. For example, an inflection point may be made on at least one surface of an object-side surface and an image-side surface of the eighth lens. The eighth lens may be made of a material having a high light transmittance and an excellent processability. For example, the eighth lens may be made of a glass material or a plastic material. The eighth lens may have characteristics advantageous for improving aberration. For example, the eighth lens may have a refractive index of 1.5 or more and an Abbe number of 50 or more.

An aspherical surface of a lens of an imaging lens system may be expressed by Equation 1 below.

$$Z = \frac{{cY}^{2}}{1 + \sqrt{1 - ( 1 + K ) {C}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} + {LY}^{22} + {MY}^{24} + {NY}^{26} + {OY}^{28} + {PY}^{30} … \qquad Equation 1$$

In Equation 1, c is a curvature of the lens surface and is equal to a reciprocal of a radius of curvature of the lens surface at an optical axis of the lens surface, K is a conic constant, and Y is a distance from any point on the aspherical surface of the lens to the optical axis. In addition, constants A to H, J, and L to P are aspherical surface coefficients. Z (also known as sag) is a distance in a direction parallel to an optical axis direction between the point on the aspherical surface of the lens at the distance Y from the optical axis of the aspherical surface to a tangential plane perpendicular to the optical axis and intersecting a vertex of the aspherical surface.

The imaging lens system may include a stop (not shown in the drawings), an imaging plane, and a filter.

The stop may be disposed between two lenses of the imaging lens system. For example, the stop may be disposed between the third lens and the fourth lens. However, the position of the stop is not limited to between the third and fourth lenses.

The imaging plane is located at a point at which light refracted by the first to eighth lenses forms an image. The imaging plane may be formed on an image sensor. For example, the imaging plane may be formed on a surface of the image sensor or on an internal plane of the image sensor.

The filter may be disposed between the eighth lens and the imaging plane. The filter may block certain wavelengths of light. For example, the filter may block light in infrared wavelengths.

Hereinafter, embodiments of the present disclosure will be described in detail with reference to the attached drawings.

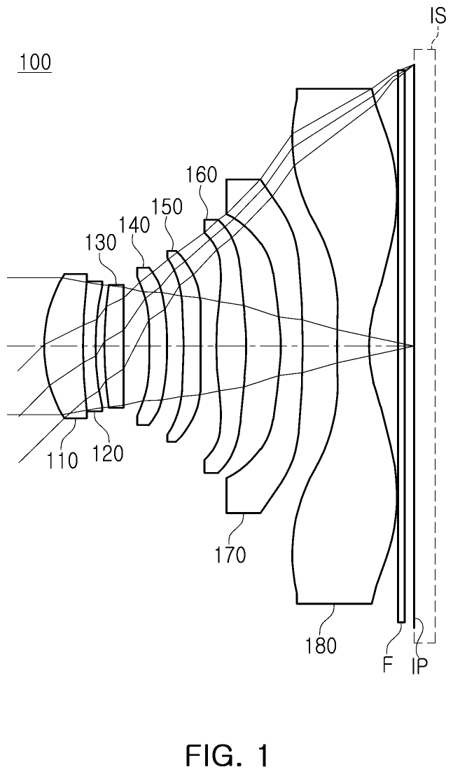

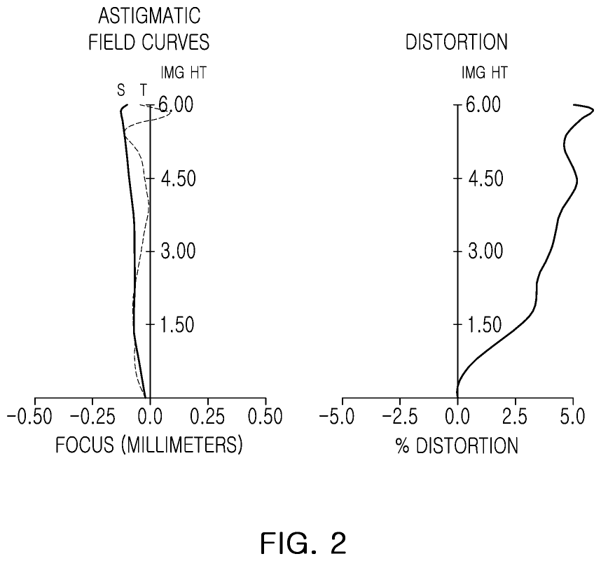

FIG. 1 is a configuration diagram of an imaging lens system according to a first embodiment of the present disclosure, and FIG. 2 illustrates aberration curves of the imaging lens system illustrated in FIG. 1.

Referring to FIG. 1, an imaging lens system 100 may include a first lens 110, a second lens 120, a third lens 130, a fourth lens 140, a fifth lens 150, a sixth lens 160, a seventh lens 170, and an eighth lens 180.

The first lens 110 may have a refractive power, a convex object-side surface in a paraxial region thereof and a concave image-side surface in a paraxial region thereof. The second lens 120 may have a negative refractive power, a convex object-side surface in a paraxial region thereof, and a concave image-side surface in a paraxial region thereof. The third lens 130 may have a positive refractive power, a convex object-side surface in a paraxial region thereof, and a concave image-side surface in a paraxial region thereof. The fourth lens 140 may have a positive refractive power, a concave object-side surface in a paraxial region thereof, and a convex image-side surface in a paraxial region thereof. The fifth lens 150 may have a negative refractive power, a convex object-side surface in a paraxial region thereof, and a concave image-side surface in a paraxial region thereof. The sixth lens 160 may have a positive refractive power, a convex object-side surface in a paraxial region thereof, and a convex image-side surface in a paraxial region thereof. The seventh lens 170 may have a negative refractive power, a concave object-side surface in a paraxial region thereof, and a convex image-side surface in a paraxial region thereof. The eighth lens 180 may have a negative refractive power, a convex object-side surface in a paraxial region thereof, and a concave image-side surface in a paraxial region thereof.

In the imaging lens system 100, the first lens 110 and the second lens 120 are bonded to each other. To elaborate, the image-side surface of the first lens 110 is in contact with and bonded to the object-side surface of the second lens 120.

The imaging lens system 100 may further include a filter IF and an imaging plane IP. The imaging plane IP may be formed on an image sensor IS, and the filter IF may be disposed between the eighth lens 180 and the imaging plane IP.

Tables 1 and 2 below list lens characteristics and aspherical values of the imaging lens system 100.

TABLE 1

| Sur- | | | | Refrac- | | |
|---|---|---|---|---|---|---|
| face | | Radius of | Thickness/ | tive | Abbe | Focal |
| No. | Component | Curvature | Distance | Index | No. | Length |
| S1 | 1st Lens | 2.92 | 0.805 | 1.511 | 67.6 | 7.240 |
| S2 | | 12.38 | 0.000 | | | |
| S3 | 2nd Lens | 12.38 | 0.260 | 1.720 | 24.3 | −15.290 |
| S4 | | 5.81 | 0.188 | | | |
| S5 | 3rd Lens | 9.50 | 0.408 | 1.570 | 62.4 | 17.500 |
| S6 | | 181.65 | 0.531 | | | |
| S7 | 4th Lens | −12.53 | 0.358 | 1.705 | 31.0 | 342.790 |
| S8 | | −12.05 | 0.330 | | | |
| S9 | 5th Lens | 12.38 | 0.364 | 1.567 | 37.4 | −30.460 |
| S10 | | 7.15 | 0.344 | | | |
| S11 | 6th Lens | 8.12 | 0.628 | 1.544 | 56.0 | 5.720 |
| S12 | | −4.94 | 0.714 | | | |
| S13 | 7th Lens | −4.75 | 0.463 | 1.671 | 19.2 | −29.450 |
| S14 | | −6.48 | 0.712 | | | |
| S15 | 8th Lens | 8.75 | 0.648 | 1.535 | 55.7 | −5.990 |
| S16 | | 2.29 | 0.500 | | | |
| S17 | Filter | Infinity | 0.142 | 1.517 | 64.2 | |
| S18 | | Infinity | 0.180 | | | |
| S19 | Imaging | Infinity | 0.020 | | | |
| | Plane | | | | | |

TABLE 2

| Surface No. | S1 | S2 | S3 | S4 | S5 | S6 | S7 | S8 |
|---|---|---|---|---|---|---|---|---|
| K | −1.827E+00 | 0 | 0 | 1.155E+01 | 1.701E+01 | −9.868E+01 | −9.117E+01 | −7.380E+01 |
| A | 1.515E−02 | 0 | 0 | 2.737E−02 | −2.972E−02 | −1.678E−02 | 3.552E−03 | −3.788E−02 |
| B | −3.684E−02 | 0 | 0 | −3.070E−01 | 2.240E−01 | 7.362E−02 | −2.753E−01 | 5.617E−02 |
| C | 1.033E−01 | 0 | 0 | 1.673E+00 | −1.224E+00 | −4.171E−01 | 1.274E+00 | −2.817E−01 |
| D | −1.627E−01 | 0 | 0 | −5.778E+00 | 4.472E+00 | 1.469E+00 | −3.695E+00 | 9.150E−01 |
| E | 1.488E−01 | 0 | 0 | 1.304E+01 | −1.150E+01 | −3.374E+00 | 7.135E+00 | −1.892E+00 |
| F | −7.083E−02 | 0 | 0 | −1.905E+01 | 2.129E+01 | 5.241E+00 | −9.570E+00 | 2.613E+00 |
| G | 2.272E−03 | 0 | 0 | 1.653E+01 | −2.871E+01 | −5.647E+00 | 9.141E+00 | −2.506E+00 |
| H | 1.926E−02 | 0 | 0 | −4.805E+00 | 2.827E+01 | 4.275E+00 | −6.295E+00 | 1.706E+00 |
| J | −1.307E−02 | 0 | 0 | −6.841E+00 | −2.025E+01 | −2.273E+00 | 3.130E+00 | −8.297E−01 |
| L | 4.612E−03 | 0 | 0 | 1.010E+01 | 1.041E+01 | 8.361E−01 | −1.113E+00 | 2.865E−01 |
| M | −9.929E−04 | 0 | 0 | −6.563E+00 | −3.739E+00 | −2.050E−01 | 2.761E−01 | −6.854E−02 |
| N | 1.311E−04 | 0 | 0 | 2.428E+00 | 8.891E−01 | 3.106E−02 | −4.541E−02 | 1.080E−02 |
| O | −9.787E−06 | 0 | 0 | −4.957E−01 | −1.257E−01 | −2.472E−03 | 4.463E−03 | −1.008E−03 |
| P | 3.173E−07 | 0 | 0 | 4.357E−02 | 7.991E−03 | 6.498E−05 | −1.992E−04 | 4.220E−05 |

| Surface No. | S9 | S10 | S11 | S12 | S13 | S14 | S15 | S16 |
|---|---|---|---|---|---|---|---|---|
| K | −2.576E+01 | 9.917E−02 | 3.425E+00 | −4.057E+00 | 2.104E−01 | −8.211E+00 | −2.390E+01 | −4.363E+00 |
| A | −7.139E−02 | −8.760E−02 | −1.118E−02 | 2.263E−02 | 2.711E−02 | 2.114E−02 | −4.150E−02 | −1.485E−02 |
| B | 1.143E−02 | 3.607E−02 | 1.721E−02 | 1.875E−02 | 2.517E−02 | 1.804E−02 | 3.651E−03 | 1.590E−03 |
| C | 8.485E−02 | −4.215E−02 | −3.283E−02 | −3.578E−02 | −4.350E−02 | −2.530E−02 | 1.052E−03 | −1.533E−05 |
| D | −2.188E−01 | 6.717E−02 | 3.164E−02 | 2.951E−02 | 2.925E−02 | 1.396E−02 | −4.469E−04 | −7.803E−05 |
| E | 3.206E−01 | −8.019E−02 | −1.935E−02 | −1.523E−02 | −1.213E−02 | −4.710E−03 | 9.154E−05 | 2.774E−05 |
| F | −3.153E−01 | 6.673E−02 | 8.015E−03 | 5.294E−03 | 3.456E−03 | 1.079E−03 | −1.253E−05 | −4.975E−06 |
| G | 2.165E−01 | −3.952E−02 | −2.340E−03 | −1.289E−03 | −7.098E−04 | −1.754E−04 | 1.214E−06 | 5.425E−07 |
| H | −1.055E−01 | 1.687E−02 | 4.929E−04 | 2.249E−04 | 1.072E−04 | 2.063E−05 | −8.442E−08 | −3.866E−08 |
| J | 3.669E−02 | −5.182E−03 | −7.550E−05 | −2.832E−05 | −1.192E−05 | −1.761E−06 | 4.206E−09 | 1.861E−09 |
| L | −9.036E−03 | 1.130E−03 | 8.347E−06 | 2.563E−06 | 9.620E−07 | 1.079E−07 | −1.485E−10 | −6.104E−11 |
| M | 1.540E−03 | −1.699E−04 | −6.487E−07 | −1.632E−07 | −5.473E−08 | −4.618E−09 | 3.620E−12 | 1.346E−12 |
| N | −1.728E−04 | 1.669E−05 | 3.354E−08 | 6.967E−09 | 2.076E−09 | 1.307E−10 | −5.789E−14 | −1.908E−14 |
| O | 1.149E−05 | −9.619E−07 | −1.033E−09 | −1.796E−10 | −4.707E−11 | −2.192E−12 | 5.464E−16 | 1.573E−16 |
| P | −3.428E−07 | 2.462E−08 | 1.431E−11 | 2.119E−12 | 4.821E−13 | 1.645E−14 | −2.306E−18 | −5.734E−19 |

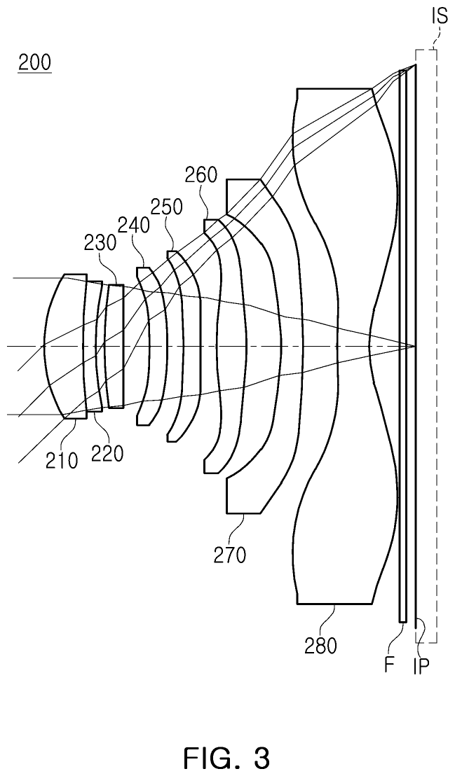

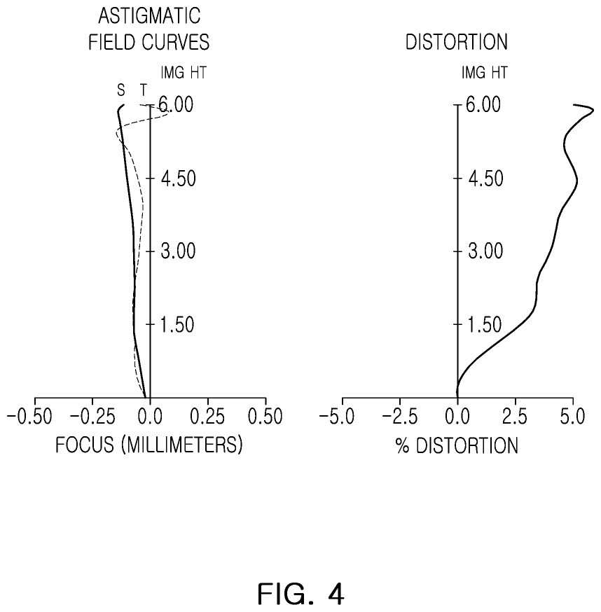

FIG. 3 is a configuration diagram of an imaging lens system according to a second embodiment of the present disclosure, and FIG. 4 illustrates aberration curves of the imaging lens system illustrated in FIG. 3.

Referring to FIG. 3, an imaging lens system 200 may include a first lens 210, a second lens 220, a third lens 230, a fourth lens 240, a fifth lens 250, a sixth lens 260, a seventh lens 270, and an eighth lens 280.

The first lens 210 may have a positive refractive power, a convex object-side surface in a paraxial region thereof, and a concave image-side surface in a paraxial region thereof. The second lens 220 may have a negative refractive power, a convex object-side surface in a paraxial region thereof, and a concave image-side surface in a paraxial region thereof. The third lens 230 may have a positive refractive power, a convex object-side surface in a paraxial region thereof, and a concave image-side surface in a paraxial region thereof. The fourth lens 240 may have a positive refractive power, a concave object-side surface in a paraxial region thereof, and a convex image-side surface in a paraxial region thereof. The fifth lens 250 may have a negative refractive power, a convex object-side surface in a paraxial region thereof, and a concave image-side surface in a paraxial region thereof. The sixth lens 260 may have a positive refractive power, a convex object-side surface in a paraxial region thereof, and a convex image-side surface in a paraxial region thereof. The seventh lens 270 may have a negative refractive power, a concave object-side surface in a paraxial region thereof, and a convex image-side surface in a paraxial region thereof. The eighth lens 280 may have a negative refractive power, a convex object-side surface in a paraxial region thereof, and a concave image-side surface in a paraxial region thereof.

In the imaging lens system 200, the first lens 210 and the second lens 220 are bonded to each other. To elaborate, the image-side surface of the first lens 210 is in contact with and bonded to the object-side surface of the second lens 220.

The imaging lens system 200 may further include a filter IF and an imaging plane IP. The imaging plane IP may be formed on an image sensor IS, and the filter IF may be disposed between the eighth lens 280 and the imaging plane IP.

Tables 3 and 4 below list lens characteristics and aspherical values of the imaging lens system 200.

TABLE 3

| Sur- | | | | Refrac- | | |
|---|---|---|---|---|---|---|
| face | | Radius of | Thickness/ | tive | Abbe | Focal |
| No. | Component | Curvature | Distance | Index | No. | Length |
| S1 | 1st Lens | 2.92 | 0.803 | 1.511 | 67.9 | 7.210 |
| S2 | | 12.57 | 0.000 | | | |
| S3 | 2nd Lens | 12.57 | 0.260 | 1.720 | 24.5 | −15.090 |
| S4 | | 5.81 | 0.187 | | | |
| S5 | 3rd Lens | 9.50 | 0.405 | 1.570 | 64.2 | 17.500 |
| S6 | | 181.36 | 0.531 | | | |
| S7 | 4th Lens | −12.54 | 0.356 | 1.707 | 30.9 | 349.650 |
| S8 | | −12.08 | 0.331 | | | |
| S9 | 5th Lens | 12.36 | 0.362 | 1.567 | 37.4 | −29.610 |
| S10 | | 7.06 | 0.344 | | | |
| S11 | 6th Lens | 7.94 | 0.632 | 1.544 | 56.0 | 5.680 |
| S12 | | −4.95 | 0.715 | | | |
| S13 | 7th Lens | −4.74 | 0.469 | 1.671 | 19.2 | −28.860 |
| S14 | | −6.49 | 0.714 | | | |
| S15 | 8th Lens | 8.70 | 0.649 | 1.535 | 55.7 | −6.000 |
| S16 | | 2.29 | 0.500 | | | |
| S17 | Filter | Infinity | 0.142 | 1.517 | 64.2 | |
| S18 | | Infinity | 0.179 | | | |
| S19 | Imaging | Infinity | 0.020 | | | |
| | Plane | | | | | |

TABLE 4

| Surface No. | S1 | S2 | S3 | S4 | S5 | S6 | S7 | S8 |
|---|---|---|---|---|---|---|---|---|
| K | −1.827E+00 | −7.002E−02 | −7.002E−02 | 1.155E+01 | 1.700E+01 | −4.129E−02 | −9.095E+01 | −7.403E+01 |
| A | 1.483E−02 | 1.205E−02 | 1.205E−02 | 3.275E−02 | −2.287E−02 | −1.374E−02 | 2.658E−03 | −3.995E−02 |
| B | −3.390E−02 | −2.060E−01 | −2.060E−01 | −3.885E−01 | 1.334E−01 | 3.707E−02 | −2.584E−01 | 7.932E−02 |
| C | 9.353E−02 | 1.381E+00 | 1.381E+00 | 2.226E+00 | −6.272E−01 | −2.075E−01 | 1.163E+00 | −3.853E−01 |
| D | −1.442E−01 | −4.923E+00 | −4.923E+00 | −7.952E+00 | 2.028E+00 | 7.381E−01 | −3.315E+00 | 1.179E+00 |
| E | 1.258E−01 | 1.028E+01 | 1.028E+01 | 1.847E+01 | −4.788E+00 | −1.694E+00 | 6.330E+00 | −2.328E+00 |
| F | −5.070E−02 | −1.241E+01 | −1.241E+01 | −2.808E+01 | 8.472E+00 | 2.590E+00 | −8.436E+00 | 3.108E+00 |
| G | −1.034E−02 | 6.311E+00 | 6.311E+00 | 2.661E+01 | −1.128E+01 | −2.701E+00 | 8.038E+00 | −2.905E+00 |
| H | 2.496E−02 | 4.641E+00 | 4.641E+00 | −1.218E+01 | 1.125E+01 | 1.936E+00 | −5.544E+00 | 1.937E+00 |
| J | −1.492E−02 | −1.127E+01 | −1.127E+01 | −3.637E+00 | −8.297E+00 | −9.422E−01 | 2.774E+00 | −9.271E−01 |
| L | 5.041E−03 | 9.939E+00 | 9.939E+00 | 9.637E+00 | 4.439E+00 | 2.981E−01 | −9.972E−01 | 3.158E−01 |
| M | −1.061E−03 | −5.078E+00 | −5.078E+00 | −6.864E+00 | −1.668E+00 | −5.421E−02 | 2.515E−01 | −7.469E−02 |
| N | 1.383E−04 | 1.574E+00 | 1.574E+00 | 2.621E+00 | 4.162E−01 | 3.235E−03 | −4.234E−02 | 1.166E−02 |
| O | −1.023E−05 | −2.756E−01 | −2.756E−01 | −5.414E−01 | −6.176E−02 | 5.681E−04 | 4.290E−03 | −1.079E−03 |
| P | 3.298E−07 | 2.102E−02 | 2.102E−02 | 4.774E−02 | 4.116E−03 | −8.391E−05 | −1.988E−04 | 4.483E−05 |

| Surface No. | S9 | S10 | S11 | S12 | S13 | S14 | S15 | S16 |
|---|---|---|---|---|---|---|---|---|
| K | −2.584E+01 | 1.147E−01 | 3.434E+00 | −4.064E+00 | 1.996E−01 | −8.191E+00 | −2.387E+01 | −4.359E+00 |
| A | −7.263E−02 | −8.738E−02 | −1.156E−02 | 2.237E−02 | 2.759E−02 | 2.125E−02 | −3.973E−02 | −1.277E−02 |
| B | 1.763E−02 | 3.439E−02 | 1.965E−02 | 2.136E−02 | 2.441E−02 | 1.638E−02 | 1.608E−03 | −3.150E−04 |
| C | 6.948E−02 | −3.804E−02 | −3.774E−02 | −4.133E−02 | −4.299E−02 | −2.294E−02 | 1.964E−03 | 7.536E−04 |
| D | −1.944E−01 | 6.258E−02 | 3.678E−02 | 3.513E−02 | 2.926E−02 | 1.239E−02 | −6.757E−04 | −2.565E−04 |
| F | 2.938E−01 | −7.761E−02 | −2.261E−02 | −1.862E−02 | −1.234E−02 | −4.093E−03 | 1.291E−04 | 5.415E−05 |
| F | −2.946E−01 | 6.615E−02 | 9.370E−03 | 6.631E−03 | 3.592E−03 | 9.184E−04 | −1.689E−05 | −7.611E−06 |
| G | 2.053E−01 | −3.967E−02 | −2.726E−03 | −1.653E−03 | −7.556E−04 | −1.463E−04 | 1.584E−06 | 7.254E−07 |
| H | −1.013E−01 | 1.702E−02 | 5.704E−04 | 2.949E−04 | 1.169E−04 | 1.685E−05 | −1.077E−07 | −4.761E−08 |
| J | 3.563E−02 | −5.238E−03 | −8.657E−05 | −3.795E−05 | −1.329E−05 | −1.408E−06 | 5.288E−09 | 2.170E−09 |
| L | −8.864E−03 | 1.142E−03 | 9.468E−06 | 3.503E−06 | 1.095E−06 | 8.443E−08 | −1.850E−10 | −6.851E−11 |
| M | 1.524E−03 | −1.715E−04 | −7.273E−07 | −2.268E−07 | −6.338E−08 | −3.528E−09 | 4.489E−12 | 1.467E−12 |
| N | −1.724E−04 | 1.682E−05 | 3.717E−08 | 9.798E−09 | 2.442E−09 | 9.719E−11 | −7.167E−14 | −2.035E−14 |
| O | 1.154E−05 | −9.682E−07 | −1.133E−09 | −2.543E−10 | −5.610E−11 | −1.580E−12 | 6.765E−16 | 1.648E−16 |
| P | −3.464E−07 | 2.476E−08 | 1.553E−11 | 3.005E−12 | 5.814E−13 | 1.142E−14 | −2.859E−18 | −5.916E−19 |

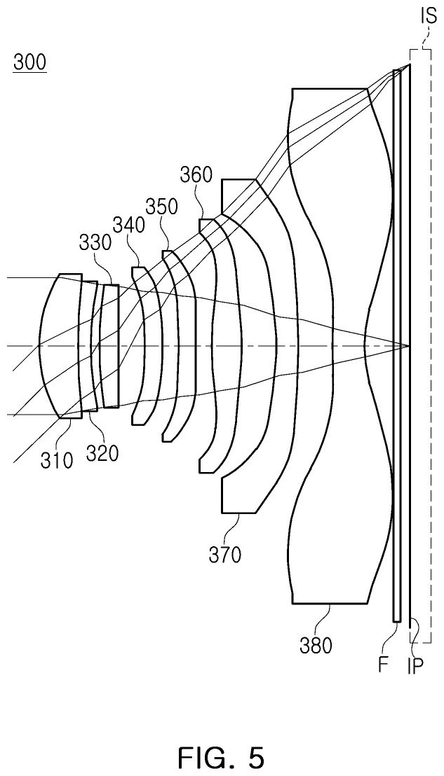

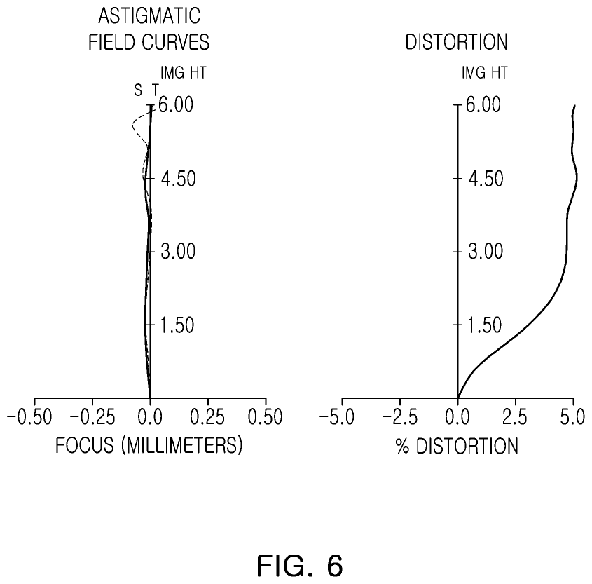

FIG. 5 is a configuration diagram of an imaging lens system according to a third embodiment of the present disclosure, and FIG. 6 illustrates aberration curves of the imaging lens system illustrated in FIG. 5.

Referring to FIG. 5, an imaging lens system 300 may include a first lens 310, a second lens 320, a third lens 330, a fourth lens 340, a fifth lens 350, a sixth lens 360, a seventh lens 370, and an eighth lens 380.

The first lens 310 may have a positive refractive power, a convex object-side surface in a paraxial region thereof, and a concave image-side surface in a paraxial region thereof. The second lens 320 may have a negative refractive power, a convex object-side surface in a paraxial region thereof, and a concave image-side surface in a paraxial region thereof. The third lens 330 may have a positive refractive power, a convex object-side surface in a paraxial region thereof, and a concave image-side surface in a paraxial region thereof. The fourth lens 340 may have a negative refractive power, a concave object-side surface in a paraxial region thereof, and a convex image-side surface in a paraxial region thereof. The fifth lens 350 may have a negative refractive power, a convex object-side surface in a paraxial region thereof, and a concave image-side surface in a paraxial region thereof. The sixth lens 360 may have a positive refractive power, a convex object-side surface in a paraxial region thereof, and a convex image-side surface in a paraxial region thereof. The seventh lens 370 may have a negative refractive power, a concave object-side surface in a paraxial region thereof, and a convex image-side surface in a paraxial region thereof. The eighth lens 380 may have a negative refractive power, a convex object-side surface in a paraxial region thereof, and a concave image-side surface in a paraxial region thereof.

In the imaging lens system 300, the second lens 320 and the third lens 330 are bonded to each other. To elaborate, the image-side surface of the second lens 320 is in contact with and bonded to the object-side surface of the third lens 330.

The imaging lens system 300 may further include a filter IF and an imaging plane IP. The imaging plane IP may be formed on an image sensor IS, and the filter IF may be disposed between the eighth lens 380 and the imaging plane IP.

Tables 5 and 6 below list lens characteristics and aspherical values of the imaging lens system 300.

TABLE 5

| Sur- | | | | Refrac- | | |
|---|---|---|---|---|---|---|
| face | | Radius of | Thickness/ | tive | Abbe | Focal |
| No. | Component | Curvature | Distance | Index | No. | Length |
| S1 | 1st Lens | 2.96 | 0.904 | 1.510 | 68.1 | 7.590 |
| S2 | | 11.10 | 0.210 | | | |
| S3 | 2nd Lens | 22.38 | 0.280 | 1.720 | 25.7 | −12.870 |
| S4 | | 6.56 | 0.000 | | | |
| S5 | 3rd Lens | 6.56 | 0.408 | 1.570 | 62.0 | 13.980 |
| S6 | | 35.78 | 0.463 | | | |
| S7 | 4th Lens | −37.11 | 0.418 | 1.698 | 31.0 | −486.940 |
| S8 | | −41.81 | 0.452 | | | |
| S9 | 5th Lens | 11.20 | 0.326 | 1.567 | 37.4 | −27.810 |
| S10 | | 6.50 | 0.327 | | | |
| S11 | 6th Lens | 7.88 | 0.793 | 1.544 | 56.0 | 5.250 |
| S12 | | −4.35 | 0.680 | | | |
| S13 | 7th Lens | −5.91 | 0.556 | 1.671 | 19.2 | −24.100 |
| S14 | | −9.60 | 0.748 | | | |
| S15 | 8th Lens | 15.70 | 0.456 | 1.535 | 55.7 | −5.760 |
| S16 | | 2.56 | 0.323 | | | |
| S17 | Filter | Infinity | 0.142 | 1.517 | 64.2 | |
| S18 | | Infinity | 0.309 | | | |
| S19 | Imaging | Infinity | 0.006 | | | |
| | Plane | | | | | |

TABLE 6

| Surface | | | | | | | | |
|---|---|---|---|---|---|---|---|---|
| No. | S1 | S2 | S3 | S4 | S5 | S6 | S7 | S8 |
| K | −2.204E+00 | −4.018E+01 | 2.158E+01 | 0 | 0 | 9.900E+01 | −5.871E+01 | −5.249E+01 |
| A | 1.470E−02 | 3.931E−03 | −1.946E−02 | 0 | 0 | −2.805E−02 | −3.232E−02 | −2.822E−02 |
| B | −2.254E−02 | −4.336E−02 | 1.340E−01 | 0 | 0 | 2.158E−01 | 2.164E−03 | −1.076E−02 |
| C | 5.140E−02 | 1.377E−01 | −6.787E−01 | 0 | 0 | −1.139E+00 | 2.902E−02 | 4.250E−02 |
| D | −7.847E−02 | −2.847E−01 | 2.135E+00 | 0 | 0 | 3.721E+00 | −2.081E−01 | −6.567E−02 |
| E | 8.025E−02 | 3.992E−01 | −4.460E+00 | 0 | 0 | −8.032E+00 | 6.928E−01 | 2.470E−02 |
| F | −5.501E−02 | −3.976E−01 | 6.477E+00 | 0 | 0 | 1.199E+01 | −1.467E+00 | 7.276E−02 |
| G | 2.407E−02 | 2.902E−01 | −6.714E+00 | 0 | 0 | −1.273E+01 | 2.104E+00 | −1.478E−01 |
| H | −5.515E−03 | −1.578E−01 | 5.035E+00 | 0 | 0 | 9.731E+00 | −2.098E+00 | 1.447E−01 |
| J | −2.392E−04 | 6.401E−02 | −2.737E+00 | 0 | 0 | −5.376E+00 | 1.470E+00 | −8.945E−02 |
| L | 6.085E−04 | −1.912E−02 | 1.067E+00 | 0 | 0 | 2.125E+00 | −7.220E−01 | 3.698E−02 |
| M | −2.019E−04 | 4.070E−03 | −2.907E−01 | 0 | 0 | −5.854E−01 | 2.431E−01 | −1.024E−02 |
| N | 3.419E−05 | −5.818E−04 | 5.245E−02 | 0 | 0 | 1.068E−01 | −5.347E−02 | 1.829E−03 |
| O | −3.069E−06 | 4.987E−05 | −5.627E−03 | 0 | 0 | −1.158E−02 | 6.918E−03 | −1.905E−04 |
| P | 1.160E−07 | −1.930E−06 | 2.714E−04 | 0 | 0 | 5.657E−04 | −3.993E−04 | 8.808E−06 |
| Surface | | | | | | | | |
| No. | S9 | S10 | S11 | S12 | S13 | S14 | S15 | S16 |
| K | −4.455E+01 | 2.220E+00 | 3.476E+00 | −4.585E+00 | −5.147E−01 | −3.140E+00 | −9.628E+01 | −4.278E+00 |
| A | −6.668E−02 | −6.710E−02 | 2.402E−02 | 4.984E−02 | 4.387E−02 | 2.613E−02 | −5.355E−02 | −2.190E−02 |
| B | 2.862E−02 | −2.603E−02 | −5.413E−02 | −2.671E−02 | −1.343E−02 | −3.327E−03 | 1.102E−02 | 3.029E−03 |
| C | −6.624E−02 | 4.531E−02 | 4.827E−02 | 1.391E−02 | −2.957E−04 | 9.623E−05 | −2.271E−03 | −3.248E−04 |
| D | 1.956E−01 | −1.138E−02 | −3.230E−02 | −8.731E−03 | 2.629E−03 | −1.338E−03 | 4.529E−04 | 4.308E−05 |
| E | −3.261E−01 | −2.828E−02 | 1.651E−02 | 4.517E−03 | −2.141E−03 | 9.330E−04 | −5.799E−05 | −7.418E−06 |
| F | 3.414E−01 | 3.886E−02 | −6.288E−03 | −1.592E−03 | 1.062E−03 | −3.151E−04 | 3.599E−06 | 1.008E−06 |
| G | −2.423E−01 | −2.636E−02 | 1.744E−03 | 3.657E−04 | −3.465E−04 | 6.583E−05 | 5.127E−08 | −9.067E−08 |
| H | 1.207E−01 | 1.141E−02 | −3.486E−04 | −5.303E−05 | 7.630E−05 | −9.239E−06 | −2.852E−08 | 5.368E−09 |
| J | −4.271E−02 | −3.360E−03 | 4.981E−05 | 4.304E−06 | −1.152E−05 | 8.990E−07 | 2.510E−09 | −2.118E−10 |
| L | 1.068E−02 | 6.828E−04 | −5.014E−06 | −7.466E−08 | 1.193E−06 | −6.097E−08 | −1.225E−10 | 5.542E−12 |
| M | −1.843E−03 | −9.444E−05 | 3.459E−07 | −2.171E−08 | −8.359E−08 | 2.831E−09 | 3.733E−12 | −9.320E−14 |
| N | 2.087E−04 | 8.502E−06 | −1.551E−08 | 2.305E−09 | 3.783E−09 | −8.585E−11 | −7.082E−14 | 9.299E−16 |
| O | −1.394E−05 | −4.496E−07 | 4.063E−10 | −1.000E−10 | −9.993E−11 | 1.532E−12 | 7.686E−16 | −4.526E−18 |
| P | 4.156E−07 | 1.061E−08 | −4.697E−12 | 1.694E−12 | 1.171E−12 | −1.219E−14 | −3.658E−18 | 5.155E−21 |

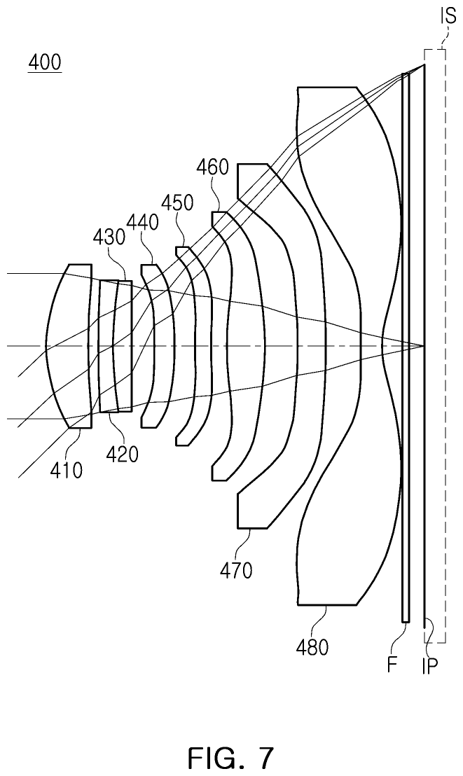

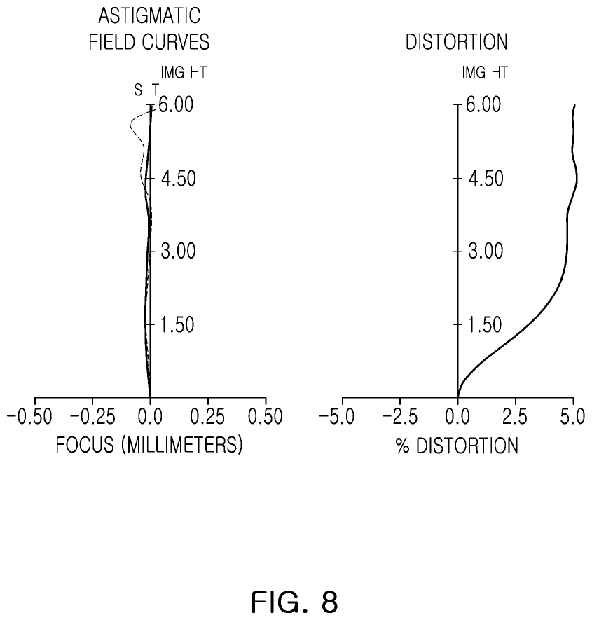

FIG. 7 is a configuration diagram of an imaging lens system according to a fourth embodiment of the present disclosure, and FIG. 8 illustrates aberration curves of the imaging lens system illustrated in FIG. 7.

Referring to FIG. 7, an imaging lens system 400 may include a first lens 410, a second lens 420, a third lens 430, a fourth lens 440, a fifth lens 450, a sixth lens 460, a seventh lens 470, and an eighth lens 480.

The first lens 410 may have a positive refractive power, a convex object-side surface in a paraxial region thereof, and a concave image-side surface in a paraxial region thereof. The second lens 420 may have a negative refractive power, a convex object-side surface in a paraxial region thereof, and a concave image-side surface in a paraxial region thereof. The third lens 430 may have a positive refractive power, a convex object-side surface in a paraxial region thereof, and a concave image-side surface in a paraxial region thereof. The fourth lens 440 may have a negative refractive power, a concave object-side surface in a paraxial region thereof, and a convex image-side surface in a paraxial region thereof. The fifth lens 450 may have a negative refractive power, a convex object-side surface in a paraxial region thereof, and a concave image-side surface in a paraxial region thereof. The sixth lens 460 may have a positive refractive power, a convex object-side surface in a paraxial region thereof, and a convex image-side surface in a paraxial region thereof. The seventh lens 470 may have a negative refractive power, a concave object-side surface in a paraxial region thereof, and a convex image-side surface in a paraxial region thereof. The eighth lens 480 may have a negative refractive power, a convex object-side surface in a paraxial region thereof, and a concave image-side surface in a paraxial region thereof.

In the imaging lens system 400, the second lens 420 and the third lens 430 are bonded to each other. To elaborate, the image-side surface of the second lens 420 is in contact with and bonded to the object-side surface of the third lens 430.

The imaging lens system 400 may further include a filter IF and an imaging plane IP. The imaging plane IP may be formed on an image sensor IS, and the filter IF may be disposed between the eighth lens 480 and the imaging plane IP.

Tables 7 and 8 below list lens characteristics and aspherical values of the imaging lens system 400.

TABLE 7

| Surface | | Radius of | Thickness/ | Refractive | Abbe | Focal |
|---|---|---|---|---|---|---|
| No. | Component | Curvature | Distance | Index | No. | Length |
| S1 | 1st Lens | 2.96 | 0.904 | 1.510 | 67.7 | 7.590 |
| S2 | | 11.10 | 0.210 | | | |
| S3 | 2nd Lens | 22.38 | 0.280 | 1.720 | 25.7 | −12.890 |
| S4 | | 6.57 | 0.000 | | | |
| S5 | 3rd Lens | 6.57 | 0.408 | 1.570 | 62.0 | 13.990 |
| S6 | | 35.81 | 0.463 | | | |
| S7 | 4th Lens | −37.15 | 0.418 | 1.698 | 31.1 | −488.500 |
| S8 | | −41.84 | 0.451 | | | |
| S9 | 5th Lens | 11.20 | 0.326 | 1.567 | 37.4 | −27.820 |
| S10 | | 6.50 | 0.327 | | | |
| S11 | 6th Lens | 7.88 | 0.793 | 1.544 | 56.0 | 5.250 |
| S12 | | −4.35 | 0.680 | | | |
| S13 | 7th Lens | −5.91 | 0.556 | 1.671 | 19.2 | −24.100 |
| S14 | | −9.60 | 0.748 | | | |
| S15 | 8th Lens | 15.70 | 0.455 | 1.535 | 55.7 | −5.750 |
| S16 | | 2.56 | 0.323 | | | |
| S17 | Filter | Infinity | 0.142 | 1.517 | 64.2 | |
| S18 | | Infinity | 0.308 | | | |
| S19 | Imaging | Infinity | 0.006 | | | |
| | Plane | | | | | |

TABLE 8

| Surface | | | | | | | | |
|---|---|---|---|---|---|---|---|---|
| No. | S1 | S2 | S3 | S4 | S5 | S6 | S7 | S8 |
| K | −2.204E+00 | −4.018E+01 | 2.158E+01 | 1.702E−03 | 1.702E−03 | 9.899E+01 | −5.871E+01 | −5.252E+01 |
| A | 1.473E−02 | 3.905E−03 | −1.946E−02 | 2.907E−03 | 2.907E−03 | −2.807E−02 | −3.230E−02 | −2.825E−02 |
| B | −2.286E−02 | −4.293E−02 | 1.340E−01 | −6.338E−02 | −6.338E−02 | 2.160E−01 | 1.788E−03 | −1.046E−02 |
| C | 5.260E−02 | 1.355E−01 | −6.793E−01 | 5.756E−01 | 5.756E−01 | −1.140E+00 | 3.135E−02 | 4.114E−02 |
| D | −8.099E−02 | −2.789E−01 | 2.138E+00 | −2.937E+00 | −2.937E+00 | 3.725E+00 | −2.162E−01 | −6.192E−02 |
| E | 8.359E−02 | 3.895E−01 | −4.468E+00 | 9.522E+00 | 9.522E+00 | −8.043E+00 | 7.109E−01 | 1.791E−02 |
| F | −5.800E−02 | −3.868E−01 | 6.491E+00 | −2.092E+01 | −2.092E+01 | 1.201E+01 | −1.495E+00 | 8.123E−02 |
| G | 2.593E−02 | 2.818E−01 | −6.731E+00 | 3.228E+01 | 3.228E+01 | −1.275E+01 | 2.134E+00 | −1.553E−01 |
| H | −6.346E−03 | −1.531E−01 | 5.050E+00 | −3.564E+01 | −3.564E+01 | 9.752E+00 | −2.122E+00 | 1.495E−01 |
| J | 2.744E−05 | 6.215E−02 | −2.746E+00 | 2.831E+01 | 2.831E+01 | −5.388E+00 | 1.484E+00 | −9.161E−02 |
| L | 5.475E−04 | −1.859E−02 | 1.071E+00 | −1.604E+01 | −1.604E+01 | 2.130E+00 | −7.279E−01 | 3.768E−02 |
| M | −1.922E−04 | 3.964E−03 | −2.918E−01 | 6.329E+00 | 6.329E+00 | −5.869E−01 | 2.448E−01 | −1.040E−02 |
| N | 3.316E−05 | −5.680E−04 | 5.265E−02 | −1.651E+00 | −1.651E+00 | 1.071E−01 | −5.380E−02 | 1.852E−03 |
| O | −3.005E−06 | 4.879E−05 | −5.649E−03 | 2.560E−01 | 2.560E−01 | −1.161E−02 | 6.956E−03 | −1.925E−04 |
| P | 1.141E−07 | −1.892E−06 | 2.725E−04 | −1.786E−02 | −1.786E−02 | 5.671E−04 | −4.012E−04 | 8.887E−06 |
| Surface | | | | | | | | |
| No. | S9 | S10 | S11 | S12 | S13 | S14 | S15 | S16 |
| K | −4.455E+01 | 2.220E+00 | 3.478E+00 | −4.586E+00 | −5.156E−01 | −3.119E+00 | −9.628E+01 | −4.279E+00 |
| A | −6.666E−02 | −6.715E−02 | 2.404E−02 | 4.983E−02 | 4.386E−02 | 2.613E−02 | −5.357E−02 | −2.192E−02 |
| B | 2.853E−02 | −2.578E−02 | −5.421E−02 | −2.669E−02 | −1.341E−02 | −3.347E−03 | 1.103E−02 | 3.090E−03 |
| C | −6.606E−02 | 4.465E−02 | 4.840E−02 | 1.389E−02 | −3.199E−04 | 1.132E−04 | −2.277E−03 | −3.647E−04 |
| D | 1.954E−01 | −1.038E−02 | −3.241E−02 | −8.717E−03 | 2.647E−03 | −1.346E−03 | 4.557E−04 | 5.588E−05 |
| E | −3.261E−01 | −2.926E−02 | 1.658E−02 | 4.511E−03 | −2.149E−03 | 9.358E−04 | −5.875E−05 | −9.845E−06 |
| F | 3.415E−01 | 3.952E−02 | −6.314E−03 | −1.589E−03 | 1.065E−03 | −3.158E−04 | 3.727E−06 | 1.307E−06 |
| G | −2.424E−01 | −2.666E−02 | 1.751E−03 | 3.651E−04 | −3.472E−04 | 6.594E−05 | 3.680E−08 | −1.157E−07 |
| H | 1.208E−01 | 1.151E−02 | −3.502E−04 | −5.291E−05 | 7.643E−05 | −9.251E−06 | −2.740E−08 | 6.835E−09 |
| J | −4.275E−02 | −3.385E−03 | 5.004E−05 | 4.289E−06 | −1.153E−05 | 9.001E−07 | 2.449E−09 | −2.727E−10 |
| L | 1.069E−02 | 6.871E−04 | −5.039E−06 | −7.324E−08 | 1.195E−06 | −6.102E−08 | −1.202E−10 | 7.326E−12 |
| M | −1.845E−03 | −9.496E−05 | 3.478E−07 | −2.180E−08 | −8.369E−08 | 2.833E−09 | 3.674E−12 | −1.292E−13 |
| N | 2.089E−04 | 8.544E−06 | −1.561E−08 | 2.309E−09 | 3.787E−09 | −8.589E−11 | −6.981E−14 | 1.407E−15 |
| O | −1.395E−05 | −4.516E−07 | 4.090E−10 | −1.001E−10 | −1.000E−10 | 1.532E−12 | 7.585E−16 | −8.257E−18 |
| P | 4.161E−07 | 1.065E−08 | −4.733E−12 | 1.695E−12 | 1.172E−12 | −1.219E−14 | −3.613E−18 | 1.821E−20 |

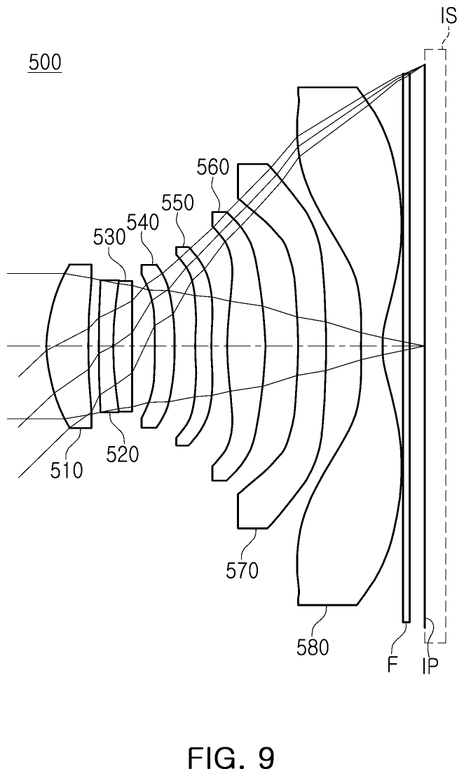

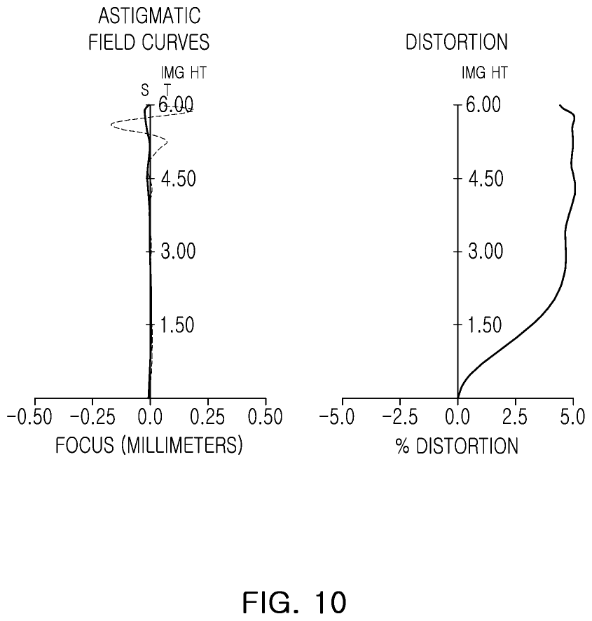

FIG. 9 is a configuration diagram of an imaging lens system according to a fifth embodiment of the present disclosure, and FIG. 10 illustrates aberration curves of the imaging lens system illustrated in FIG. 9.

An imaging lens system 500 may include a first lens 510, a second lens 520, a third lens 530, a fourth lens 540, a fifth lens 550, a sixth lens 560, a seventh lens 570, and an eighth lens 580.

The first lens 510 may have a positive refractive power, a convex object-side surface in a paraxial region thereof, and a concave image-side surface in a paraxial region thereof. The second lens 520 may have a negative refractive power, a convex object-side surface in a paraxial region thereof, and a concave image-side surface in a paraxial region thereof. The third lens 530 may have a positive refractive power, a convex object-side surface in a paraxial region thereof, and a convex image-side surface in a paraxial region thereof. The fourth lens 540 may have a positive refractive power, a concave object-side surface in a paraxial region thereof, and a convex image-side surface in a paraxial region thereof. The fifth lens 550 may have a negative refractive power, a concave object-side surface in a paraxial region thereof, and a concave image-side surface in a paraxial region thereof. The sixth lens 560 may have a positive refractive power, a convex object-side surface in a paraxial region thereof, and a convex image-side surface in a paraxial region thereof. The seventh lens 570 may have a negative refractive power, a concave object-side surface in a paraxial region thereof, and a convex image-side surface in a paraxial region thereof. The eighth lens 580 may have a negative refractive power, a convex object-side surface in a paraxial region thereof, and a concave image-side surface in a paraxial region thereof.

In the imaging lens system 500, the fourth lens 540 and the fifth lens 550 are bonded to each other. To elaborate, the image-side surface of the fourth lens 540 is in contact with and bonded to the object-side surface of the fifth lens 550.

The imaging lens system 500 may further include a filter IF and an imaging plane IP. The imaging plane IP may be formed on an image sensor IS, and the filter IF may be disposed between the eighth lens 580 and the imaging plane IP.

Tables 9 and 10 below list lens characteristics and aspherical values of the imaging lens system 500.

TABLE 9

| Surface | | Radius of | Thickness/ | Refractive | Abbe | Focal |
|---|---|---|---|---|---|---|
| No. | Component | Curvature | Distance | Index | No. | Length |
| S1 | 1st Lens | 2.55 | 0.849 | 1.547 | 64.7 | 6.330 |
| S2 | | 8.50 | 0.162 | | | |
| S3 | 2nd Lens | 11.74 | 0.250 | 1.720 | 24.4 | −15.220 |
| S4 | | 5.65 | 0.126 | | | |
| S5 | 3rd Lens | 8.22 | 0.405 | 1.570 | 62.0 | 12.830 |
| S6 | | −67.27 | 0.419 | | | |
| S7 | 4th Lens | −7.75 | 0.342 | 1.699 | 31.0 | 18.470 |
| S8 | | −4.94 | 0.000 | | | |
| S9 | 5th Lens | −4.94 | 0.516 | 1.541 | 54.6 | −9.050 |
| S10 | | 1051.25 | 0.279 | | | |
| S11 | 6th Lens | 9.12 | 0.372 | 1.544 | 56.0 | 5.900 |
| S12 | | −4.91 | 0.662 | | | |
| S13 | 7th Lens | −5.87 | 0.724 | 1.671 | 19.2 | −22.700 |
| S14 | | −9.97 | 0.676 | | | |
| S15 | 8th Lens | 13.29 | 0.622 | 1.535 | 55.7 | −4.880 |
| S16 | | 2.15 | 0.400 | | | |
| S17 | Filter | Infinity | 0.129 | 1.517 | 64.2 | |
| S18 | | Infinity | 0.186 | | | |
| S19 | Imaging | Infinity | 0.011 | | | |
| | Plane | | | | | |

TABLE 10

| Surface | | | | | | | | |
|---|---|---|---|---|---|---|---|---|
| No. | S1 | S2 | S3 | S4 | S5 | S6 | S7 | S8 |
| K | −2.213E+00 | −4.520E+01 | 3.210E+01 | 1.231E+01 | 1.424E+01 | −9.702E+01 | −5.117E+01 | 0 |
| A | 1.286E−02 | −6.677E−03 | −2.023E−02 | −7.925E−03 | −3.722E−03 | −1.479E−02 | −7.018E−02 | 0 |
| B | 1.814E−02 | 2.189E−02 | 6.866E−02 | −7.656E−02 | −2.570E−02 | 2.965E−02 | 1.878E−01 | 0 |
| C | −1.026E−01 | −1.274E−01 | −4.341E−01 | 8.351E−01 | 1.564E−01 | −7.253E−02 | −1.029E+00 | 0 |
| D | 2.985E−01 | 3.948E−01 | 1.954E+00 | −4.958E+00 | −5.764E−01 | −7.305E−02 | 3.877E+00 | 0 |
| E | −5.446E−01 | −7.867E−01 | −5.766E+00 | 1.925E+01 | 1.442E+00 | 1.150E+00 | −1.002E+01 | 0 |
| F | 6.632E−01 | 1.062E+00 | 1.158E+01 | −5.129E+01 | −2.564E+00 | −4.135E+00 | 1.819E+01 | 0 |
| G | −5.595E−01 | −1.003E+00 | −1.630E+01 | 9.629E+01 | 3.329E+00 | 8.635E+00 | 2.361E+01 | 0 |
| H | 3.333E−01 | 6.712E−01 | 1.633E+01 | −1.292E+02 | −3.207E+00 | −1.193E+01 | 2.215E+01 | 0 |
| J | −1.410E−01 | −3.189E−01 | −1.170E+01 | 1.243E+02 | 2.302E+00 | 1.135E+01 | −1.502E+01 | 0 |
| L | 4.197E−02 | 1.061E−01 | 5.942E+00 | −8.494E+01 | −1.213E+00 | −7.480E+00 | 7.288E+00 | 0 |
| M | 8.581E−03 | −2.400E−02 | −2.090E+00 | 4.024E+01 | 4.527E−01 | 3.357E+00 | −2.463E+00 | 0 |
| N | 1.144E−03 | 3.477E−03 | 4.841E−01 | −1.255E+01 | −1.122E−01 | −9.796E−01 | 5.507E−01 | 0 |
| O | −8.919E−05 | −2.866E−04 | −6.638E−02 | 2.318E+00 | 1.634E−02 | 1.675E−01 | −7.315E−02 | 0 |
| P | 3.078E−06 | 9.979E−06 | 4.082E−03 | −1.918E−01 | −1.037E−03 | −1.273E−02 | 4.372E−03 | 0 |
| Surface | | | | | | | | |
| No. | S9 | S10 | S11 | S12 | S13 | S14 | S15 | S16 |
| K | 0 | −9.449E+02 | −1.293E+01 | −9.696E+00 | −3.823E+00 | −1.447E+01 | −5.349E+01 | −5.283E+00 |
| A | 0 | −8.728E−02 | −2.543E−02 | 2.962E−02 | 3.487E−02 | 2.396E−02 | −8.555E−02 | −5.189E−02 |
| B | 0 | 8.510E−02 | 3.609E−02 | 7.451E−03 | 8.727E−03 | 8.425E−03 | 3.856E−02 | 2.327E−02 |
| C | 0 | −2.164E−01 | −6.493E−02 | −9.863E−03 | −3.456E−02 | −1.709E−02 | −1.453E−02 | −7.030E−03 |
| D | 0 | 3.965E−01 | 7.459E−02 | 7.017E−04 | 3.402E−02 | 1.085E−02 | 3.393E−03 | 1.366E−03 |
| E | 0 | −5.051E−01 | −6.088E−02 | 3.314E−03 | −2.057E−02 | −4.296E−03 | −4.381E−04 | −1.719E−04 |
| F | 0 | 4.564E−01 | 3.594E−02 | −2.395E−03 | 8.466E−03 | 1.183E−03 | 2.369E−05 | 1.376E−05 |
| G | 0 | −2.967E−01 | −1.532E−02 | 8.763E−04 | −2.449E−03 | −2.342E−04 | 1.421E−06 | −6.584E−07 |
| H | 0 | 1.396E−01 | 4.691E−03 | −2.006E−04 | 5.040E−04 | 3.372E−05 | −3.678E−07 | 1.513E−08 |
| J | 0 | −4.746E−02 | −1.026E−03 | 3.048E−05 | −7.384E−05 | −3.527E−06 | 3.261E−08 | 2.860E−11 |
| L | 0 | 1.151E−02 | 1.584E−04 | −3.111E−06 | 7.628E−06 | 2.649E−07 | −1.713E−09 | −4.527E−12 |
| M | 0 | −1.937E−03 | −1.680E−05 | 2.087E−07 | −5.421E−07 | −1.392E−08 | 5.782E−11 | −3.499E−13 |
| N | 0 | 2.143E−04 | 1.164E−06 | −8.656E−09 | 2.520E−08 | 4.858E−10 | −1.238E−12 | 2.124E−14 |
| O | 0 | −1.400E−05 | −4.733E−08 | 1.930E−10 | −6.894E−10 | −1.012E−11 | 1.542E−14 | −4.240E−16 |
| P | 0 | 4.081E−07 | 8.564E−10 | −1.594E−12 | 8.413E−12 | 9.535E−14 | −8.538E−17 | 3.049E−18 |

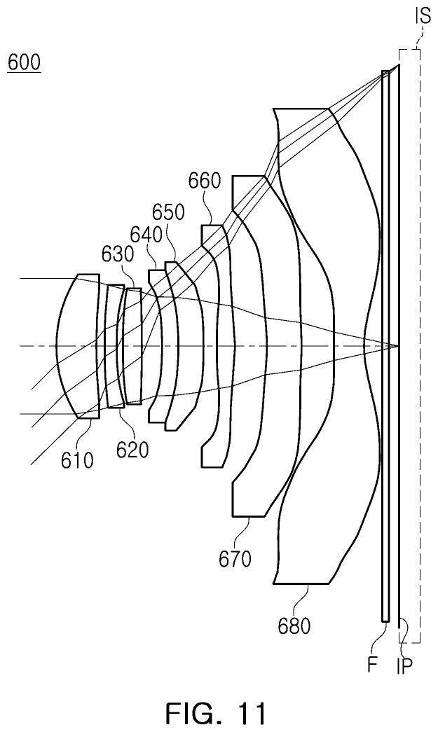

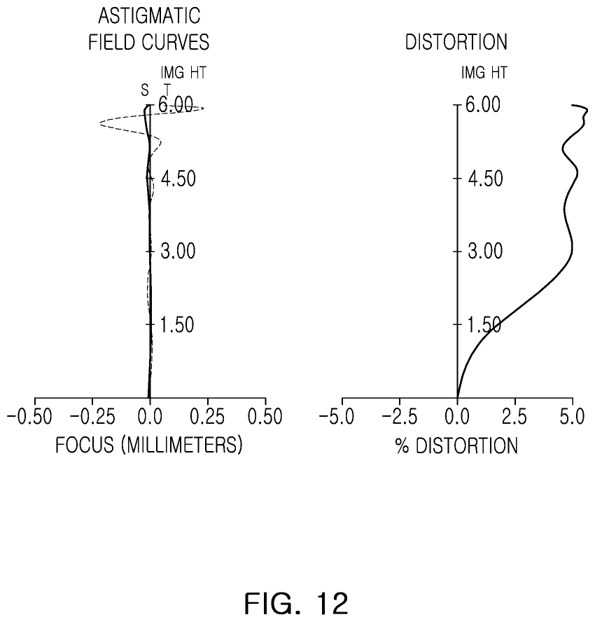

FIG. 11 is a configuration diagram of an imaging lens system according to a sixth embodiment of the present disclosure, and FIG. 12 illustrates aberration curves of the imaging lens system illustrated in FIG. 11.

Referring to FIG. 11, an imaging lens system 600 may include a first lens 610, a second lens 620, a third lens 630, a fourth lens 640, a fifth lens 650, a sixth lens 660, a seventh lens 670, and an eighth lens 680.

The first lens 610 may have a positive refractive power, a convex object-side surface in a paraxial region thereof, and a concave image-side surface in a paraxial region thereof. The second lens 620 may have a negative refractive power, a convex object-side surface in a paraxial region thereof, and a concave image-side surface in a paraxial region thereof. The third lens 630 may have a positive refractive power, a convex object-side surface in a paraxial region thereof, and a convex image-side surface in a paraxial region thereof. The fourth lens 640 may have a positive refractive power, a concave object-side surface in a paraxial region thereof, and a convex image-side surface in a paraxial region thereof. The fifth lens 650 may have a negative refractive power, a concave object-side surface in a paraxial region thereof, and a convex image-side surface in a paraxial region thereof. The sixth lens 660 may have a positive refractive power, a convex object-side surface in a paraxial region thereof, and a convex image-side surface in a paraxial region thereof. The seventh lens 670 may have a negative refractive power, a concave object-side surface in a paraxial region thereof, and a convex image-side surface in a paraxial region thereof. The eighth lens 680 may have a negative refractive power, a convex object-side surface in a paraxial region thereof, and a concave image-side surface in a paraxial region thereof.

In the imaging lens system 600 according to the present embodiment, the fourth lens 640 and the fifth lens 650 are bonded to each other. To elaborate, the image-side surface of the fourth lens 640 is in contact with and bonded to the object-side surface of the fifth lens 650.

The imaging lens system 600 may further include a filter IF and an imaging plane IP. The imaging plane IP may be formed on an image sensor IS, and the filter IF may be disposed between the eighth lens 680 and the imaging plane IP.

Tables 11 and 12 below list lens characteristics and aspherical values of the imaging lens system 600.

TABLE 11

| Surface | | Radius of | Thickness/ | Refractive | Abbe | Focal |
|---|---|---|---|---|---|---|
| No. | Component | Curvature | Distance | Index | No. | Length |
| S1 | 1st Lens | 2.55 | 0.850 | 1.543 | 65.2 | 6.370 |
| S2 | | 8.47 | 0.161 | | | |
| S3 | 2nd Lens | 11.70 | 0.251 | 1.720 | 24.3 | −15.240 |
| S4 | | 5.64 | 0.125 | | | |
| S5 | 3rd Lens | 8.20 | 0.399 | 1.570 | 62.0 | 12.780 |
| S6 | | −66.38 | 0.418 | | | |
| S7 | 4th Lens | −7.70 | 0.337 | 1.705 | 30.9 | 20.220 |
| S8 | | −5.11 | 0.000 | | | |
| S9 | 5th Lens | −5.11 | 0.515 | 1.538 | 53.0 | −9.520 |
| S10 | | −666.70 | 0.277 | | | |
| S11 | 6th Lens | 9.40 | 0.373 | 1.544 | 56.0 | 5.910 |
| S12 | | −4.86 | 0.666 | | | |
| S13 | 7th Lens | −6.13 | 0.716 | 1.671 | 19.2 | −21.860 |
| S14 | | −10.94 | 0.685 | | | |
| S15 | 8th Lens | 12.68 | 0.625 | 1.535 | 55.7 | −5.010 |
| S16 | | 2.18 | 0.400 | | | |
| S17 | Filter | Infinity | 0.129 | 1.517 | 64.2 | |
| S18 | | Infinity | 0.192 | | | |
| S19 | Imaging | Infinity | 0.008 | | | |
| | Plane | | | | | |

TABLE 12

| Surface | | | | | | | | |
|---|---|---|---|---|---|---|---|---|
| No. | S1 | S2 | S3 | S4 | S5 | S6 | S7 | S8 |
| K | −2.215E+00 | −4.508E+01 | 3.222E+01 | 1.229E+01 | 1.420E+01 | 6.228E+01 | −5.097E+01 | 7.073E−01 |
| A | 1.381E−02 | −5.332E−03 | −2.214E−02 | −1.067E−02 | 1.145E−03 | −2.149E−02 | −7.760E−02 | 9.364E−04 |
| B | 1.687E−02 | 5.067E−03 | 8.508E−02 | −1.388E−02 | −1.094E−01 | 1.204E−01 | 2.942E−01 | 1.135E−01 |
| C | −1.101E−01 | −3.908E−02 | −5.147E−01 | 1.832E−01 | 9.025E−01 | −6.920E−01 | −1.702E+00 | −6.473E−01 |
| D | 3.385E−01 | 1.229E−01 | 2.218E+00 | −9.665E−01 | −4.497E+00 | 2.515E+00 | 6.455E+00 | 1.779E+00 |
| E | −6.386E−01 | −2.444E−01 | −6.365E+00 | 3.433E+00 | 1.475E+01 | −6.032E+00 | −1.667E+01 | −2.973E+00 |
| F | 7.974E−01 | 3.254E−01 | 1.256E+01 | −8.628E+00 | −3.339E+01 | 9.745E+00 | 3.023E+01 | 3.140E+00 |
| G | −6.870E−01 | −3.006E−01 | −1.745E+01 | 1.553E+01 | 5.361E+01 | −1.057E+01 | −3.930E+01 | −1.965E+00 |
| H | 4.172E−01 | 1.958E−01 | 1.732E+01 | −2.011E+01 | −6.185E+01 | 7.351E+00 | 3.701E+01 | 4.553E−01 |
| J | −1.797E−01 | −8.957E−02 | −1.233E+01 | 1.871E+01 | 5.138E+01 | −2.720E+00 | −2.524E+01 | 3.326E−01 |
| L | 5.449E−02 | 2.817E−02 | 6.244E+00 | −1.237E+01 | −3.043E+01 | −9.913E−02 | 1.233E+01 | −3.662E−01 |
| M | −1.135E−02 | −5.802E−03 | −2.193E+00 | 5.669E+00 | 1.252E+01 | 6.470E−01 | −4.201E+00 | 1.671E−01 |
| N | 1.545E−03 | 7.108E−04 | 5.078E−01 | −1.710E+00 | −3.393E+00 | −3.186E−01 | 9.477E−01 | −4.287E−02 |
| O | −1.233E−04 | −4.117E−05 | −6.969E−02 | 3.050E−01 | 5.446E−01 | 7.136E−02 | −1.271E−01 | 6.038E−03 |
| P | 4.373E−06 | 3.833E−07 | 4.293E−03 | −2.437E−02 | −3.917E−02 | −6.424E−03 | 7.669E−03 | −3.650E−04 |
| Surface | | | | | | | | |
| No. | S9 | S10 | S11 | S12 | S13 | S14 | S15 | S16 |
| K | 7.073E−01 | 0.000E+00 | −1.259E+01 | −9.591E+00 | −3.846E+00 | −1.679E+01 | −5.284E+01 | −5.257E+00 |
| A | 9.364E−04 | −8.497E−02 | −2.291E−02 | 2.889E−02 | 3.437E−02 | 2.147E−02 | −8.665E−02 | −4.853E−02 |
| B | 1.135E−01 | 5.770E−02 | 2.637E−02 | 1.205E−02 | 1.042E−02 | 1.261E−02 | 4.012E−02 | 2.045E−02 |
| C | −6.473E−01 | −1.236E−01 | −4.585E−02 | −1.891E−02 | −3.587E−02 | −2.041E−02 | −1.559E−02 | −5.703E−03 |
| D | 1.779E+00 | 2.262E−01 | 5.190E−02 | 9.635E−03 | 3.411E−02 | 1.240E−02 | 3.793E−03 | 9.616E−04 |
| E | −2.973E+00 | −3.053E−01 | −4.297E−02 | −2.075E−03 | −2.017E−02 | −4.767E−03 | −5.338E−04 | −8.862E−05 |
| F | 3.140E+00 | 2.960E−01 | 2.617E−02 | −2.262E−04 | 8.188E−03 | 1.279E−03 | 3.924E−05 | 1.930E−06 |
| G | −1.965E+00 | −2.056E−01 | −1.155E−02 | 2.674E−04 | 2.352E−03 | −2.479E−04 | −3.563E−07 | 5.211E−07 |
| H | 4.553E−01 | 1.025E−01 | 3.649E−03 | −7.861E−05 | 4.825E−04 | 3.506E−05 | −2.223E−07 | −6.819E−08 |
| J | 3.326E−01 | −3.658E−02 | −8.196E−04 | 1.293E−05 | −7.062E−05 | −3.613E−06 | 2.405E−08 | 4.211E−09 |
| L | −3.662E−01 | 9.234E−03 | 1.292E−04 | −1.311E−06 | 7.299E−06 | 2.680E−07 | −1.355E−09 | −1.524E−10 |
| M | 1.671E−01 | −1.605E−03 | −1.395E−05 | 8.017E−08 | −5.194E−07 | −1.392E−08 | 4.742E−11 | 3.249E−12 |
| N | −4.287E−02 | 1.824E−04 | 9.796E−07 | −2.578E−09 | 2.419E−08 | 4.807E−10 | −1.039E−12 | −3.604E−14 |
| O | 6.038E−03 | −1.217E−05 | −4.028E−08 | 2.209E−11 | −6.629E−10 | −9.912E−12 | 1.317E−14 | 1.126E−16 |
| P | −3.650E−04 | 3.612E−07 | 7.352E−10 | 5.725E−13 | 8.106E−12 | 9.239E−14 | −7.404E−17 | 8.078E−19 |

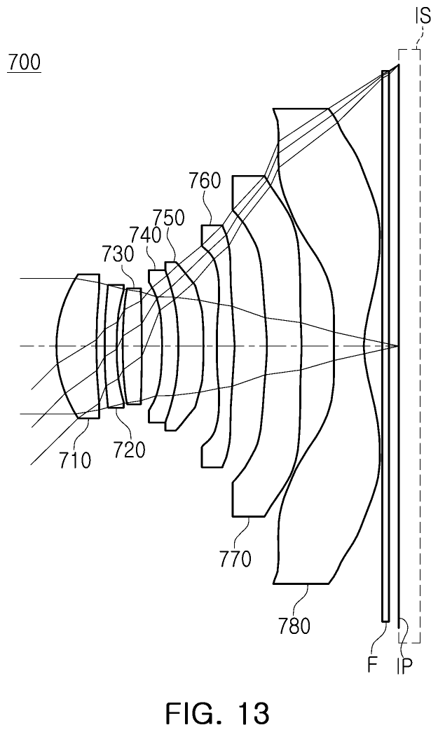

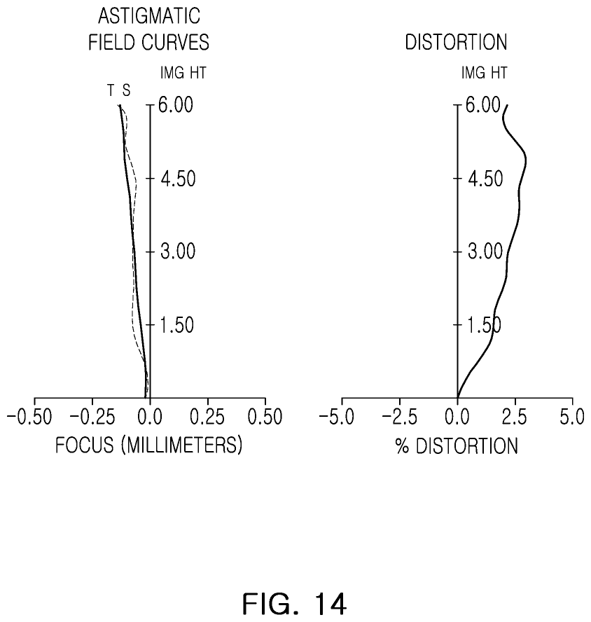

FIG. 13 is a configuration diagram of an imaging lens system according to a seventh embodiment of the present disclosure, and FIG. 14 illustrates aberration curves of the imaging lens system illustrated in FIG. 13.

Referring to FIG. 13, an imaging lens system 700 may include a first lens 710, a second lens 720, a third lens 730, a fourth lens 740, a fifth lens 750, a sixth lens 760, a seventh lens 770, and an eighth lens 780.

The first lens 710 may have a positive refractive power, a convex object-side surface in a paraxial region thereof, and a concave image-side surface in a paraxial region thereof. The second lens 720 may have a negative refractive power, a convex object-side surface in a paraxial region thereof, and a concave image-side surface in a paraxial region thereof. The third lens 730 may have a positive refractive power, a convex object-side surface in a paraxial region thereof, and a concave image-side surface in a paraxial region thereof. The fourth lens 740 may have a negative refractive power, a concave object-side surface in a paraxial region thereof, and a convex image-side surface in a paraxial region thereof. The fifth lens 750 may have a negative refractive power, a convex object-side surface in a paraxial region thereof, and a concave image-side surface in a paraxial region thereof. The sixth lens 760 may have a positive refractive power, a convex object-side surface in a paraxial region thereof, and a convex image-side surface in a paraxial region thereof. The seventh lens 770 may have a negative refractive power, a concave object-side surface in a paraxial region thereof, and a convex image-side surface in a paraxial region thereof. The eighth lens 780 may have a negative refractive power, a convex object-side surface in a paraxial region thereof, and a concave image-side surface in a paraxial region thereof.

In the imaging lens system 700 according to the present embodiment, the first lens 710 and the second lens 720 are bonded to each other. To elaborate, the image-side surface of the first lens 710 is in contact with and bonded to the object-side surface of the second lens 720.

The imaging lens system 700 may further include a filter IF and an imaging plane IP. The imaging plane IP may be formed on an image sensor IS, and the filter IF may be disposed between the eighth lens 780 and the imaging plane IP.

Tables 13 and 14 below list lens characteristics and aspherical values of the imaging lens system 700.

TABLE 13

| Surface | | Radius of | Thickness/ | Refractive | Abbe | Focal |
|---|---|---|---|---|---|---|
| No. | Component | Curvature | Distance | Index | No. | Length |
| S1 | 1st Lens | 3.36 | 0.878 | 1.521 | 66.1 | 7.760 |
| S2 | | 17.91 | 0.000 | | | |
| S3 | 2nd Lens | 17.91 | 0.280 | 1.720 | 25.7 | −14.920 |
| S4 | | 6.71 | 0.176 | | | |
| S5 | 3rd Lens | 11.02 | 0.423 | 1.570 | 51.0 | 20.490 |
| S6 | | 178.70 | 0.658 | | | |
| S7 | 4th Lens | −14.77 | 0.427 | 1.710 | 30.3 | −732.470 |
| S8 | | −15.38 | 0.457 | | | |
| S9 | 5th Lens | 12.76 | 0.396 | 1.567 | 37.4 | −25.570 |
| S10 | | 6.73 | 0.383 | | | |
| S11 | 6th Lens | 7.29 | 0.959 | 1.544 | 56.0 | 5.980 |
| S12 | | −5.65 | 0.778 | | | |
| S13 | 7th Lens | −5.08 | 0.545 | 1.671 | 19.2 | −36.500 |
| S14 | | −6.66 | 0.771 | | | |
| S15 | 8th Lens | 10.17 | 0.742 | 1.535 | 55.7 | −5.900 |
| S16 | | 2.35 | 0.575 | | | |
| S17 | Filter | Infinity | 0.163 | 1.517 | 64.2 | |
| S18 | | Infinity | 0.279 | | | |
| S19 | Imaging | Infinity | 0.020 | | | |
| | Plane | | | | | |

TABLE 14

| Surface | | | | | | | | |
|---|---|---|---|---|---|---|---|---|
| No. | S1 | S2 | S3 | S4 | S5 | S6 | S7 | S8 |
| K | −1.801E+00 | 0 | 0 | 1.146E+01 | 1.722E+01 | 8.838E+01 | −7.852E+01 | −8.228E+01 |
| A | 9.102E−03 | 0 | 0 | 1.930E−02 | −2.577E−03 | −1.262E−02 | −8.980E−03 | −2.340E−02 |
| B | −1.216E−02 | 0 | 0 | −1.768E−01 | −2.701E−02 | 5.298E−02 | −6.679E−02 | 2.520E−02 |
| C | 2.558E−02 | 0 | 0 | 7.789E−01 | 1.515E−01 | −2.303E−01 | 2.518E−01 | −7.733E−02 |
| D | −3.303E−02 | 0 | 0 | −2.206E+00 | −4.391E−01 | 6.050E−01 | −6.195E−01 | 1.610E−01 |
| E | 2.767E−02 | 0 | 0 | 4.280E+00 | 7.567E−01 | −1.040E+00 | 1.026E+00 | −2.301E−01 |
| F | −1.552E−02 | 0 | 0 | −5.916E+00 | −8.029E−01 | 1.226E+00 | −1.189E+00 | 2.300E−01 |
| G | 5.918E−03 | 0 | 0 | 5.966E+00 | 4.989E−01 | −1.016E+00 | 9.846E−01 | −1.640E−01 |
| H | −1.543E−03 | 0 | 0 | −4.438E+00 | −1.221E−01 | 5.996E−01 | −5.896E−01 | 8.447E−02 |
| J | 2.751E−04 | 0 | 0 | 2.435E+00 | −6.511E−02 | −2.520E−01 | 2.557E−01 | −3.145E−02 |
| L | −3.376E−05 | 0 | 0 | −9.743E−01 | 7.282E−02 | 7.442E−02 | −7.954E−02 | 8.375E−03 |
| M | 2.983E−06 | 0 | 0 | 2.763E−01 | −3.143E−02 | −1.495E−02 | 1.731E−02 | −1.553E−03 |
| N | −2.094E−07 | 0 | 0 | −5.262E−02 | 7.505E−03 | 1.921E−03 | −2.503E−03 | 1.900E−04 |
| O | 1.171E−08 | 0 | 0 | 6.030E−03 | −9.742E−04 | −1.393E−04 | 2.162E−04 | −1.379E−05 |
| P | −3.587E−10 | 0 | 0 | −3.140E−04 | 5.389E−05 | 4.167E−06 | −8.453E−06 | 4.488E−07 |
| Surface | | | | | | | | |
| No. | S9 | S10 | S11 | S12 | S13 | S14 | S15 | S16 |
| K | −2.768E+01 | 5.477E−01 | 3.339E+00 | −4.358E+00 | 3.434E−01 | −5.254E+00 | −2.684E+01 | −4.148E+00 |
| A | −5.301E−02 | −5.925E−02 | −2.542E−03 | 2.023E−02 | 2.315E−02 | 1.372E−02 | −5.323E−02 | −2.136E−02 |
| B | 3.659E−02 | 1.822E−02 | −1.202E−03 | 5.863E−04 | 5.211E−03 | 4.251E−03 | 1.724E−02 | 2.021E−03 |
| C | −4.207E−02 | −1.368E−02 | −2.962E−03 | −5.881E−03 | −1.244E−02 | −5.207E−03 | −4.037E−03 | 8.658E−04 |
| D | 4.827E−02 | 1.698E−02 | 3.887E−03 | 4.305E−03 | 7.682E−03 | 2.159E−03 | 6.780E−04 | −3.645E−04 |
| E | −4.220E−02 | −1.660E−02 | −2.433E−03 | −1.766E−03 | −2.914E−03 | −5.697E−04 | −8.120E−05 | 6.726E−05 |
| F | 2.652E−02 | 1.103E−02 | 9.368E−04 | 4.611E−04 | 7.605E−04 | 1.062E−04 | 6.973E−06 | −7.570E−06 |
| G | −1.208E−02 | −5.090E−03 | −2.435E−04 | −8.082E−05 | −1.417E−04 | −1.442E−05 | −4.327E−07 | 5.686E−07 |
| H | 4.039E−03 | 1.667E−03 | 4.449E−05 | 9.736E−06 | 1.907E−05 | 1.437E−06 | 1.950E−08 | −2.960E−08 |
| J | −9.912E−04 | −3.893E−04 | −5.798E−06 | −8.092E−07 | −1.853E−06 | −1.042E−07 | −6.381E−10 | 1.083E−09 |
| L | 1.762E−04 | 6.421E−05 | 5.357E−07 | 4.576E−08 | 1.284E−07 | 5.418E−09 | 1.500E−11 | −2.775E−11 |
| M | −2.200E−05 | −7.285E−06 | −3.421E−08 | −1.698E−09 | −6.174E−09 | −1.957E−10 | −2.468E−13 | 4.878E−13 |
| N | 1.819E−06 | 5.393E−07 | 1.433E−09 | 3.852E−11 | 1.956E−10 | 4.649E−12 | 2.703E−15 | −5.600E−15 |
| O | −8.907E−08 | −2.341E−08 | −3.533E−11 | −4.617E−13 | −3.669E−12 | −6.518E−14 | −1.770E−17 | 3.781E−17 |
| P | 1.946E−09 | 4.512E−10 | 3.881E−13 | 2.040E−15 | 3.084E−14 | 4.077E−16 | 5.249E−20 | −1.138E−19 |

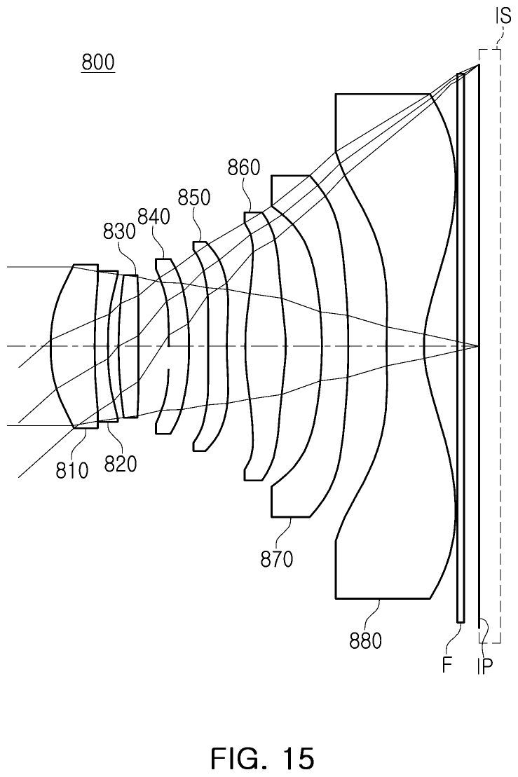

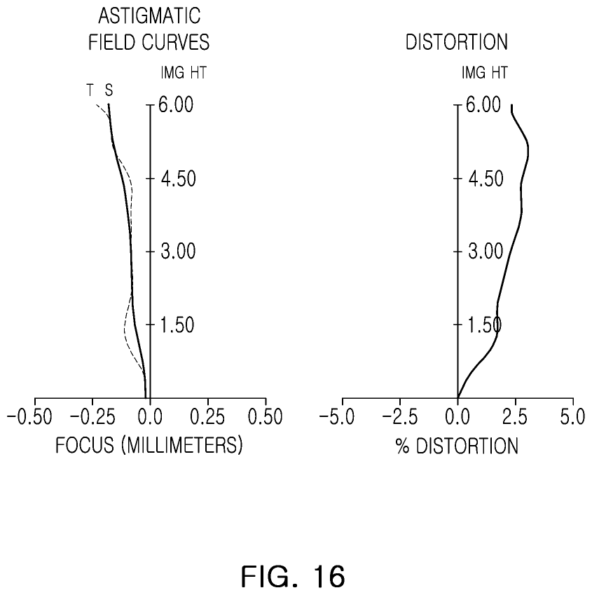

FIG. 15 is a configuration diagram of an imaging lens system according to an eighth embodiment of the present disclosure, and FIG. 16 illustrates aberration curves of the imaging lens system illustrated in FIG. 15.

Referring to FIG. 15, an imaging lens system 800 may include a first lens 810, a second lens 820, a third lens 830, a fourth lens 840, a fifth lens 850, a sixth lens 860, a seventh lens 870, and an eighth lens 880.

The first lens 810 may have a positive refractive power, a convex object-side surface in a paraxial region thereof, and a concave image-side surface in a paraxial region thereof. The second lens 820 may have a negative refractive power, a convex object-side surface in a paraxial region thereof, and a concave image-side surface in a paraxial region thereof. The third lens 830 may have a positive refractive power, a convex object-side surface in a paraxial region thereof, and a concave image-side surface in a paraxial region thereof. The fourth lens 840 may have a positive refractive power, a concave object-side surface in a paraxial region thereof, and a convex image-side surface in a paraxial region thereof. The fifth lens 850 may have a negative refractive power, a convex object-side surface in a paraxial region thereof, and a concave image-side surface in a paraxial region thereof. The sixth lens 860 may have a positive refractive power, a convex object-side surface in a paraxial region thereof, and a convex image-side surface in a paraxial region thereof. The seventh lens 870 may have a negative refractive power, a concave object-side surface in a paraxial region thereof, and a convex image-side surface in a paraxial region thereof. The eighth lens 880 may have a negative refractive power, a convex object-side surface in a paraxial region thereof, and a concave image-side surface in a paraxial region thereof.

In the imaging lens system 800 according to the present embodiment, the first lens 810 and the second lens 820 are bonded to each other. To elaborate, the image-side surface of the first lens 810 is in contact with and bonded to the object-side surface of the second lens 820.

The imaging lens system 800 may further include a filter IF and an imaging plane IP. The imaging plane IP may be formed on an image sensor IS, and the filter IF may be disposed between the eighth lens 880 and the imaging plane IP.

Tables 15 and 16 below list lens characteristics and aspherical values of the imaging lens system 800.

TABLE 15

| Surface | | Radius of | Thickness/ | Refractive | Abbe | Focal |
|---|---|---|---|---|---|---|
| No. | Component | Curvature | Distance | Index | No. | Length |
| S1 | 1st Lens | 3.36 | 0.914 | 1.512 | 67.1 | 8.220 |
| S2 | | 14.86 | 0.000 | | | |
| S3 | 2nd Lens | 14.86 | 0.282 | 1.720 | 25.0 | −16.930 |
| S4 | | 6.68 | 0.210 | | | |
| S5 | 3rd Lens | 10.93 | 0.419 | 1.570 | 58.4 | 20.290 |
| S6 | | 183.97 | 0.624 | | | |
| S7 | 4th Lens | −14.39 | 0.420 | 1.710 | 29.2 | 1313.070 |
| S8 | | −14.35 | 0.397 | | | |
| S9 | 5th Lens | 13.83 | 0.397 | 1.567 | 37.4 | −27.260 |
| S10 | | 7.25 | 0.382 | | | |
| S11 | 6th Lens | 7.68 | 0.826 | 1.544 | 56.0 | 6.120 |
| S12 | | −5.70 | 0.779 | | | |
| S13 | 7th Lens | −5.21 | 0.542 | 1.671 | 19.2 | −38.580 |
| S14 | | −6.78 | 0.785 | | | |
| S15 | 8th Lens | 8.51 | 0.766 | 1.535 | 55.7 | −5.940 |
| S16 | | 2.25 | 0.575 | | | |
| S17 | Filter | Infinity | 0.163 | 1.517 | 64.2 | |
| S18 | | Infinity | 0.280 | | | |
| S19 | Imaging | Infinity | 0.020 | | | |
| | Plane | | | | | |

TABLE 16

| Surface | | | | | | | | |
|---|---|---|---|---|---|---|---|---|
| No. | S1 | S2 | S3 | S4 | S5 | S6 | S7 | S8 |
| K | −1.826E+00 | 1.989E+00 | 1.989E+00 | 1.154E+01 | 1.698E+01 | −1.057E+02 | −8.908E+01 | −7.485E+01 |
| A | 8.886E−03 | 1.909E−02 | 1.909E−02 | 2.789E−02 | −3.916E−03 | −4.514E−03 | 2.923E−03 | −2.931E−02 |
| B | −1.364E−02 | −2.342E−01 | −2.342E−01 | −2.599E−01 | −5.149E−02 | −2.400E−02 | −1.456E−01 | 5.850E−02 |
| C | 3.118E−02 | 1.184E+00 | 1.184E+00 | 1.149E+00 | 3.759E−01 | 1.181E−01 | 5.401E−01 | −1.901E−01 |
| D | −4.185E−02 | −3.314E+00 | −3.314E+00 | −3.084E+00 | −1.342E+00 | −3.328E−01 | −1.283E+00 | 3.944E−01 |
| E | 3.476E−02 | 5.756E+00 | 5.756E+00 | 5.287E+00 | 2.916E+00 | 6.162E−01 | 2.051E+00 | −5.459E−01 |
| F | −1.810E−02 | −6.508E+00 | −6.508E+00 | −5.840E+00 | −4.190E+00 | −7.951E−01 | −2.296E+00 | 5.233E−01 |
| G | 5.621E−03 | 4.804E+00 | 4.804E+00 | 3.913E+00 | 4.157E+00 | 7.371E−01 | 1.841E+00 | −3.565E−01 |
| H | −7.755E−04 | −2.176E+00 | −2.176E+00 | −1.110E+00 | −2.909E+00 | −4.971E−01 | −1.071E+00 | 1.751E−01 |
| J | −1.081E−04 | 4.317E−01 | 4.317E−01 | −5.307E−01 | 1.444E+00 | 2.439E−01 | 4.519E−01 | −6.211E−02 |
| L | 7.201E−05 | 1.138E−01 | 1.138E−01 | 7.144E−01 | −5.043E−01 | −8.594E−02 | −1.370E−01 | 1.576E−02 |
| M | −1.507E−05 | −1.051E−01 | −1.051E−01 | −3.538E−01 | 1.208E−01 | 2.116E−02 | 2.908E−02 | −2.790E−03 |
| N | 1.689E−06 | 3.192E−02 | 3.192E−02 | 9.710E−02 | −1.882E−02 | −3.451E−03 | −4.098E−03 | 3.268E−04 |
| O | −1.013E−07 | −4.784E−03 | −4.784E−03 | −1.458E−02 | 1.710E−03 | 3.344E−04 | 3.446E−04 | −2.275E−05 |
| P | 2.568E−09 | 2.957E−04 | 2.957E−04 | 9.397E−04 | −6.835E−05 | −1.457E−05 | −1.309E−05 | 7.127E−07 |
| Surface | | | | | | | | |
| No. | S9 | S10 | S11 | S12 | S13 | S14 | S15 | S16 |
| K | −2.635E+01 | 2.924E−01 | 3.507E+00 | −4.010E+00 | 3.776E−01 | −7.627E+00 | −2.820E+01 | −4.284E+00 |
| A | −5.104E−02 | −5.601E−02 | −3.444E−03 | 1.708E−02 | 1.782E−02 | 1.423E−02 | −5.060E−02 | −1.726E−02 |
| B | 2.637E−02 | 9.439E−03 | −4.192E−04 | 5.269E−03 | 1.555E−02 | 7.452E−03 | 1.688E−02 | 9.599E−04 |
| C | −1.510E−02 | −1.102E−04 | −2.477E−03 | −1.091E−02 | −2.252E−02 | −8.618E−03 | −4.248E−03 | 7.907E−04 |
| D | 2.968E−03 | 3.140E−03 | 2.708E−03 | 7.854E−03 | 1.330E−02 | 3.831E−03 | 7.758E−04 | −2.728E−04 |
| E | 8.054E−03 | −6.915E−03 | −1.529E−03 | −3.416E−03 | −4.899E−03 | −1.058E−03 | −1.010E−04 | 4.567E−05 |
| F | −1.145E−02 | 6.237E−03 | 5.329E−04 | 9.802E−04 | 1.234E−03 | 2.003E−04 | 9.393E−06 | −4.776E−06 |
| G | 8.006E−03 | −3.372E−03 | −1.253E−04 | −1.943E−04 | −2.204E−04 | −2.704E−05 | −6.278E−07 | 3.365E−07 |
| H | −3.530E−03 | 1.214E−03 | 2.085E−05 | 2.728E−05 | 2.835E−05 | 2.639E−06 | 3.032E−08 | −1.650E−08 |
| J | 1.049E−03 | −3.018E−04 | −2.510E−06 | −2.741E−06 | −2.628E−06 | −1.863E−07 | −1.058E−09 | 5.695E−10 |
| L | −2.136E−04 | 5.196E−05 | 2.184E−07 | 1.964E−07 | 1.737E−07 | 9.411E−09 | 2.636E−11 | −1.379E−11 |
| M | 2.951E−05 | −6.078E−06 | −1.337E−08 | −9.809E−09 | −7.979E−09 | −3.307E−10 | −4.578E−13 | 2.291E−13 |
| N | −2.650E−06 | 4.603E−07 | 5.444E−10 | 3.255E−10 | 2.418E−10 | 7.666E−12 | 5.261E−15 | −2.487E−15 |
| O | 1.398E−07 | −2.033E−08 | −1.316E−11 | −6.459E−12 | −4.344E−12 | −1.053E−13 | −3.596E−17 | 1.588E−17 |
| P | −3.293E−09 | 3.973E−10 | 1.424E−13 | 5.813E−14 | 3.504E−14 | 6.478E−16 | 1.107E−19 | −4.520E−20 |

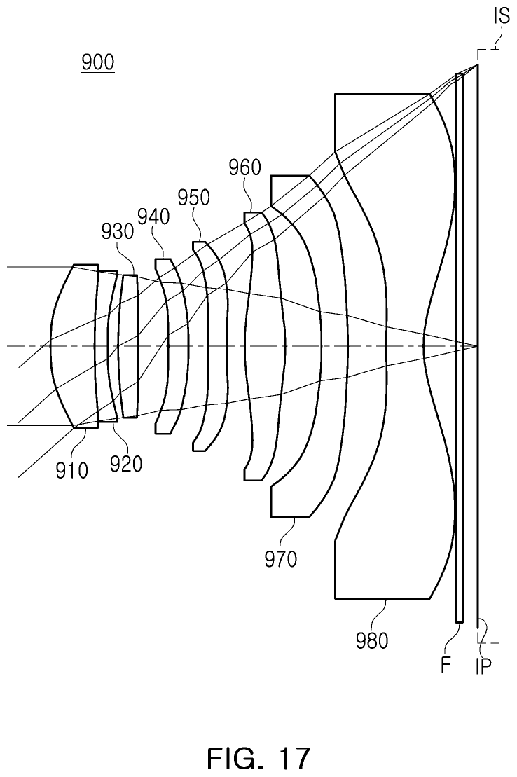

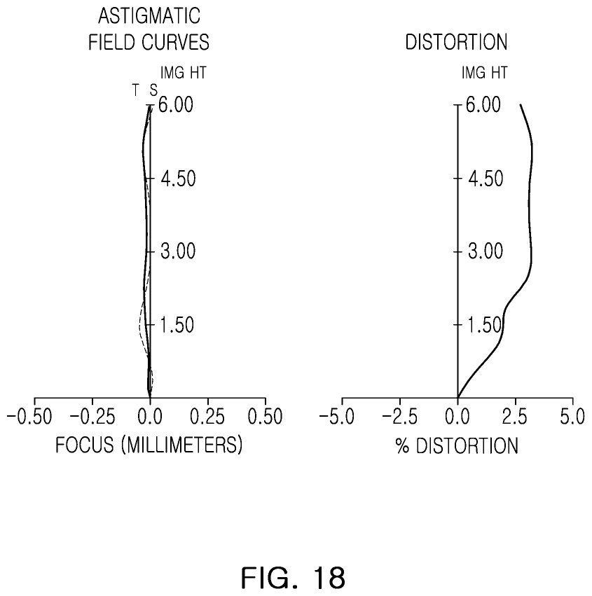

FIG. 17 is a configuration diagram of an imaging lens system according to a ninth embodiment of the present disclosure, and FIG. 18 illustrates aberration curves of the imaging lens system illustrated in FIG. 17.

Referring to FIG. 17, an imaging lens system 900 may include a first lens 910, a second lens 920, a third lens 930, a fourth lens 940, a fifth lens 950, a sixth lens 960, a seventh lens 970, and an eighth lens 980.

The first lens 910 may have a positive refractive power, a convex object-side surface in a paraxial region thereof, and a concave image-side surface in a paraxial region thereof. The second lens 920 may have a negative refractive power, a convex object-side surface in a paraxial region thereof, and a concave image-side surface in a paraxial region thereof. The third lens 930 may have a positive refractive power, a convex object-side surface in a paraxial region thereof, and a concave image-side surface in a paraxial region thereof. The fourth lens 940 may have a negative refractive power, a concave object-side surface in a paraxial region thereof, and a convex image-side surface in a paraxial region thereof. The fifth lens 950 may have a negative refractive power, a convex object-side surface in a paraxial region thereof, and a concave image-side surface in a paraxial region thereof. The sixth lens 960 may have a positive refractive power, a convex object-side surface in a paraxial region thereof, and a convex image-side surface in a paraxial region thereof. The seventh lens 970 may have a negative refractive power, a concave object-side surface in a paraxial region thereof, and a convex image-side surface in a paraxial region thereof. The eighth lens 980 may have a negative refractive power, a convex object-side surface in a paraxial region thereof, and a concave image-side surface in a paraxial region thereof.

In the imaging lens system 900 according to the present embodiment, the second lens 920 and the third lens 930 are bonded to each other. To elaborate, the image-side surface of the second lens 920 is in contact with and bonded to the object-side surface of the third lens 930.

The imaging lens system 900 may further include a filter IF and an imaging plane IP. The imaging plane IP may be formed on an image sensor IS, and the filter IF may be disposed between the eighth lens 980 and the imaging plane IP.

Tables 17 and 18 below list lens characteristics and aspherical values of the imaging lens system 900.

TABLE 17

| Surface | | Radius of | Thickness/ | Refractive | Abbe | Focal |
|---|---|---|---|---|---|---|
| No. | Component | Curvature | Distance | Index | No. | Length |
| S1 | 1st Lens | 3.25 | 0.995 | 1.512 | 68.3 | 8.320 |
| S2 | | 12.18 | 0.235 | | | |
| S3 | 2nd Lens | 23.75 | 0.302 | 1.720 | 26.9 | −13.970 |
| S4 | | 7.07 | 0.000 | | | |
| S5 | 3rd Lens | 7.07 | 0.442 | 1.570 | 60.4 | 15.190 |
| S6 | | 36.91 | 0.509 | | | |
| S7 | 4th Lens | −41.46 | 0.452 | 1.706 | 30.6 | −641.510 |
| S8 | | −45.81 | 0.490 | | | |
| S9 | 5th Lens | 12.37 | 0.357 | 1.567 | 37.4 | −30.200 |
| S10 | | 7.12 | 0.357 | | | |
| S11 | 6th Lens | 8.55 | 0.888 | 1.544 | 56.0 | 5.740 |
| S12 | | −4.78 | 0.751 | | | |
| S13 | 7th Lens | −6.63 | 0.610 | 1.671 | 19.2 | −25.890 |
| S14 | | −11.04 | 0.828 | | | |
| S15 | 8th Lens | 17.87 | 0.507 | 1.535 | 55.7 | −5.730 |
| S16 | | 2.60 | 0.355 | | | |
| S17 | Filter | Infinity | 0.156 | 1.517 | 64.2 | |
| S18 | | Infinity | 0.309 | | | |
| S19 | Imaging | Infinity | 0.007 | | | |
| | Plane | | | | | |

TABLE 18

| Surface | | | | | | | | |
|---|---|---|---|---|---|---|---|---|
| No. | S1 | S2 | S3 | S4 | S5 | S6 | S7 | S8 |
| K | −2.204E+00 | −4.013E+01 | 2.134E+01 | 0 | 0 | 9.899E+01 | −5.717E+01 | −5.450E+01 |
| A | 1.007E−02 | 2.347E−03 | −1.362E−02 | 0 | 0 | −1.873E−02 | −2.379E−02 | −2.170E−02 |
| B | −9.998E−03 | −2.411E−02 | 7.449E−02 | 0 | 0 | 1.149E−01 | −4.353E−04 | −3.452E−03 |
| C | 1.684E−02 | 6.687E−02 | −3.110E−01 | 0 | 0 | −4.990E−01 | 1.972E−02 | 7.606E−03 |
| D | −1.760E−02 | −1.237E−01 | 8.101E−01 | 0 | 0 | 1.341E+00 | −9.613E−02 | 1.287E−02 |
| E | 9.790E−03 | 1.566E−01 | −1.408E+00 | 0 | 0 | −2.383E+00 | 2.437E−01 | −6.664E−02 |
| F | −5.931E−04 | −1.412E−01 | 1.708E+00 | 0 | 0 | 2.930E+00 | −4.037E−01 | 1.133E−01 |
| G | −3.436E−03 | 9.299E−02 | −1.483E+00 | 0 | 0 | −2.561E+00 | 4.609E−01 | −1.125E−01 |
| H | 2.864E−03 | −4.514E−02 | 9.338E−01 | 0 | 0 | 1.614E+00 | −3.710E−01 | 7.356E−02 |
| J | −1.255E−03 | 1.611E−02 | −4.265E−01 | 0 | 0 | −7.344E−01 | 2.120E−01 | −3.304E−02 |
| L | 3.465E−04 | −4.160E−03 | 1.397E−01 | 0 | 0 | 2.392E−01 | −8.543E−02 | 1.028E−02 |
| M | −6.212E−05 | 7.537E−04 | −3.193E−02 | 0 | 0 | −5.430E−02 | 2.372E−02 | −2.182E−03 |
| N | 7.035E−06 | −9.056E−05 | 4.829E−03 | 0 | 0 | 8.162E−03 | −4.317E−03 | 3.020E−04 |
| O | −4.581E−07 | 6.462E−06 | −4.338E−04 | 0 | 0 | −7.298E−04 | 4.631E−04 | −2.458E−05 |
| P | 1.308E−08 | −2.069E−07 | 1.750E−05 | 0 | 0 | 2.938E−05 | −2.219E−05 | 8.927E−07 |
| Surface | | | | | | | | |
| No. | S9 | S10 | S11 | S12 | S13 | S14 | S15 | S16 |
| K | −4.426E+01 | 2.225E+00 | 3.583E+00 | −4.569E+00 | −4.443E−01 | −3.204E+00 | −6.781E+01 | −4.306E+00 |
| A | −4.971E−02 | −5.024E−02 | 1.810E−02 | 3.766E−02 | 3.068E−02 | 2.015E−02 | −5.417E−02 | −1.596E−02 |
| B | 1.692E−02 | −1.785E−02 | −3.413E−02 | −1.870E−02 | −3.495E−03 | 2.995E−05 | 2.012E−02 | −1.872E−03 |
| C | −3.457E−02 | 2.778E−02 | 2.644E−02 | 1.066E−02 | −5.730E−03 | −2.911E−03 | −6.857E−03 | 1.929E−03 |
| D | 8.663E−02 | −1.124E−02 | −1.567E−02 | −6.532E−03 | 4.758E−03 | 1.177E−03 | 1.621E−03 | −5.213E−04 |
| E | −1.196E−01 | −4.206E−03 | 7.056E−03 | 2.950E−03 | −2.242E−03 | −2.710E−04 | −2.534E−04 | 7.951E−05 |
| F | 1.031E−01 | 7.787E−03 | −2.331E−03 | −8.973E−04 | 7.179E−04 | 4.211E−05 | 2.717E−05 | −7.876E−06 |
| G | −6.011E−02 | −4.808E−03 | 5.550E−04 | 1.841E−04 | −1.618E−04 | −4.680E−06 | −2.065E−06 | 5.373E−07 |
| H | 2.460E−02 | 1.787E−03 | −9.476E−05 | −2.568E−05 | 2.592E−05 | 3.844E−07 | 1.134E−07 | −2.595E−08 |
| J | −7.154E−03 | −4.429E−04 | 1.156E−05 | 2.416E−06 | −2.952E−06 | −2.386E−08 | −4.522E−09 | 8.958E−10 |
| L | 1.471E−03 | 7.503E−05 | −9.956E−07 | −1.475E−07 | 2.367E−07 | 1.132E−09 | 1.299E−10 | −2.198E−11 |
| M | −2.089E−04 | −8.610E−06 | 5.904E−08 | 5.243E−09 | −1.304E−08 | −4.062E−11 | −2.619E−12 | 3.742E−13 |
| N | 1.948E−05 | 6.413E−07 | −2.292E−09 | −6.985E−11 | 4.699E−10 | 1.047E−12 | 3.519E−14 | −4.205E−15 |
| O | −1.072E−06 | −2.803E−08 | 5.238E−11 | −1.442E−12 | −9.961E−12 | −1.718E−14 | −2.830E−16 | 2.804E−17 |
| P | 2.634E−08 | 5.461E−10 | −5.344E−13 | 4.594E−14 | 9.420E−14 | 1.326E−16 | 1.030E−18 | −8.398E−20 |

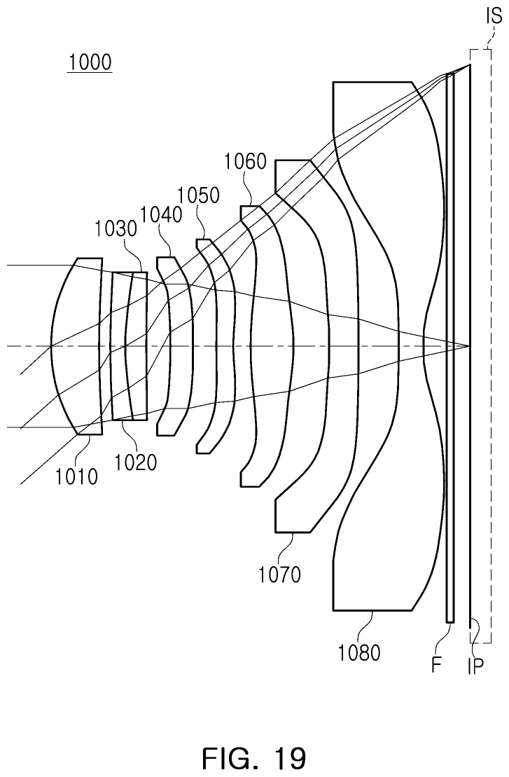

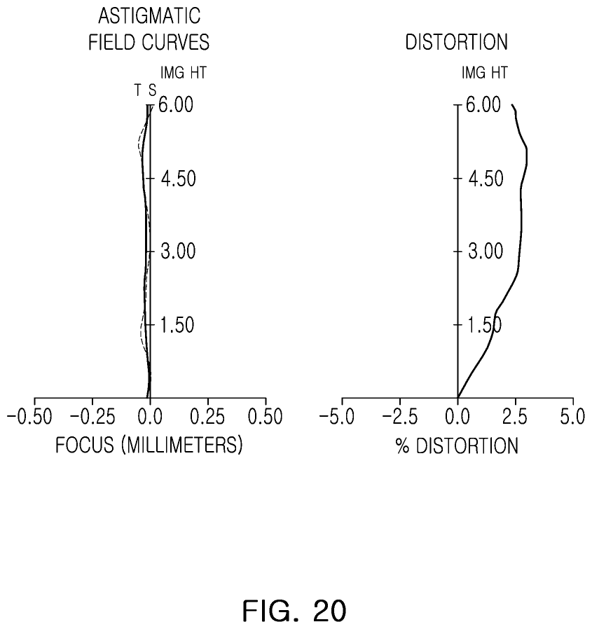

FIG. 19 is a configuration diagram of an imaging lens system according to a tenth embodiment of the present disclosure, and FIG. 20 illustrates aberration curves of the imaging lens system illustrated in FIG. 19.

Referring to FIG. 19, an imaging lens system 1000 may include a first lens 1010, a second lens 1020, a third lens 1030, a fourth lens 1040, a fifth lens 1050, a sixth lens 1060, a seventh lens 1070, and an eighth lens 1080.

The first lens 1010 may have a positive refractive power, a convex object-side surface in a paraxial region thereof, and a concave image-side surface in a paraxial region thereof. The second lens 1020 may have a negative refractive power, a convex object-side surface in a paraxial region thereof, and a concave image-side surface in a paraxial region thereof. The third lens 1030 may have a positive refractive power, a convex object-side surface in a paraxial region thereof, and a concave image-side surface in a paraxial region thereof. The fourth lens 1040 may have a negative refractive power, a concave object-side surface in a paraxial region thereof, and a convex image-side surface in a paraxial region thereof. The fifth lens 1050 may have a negative refractive power, a convex object-side surface in a paraxial region thereof, and a concave image-side surface in a paraxial region thereof. The sixth lens 1060 may have a positive refractive power, a convex object-side surface in a paraxial region thereof, and a convex image-side surface in a paraxial region thereof. The seventh lens 1070 may have a negative refractive power, a concave object-side surface in a paraxial region thereof, and a convex image-side surface in a paraxial region thereof. The eighth lens 1080 may have a negative refractive power, a convex object-side surface in a paraxial region thereof, and a concave image-side surface in a paraxial region thereof.

In the imaging lens system 1000 according to the present embodiment, the second lens 1020 and the third lens 1030 are bonded to each other. To elaborate, the image-side surface of the second lens 1020 is in contact with and bonded to the object-side surface of the third lens 1030.

The imaging lens system 1000 may further include a filter IF and an imaging plane IP. The imaging plane IP may be formed on an image sensor IS, and the filter IF may be disposed between the eighth lens 1080 and the imaging plane IP.

Tables 19 and 20 below list lens characteristics and aspherical values of the imaging lens system 1000.

TABLE 19

| Surface | | Radius of | Thickness/ | Refractive | Abbe | Focal |
|---|---|---|---|---|---|---|
| No. | Component | Curvature | Distance | Index | No. | Length |
| S1 | 1st Lens | 3.26 | 0.993 | 1.530 | 69.0 | 8.030 |
| S2 | | 12.30 | 0.240 | | | |
| S3 | 2nd Lens | 25.77 | 0.291 | 1.720 | 28.4 | −12.420 |
| S4 | | 6.65 | 0.000 | | | |
| S5 | 3rd Lens | 6.65 | 0.439 | 1.559 | 60.1 | 14.060 |
| S6 | | 41.28 | 0.514 | | | |
| S7 | 4th Lens | −42.82 | 0.448 | 1.689 | 30.5 | −787.850 |
| S8 | | −46.66 | 0.493 | | | |
| S9 | 5th Lens | 12.34 | 0.358 | 1.567 | 37.4 | −27.780 |
| S10 | | 6.86 | 0.352 | | | |
| S11 | 6th Lens | 8.15 | 0.902 | 1.544 | 56.0 | 5.640 |
| S12 | | −4.77 | 0.740 | | | |
| S13 | 7th Lens | −6.24 | 0.608 | 1.671 | 19.2 | −25.590 |
| S14 | | −10.13 | 0.817 | | | |
| S15 | 8th Lens | 19.75 | 0.506 | 1.535 | 55.7 | −5.440 |
| S16 | | 2.52 | 0.355 | | | |
| S17 | Filter | Infinity | 0.156 | 1.517 | 64.2 | |
| S18 | | Infinity | 0.293 | | | |
| S19 | Imaging | Infinity | 0.009 | | | |
| | Plane | | | | | |

TABLE 20

| Surface | | | | | | | | |
|---|---|---|---|---|---|---|---|---|
| No. | S1 | S2 | S3 | S4 | S5 | S6 | S7 | S8 |
| K | −2.205E+00 | −4.026E+01 | 2.099E+01 | 2.917E−01 | 2.917E−01 | 9.901E+01 | −4.719E+01 | −5.090E+01 |
| A | 8.945E−03 | 1.669E−03 | −1.048E−02 | 1.661E−02 | 1.661E−02 | −1.604E−02 | −2.225E−02 | −2.181E−02 |
| B | −6.889E−03 | −1.902E−02 | 4.811E−02 | −1.809E−01 | −1.809E−01 | 8.684E−02 | −1.001E−02 | −3.730E−03 |
| C | 1.073E−02 | 5.087E−02 | −1.950E−01 | 1.003E+00 | 1.003E+00 | −3.575E−01 | 5.291E−02 | 1.188E−02 |
| D | −8.172E−03 | −9.380E−02 | 4.971E−01 | −3.398E+00 | −3.398E+00 | 9.250E−01 | −1.733E−01 | −5.021E−03 |
| E | −1.144E−03 | 1.206E−01 | −8.505E−01 | 7.593E+00 | 7.593E+00 | −1.596E+00 | 3.708E−01 | −2.723E−02 |
| F | 8.534E−03 | −1.122E−01 | 1.021E+00 | −1.174E+01 | −1.174E+01 | 1.918E+00 | −5.557E−01 | 5.993E−02 |
| G | −8.844E−03 | 7.690E−02 | −8.813E−01 | 1.291E+01 | 1.291E+01 | −1.647E+00 | 5.941E−01 | −6.467E−02 |
| H | 5.136E−03 | −3.892E−02 | 5.524E−01 | −1.026E+01 | −1.026E+01 | 1.025E+00 | −4.566E−01 | 4.414E−02 |
| J | −1.932E−03 | 1.444E−02 | −2.514E−01 | 5.896E+00 | 5.896E+00 | −4.626E−01 | 2.521E−01 | −2.040E−02 |
| L | 4.881E−04 | −3.859E−03 | 8.206E−02 | −2.429E+00 | −2.429E+00 | 1.500E−01 | −9.886E−02 | 6.494E−03 |
| M | −8.244E−05 | 7.189E−04 | −1.868E−02 | 6.984E−01 | 6.984E−01 | −3.406E−02 | 2.684E−02 | −1.407E−03 |
| N | 8.938E−06 | −8.829E−05 | 2.813E−03 | −1.331E−01 | −1.331E−01 | 5.135E−03 | −4.791E−03 | 1.986E−04 |
| O | −5.628E−07 | 6.408E−06 | −2.512E−04 | 1.510E−02 | 1.510E−02 | −4.619E−04 | 5.054E−04 | −1.648E−05 |
| P | 1.565E−08 | −2.078E−07 | 1.006E−05 | −7.720E−04 | −7.720E−04 | 1.875E−05 | −2.386E−05 | 6.105E−07 |
| Surface | | | | | | | | |
| No. | S9 | S10 | S11 | S12 | S13 | $14 | S15 | S16 |
| K | −4.374E+01 | 2.306E+00 | 3.736E+00 | −4.500E+00 | −4.579E−01 | −3.236E+00 | −6.126E+01 | −4.329E+00 |
| A | −4.909E−02 | −5.030E−02 | 1.848E−02 | 3.666E−02 | 3.108E−02 | 1.959E−02 | −6.378E−02 | −2.828E−02 |
| B | 1.024E−02 | −1.863E−02 | −3.496E−02 | −1.586E−02 | −2.228E−03 | 1.680E−03 | 2.681E−02 | 5.986E−03 |
| C | −9.796E−03 | 3.299E−02 | 2.691E−02 | 6.634E−03 | −7.917E−03 | −4.405E−03 | −9.155E−03 | −5.291E−04 |
| D | 3.847E−02 | −2.218E−02 | −1.553E−02 | −3.336E−03 | 6.329E−03 | 1.938E−03 | 2.120E−03 | −6.640E−05 |
| E | −6.198E−02 | 8.160E−03 | 6.773E−03 | 1.386E−03 | −2.931E−03 | −5.281E−04 | −3.281E−04 | 2.571E−05 |
| F | 5.721E−02 | −9.587E−04 | −2.177E−03 | −3.905E−04 | 9.220E−04 | 1.029E−04 | 3.515E−05 | −3.635E−06 |
| G | −3.475E−02 | −6.659E−04 | 5.070E−04 | 7.050E−05 | −2.044E−04 | −1.488E−05 | −2.683E−06 | 3.102E−07 |
| H | 1.464E−02 | 4.295E−04 | −8.496E−05 | −7.636E−06 | 3.230E−05 | 1.606E−06 | 1.484E−07 | −1.772E−08 |
| J | −4.355E−03 | −1.306E−04 | 1.018E−05 | 3.678E−07 | −3.637E−06 | −1.281E−07 | −5.969E−09 | 7.012E−10 |
| L | 9.125E−04 | 2.476E−05 | −8.617E−07 | 1.763E−08 | 2.889E−07 | 7.411E−09 | 1.730E−10 | −1.932E−11 |
| M | −1.317E−04 | −3.066E−06 | 5.013E−08 | −3.999E−09 | −1.581E−08 | −3.011E−10 | −3.522E−12 | 3.641E−13 |
| N | 1.244E−05 | 2.421E−07 | −1.905E−09 | 2.715E−10 | 5.661E−10 | 8.122E−12 | 4.777E−14 | −4.475E−15 |
| O | −6.920E−07 | −1.112E−08 | 4.249E−11 | −8.923E−12 | −1.194E−11 | −1.304E−13 | −3.876E−16 | 3.234E−17 |
| P | 1.715E−08 | 2.268E−10 | −4.216E−13 | 1.197E−13 | 1.125E−13 | 9.428E−16 | 1.424E−18 | −1.042E−19 |

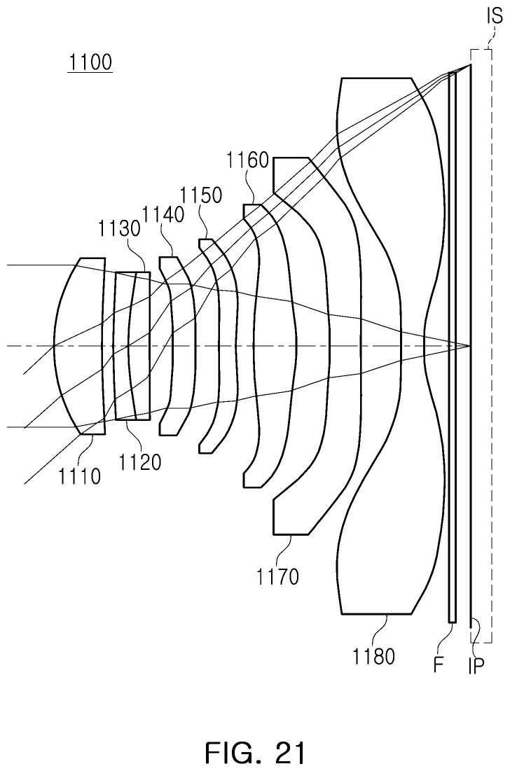

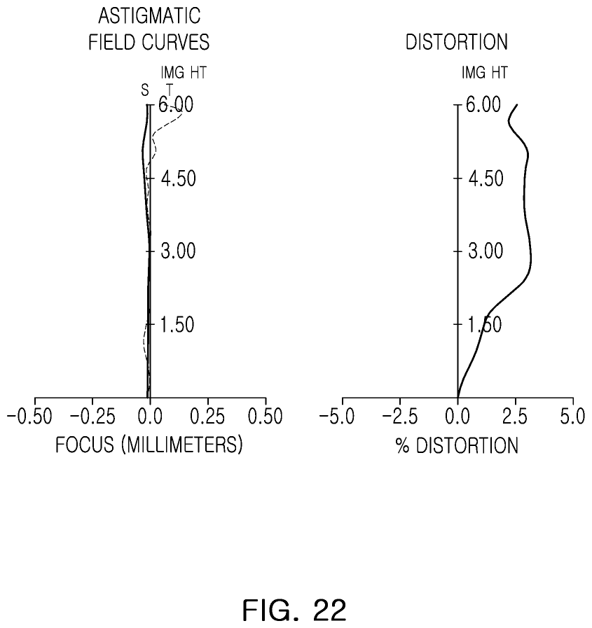

FIG. 21 is a configuration diagram of an imaging lens system according to an eleventh embodiment of the present disclosure, and FIG. 22 illustrates aberration curves of the imaging lens system illustrated in FIG. 21.

Referring to FIG. 21, an imaging lens system 1100 may include a first lens 1110, a second lens 1120, a third lens 1130, a fourth lens 1140, a fifth lens 1150, a sixth lens 1160, a seventh lens 1170, and an eighth lens 1180.

The first lens 1110 may have a positive refractive power, a convex object-side surface in a paraxial region thereof, and a concave image-side surface in a paraxial region thereof. The second lens 1120 may have a negative refractive power, a convex object-side surface in a paraxial region thereof, and a concave image-side surface in a paraxial region thereof. The third lens 1130 may have a positive refractive power, a convex object-side surface in a paraxial region thereof, and a convex image-side surface in a paraxial region thereof. The fourth lens 1140 may have a positive refractive power, a concave object-side surface in a paraxial region thereof, and a convex image-side surface in a paraxial region thereof. The fifth lens 1150 may have a negative refractive power, a concave object-side surface in a paraxial region thereof, and a concave image-side surface in a paraxial region thereof. The sixth lens 1160 may have a positive refractive power, a convex object-side surface in a paraxial region thereof, and a convex image-side surface in a paraxial region thereof. The seventh lens 1170 may have a negative refractive power, a concave object-side surface in a paraxial region thereof, and a convex image-side surface in a paraxial region thereof. The eighth lens 1180 may have a negative refractive power, a convex object-side surface in a paraxial region thereof, and a concave image-side surface in a paraxial region thereof.

In the imaging lens system 1100 according to the present embodiment, the fourth lens 1140 and the fifth lens 1150 are bonded to each other. To elaborate, the image-side surface of the fourth lens 1140 is in contact with and bonded to the object-side surface of the fifth lens 1150.

The imaging lens system 1100 may further include a filter IF and an imaging plane IP. The imaging plane IP may be formed on an image sensor IS, and the filter IF may be disposed between the eighth lens 1180 and the imaging plane IP.

Tables 21 and 22 below list lens characteristics and aspherical values of the imaging lens system 1100.

TABLE 21

| Surface | | Radius of | Thickness/ | Refractive | Abbe | Focal |
|---|---|---|---|---|---|---|
| No. | Component | Curvature | Distance | Index | No. | Length |
| S1 | 1st Lens | 2.81 | 0.935 | 1.545 | 65.8 | 6.980 |
| S2 | | 9.36 | 0.180 | | | |
| S3 | 2nd Lens | 13.00 | 0.272 | 1.720 | 25.2 | −16.710 |
| S4 | | 6.22 | 0.144 | | | |
| S5 | 3rd Lens | 9.13 | 0.446 | 1.570 | 62.8 | 14.110 |
| S6 | | −68.38 | 0.461 | | | |
| S7 | 4th Lens | −8.51 | 0.384 | 1.698 | 30.8 | 21.140 |
| S8 | | −5.51 | 0.000 | | | |
| S9 | 5th Lens | −5.51 | 0.566 | 1.543 | 52.9 | −10.010 |
| S10 | | 587.74 | 0.302 | | | |
| S11 | 6th Lens | 10.47 | 0.420 | 1.544 | 56.0 | 6.490 |
| S12 | | −5.28 | 0.706 | | | |
| S13 | 7th Lens | −6.44 | 0.813 | 1.671 | 19.2 | −26.470 |
| S14 | | −10.54 | 0.722 | | | |
| S15 | 8th Lens | 15.33 | 0.695 | 1.535 | 55.7 | −5.090 |
| S16 | | 2.28 | 0.440 | | | |
| S17 | Filter | Infinity | 0.142 | 1.517 | 64.2 | |
| S18 | | Infinity | 0.288 | | | |
| S19 | Imaging | Infinity | 0.009 | | | |
| | Plane | | | | | |

TABLE 22

| Surface | | | | | | | | |
|---|---|---|---|---|---|---|---|---|
| No. | S1 | S2 | S3 | S4 | S5 | S6 | S7 | S8 |
| K | −2.223E+00 | −4.532E+01 | 3.168E+01 | 1.231E+01 | 1.442E+01 | 9.937E+00 | −5.139E+01 | 0 |
| A | 1.242E−02 | −3.730E−03 | −1.591E−02 | −9.295E−03 | −4.964E−03 | −8.972E−03 | −5.248E−02 | 0 |
| B | −1.042E−02 | 8.101E−03 | 4.624E−02 | 3.726E−02 | 9.829E−03 | −1.281E−02 | 1.219E−01 | 0 |
| C | 2.434E−02 | −4.986E−02 | −2.153E−01 | −3.567E−01 | −4.109E−02 | 1.692E−01 | −5.832E−01 | 0 |
| D | −3.104E−02 | 1.279E−01 | 7.118E−01 | 1.890E+00 | 3.277E−03 | −7.963E−01 | 1.879E+00 | 0 |
| E | 1.709E−02 | −1.921E−01 | −1.570E+00 | −6.141E+00 | 4.760E−01 | 2.183E+00 | −4.096E+00 | 0 |
| F | 4.151E−03 | 1.801E−01 | 2.397E+00 | 1.342E+01 | −1.719E+00 | −3.973E+00 | 6.203E+00 | 0 |
| G | −1.353E−02 | −1.055E−01 | −2.596E+00 | −2.069E+01 | 3.201E+00 | 5.080E+00 | −6.677E+00 | 0 |
| H | 1.028E−02 | 3.491E−02 | 2.023E+00 | 2.297E+01 | −3.749E+00 | −4.689E+00 | 5.170E+00 | 0 |
| J | −4.398E−03 | −2.652E−03 | −1.137E+00 | −1.845E+01 | 2.940E+00 | 3.146E+00 | −2.885E+00 | 0 |
| L | 1.183E−03 | −2.984E−03 | 4.576E−01 | 1.061E+01 | −1.572E+00 | −1.521E+00 | 1.149E+00 | 0 |
| M | −2.018E−04 | 1.439E−03 | −1.285E−01 | −4.256E+00 | 5.666E−01 | 5.153E−01 | −3.181E−01 | 0 |
| N | 2.078E−05 | −3.138E−04 | 2.394E−02 | 1.129E+00 | −1.319E−01 | −1.160E−01 | 5.818E−02 | 0 |
| O | −1.133E−06 | 3.530E−05 | −2.659E−03 | −1.780E−01 | 1.791E−02 | 1.555E−02 | −6.318E−03 | 0 |
| P | 2.270E−08 | −1.655E−06 | 1.333E−04 | 1.260E−02 | −1.078E−03 | −9.385E−04 | 3.083E−04 | 0 |

| Surface | | | | | | | | |
|---|---|---|---|---|---|---|---|---|
| No. | S9 | S10 | S11 | S12 | S13 | S14 | S15 | S16 |
| K | 0 | 7.797E+01 | −1.343E+01 | −9.619E+00 | −3.507E+00 | −1.406E+01 | −5.140E+01 | −5.334E+00 |
| A | 0 | −6.775E−02 | −1.827E−02 | 2.028E−02 | 2.529E−02 | 1.757E−02 | −6.991E−02 | −2.805E−02 |
| B | 0 | 6.104E−02 | 2.279E−02 | 9.643E−03 | 5.457E−03 | 5.484E−03 | 2.806E−02 | 3.529E−03 |
| C | 0 | −1.249E−01 | −3.545E−02 | −1.182E−02 | −1.686E−02 | −8.861E−03 | −9.584E−03 | 9.971E−04 |
| D | 0 | 1.804E−01 | 3.401E−02 | 5.705E−03 | 1.370E−02 | 4.702E−03 | 2.174E−03 | −5.229E−04 |
| E | 0 | −1.815E−01 | −2.272E−02 | −1.608E−03 | −6.931E−03 | −1.576E−03 | −3.185E−04 | 1.061E−04 |
| F | 0 | 1.306E−01 | 1.089E−02 | 2.653E−04 | 2.395E−03 | 3.681E−04 | 3.170E−05 | −1.283E−05 |
| G | 0 | −6.824E−02 | −3.768E−03 | −2.243E−05 | −5.807E−04 | −6.162E−05 | −2.255E−06 | 1.026E−06 |
| H | 0 | 2.605E−02 | 9.383E−04 | 3.702E−07 | 9.987E−05 | 7.467E−06 | 1.193E−07 | −5.603E−08 |
| J | 0 | −7.237E−03 | −1.673E−04 | 3.663E−08 | −1.220E−05 | −6.547E−07 | −4.824E−09 | 2.097E−09 |
| L | 0 | 1.443E−03 | 2.111E−05 | 1.390E−08 | 1.048E−06 | 4.109E−08 | 1.495E−10 | −5.262E−11 |
| M | 0 | −2.002E−04 | −1.833E−06 | −3.138E−09 | −6.187E−08 | −1.800E−09 | −3.450E−12 | 8.348E−13 |
| N | 0 | 1.832E−05 | 1.041E−07 | 2.632E−10 | 2.386E−09 | 5.226E−11 | 5.553E−14 | −7.279E−15 |
| O | 0 | −9.908E−07 | −3.475E−09 | −1.056E−11 | −5.413E−11 | −9.048E−13 | −5.491E−16 | 2.062E−17 |
| P | 0 | 2.394E−08 | 5.165E−11 | 1.698E−13 | 5.474E−13 | 7.073E−15 | 2.484E−18 | 8.129E−20 |

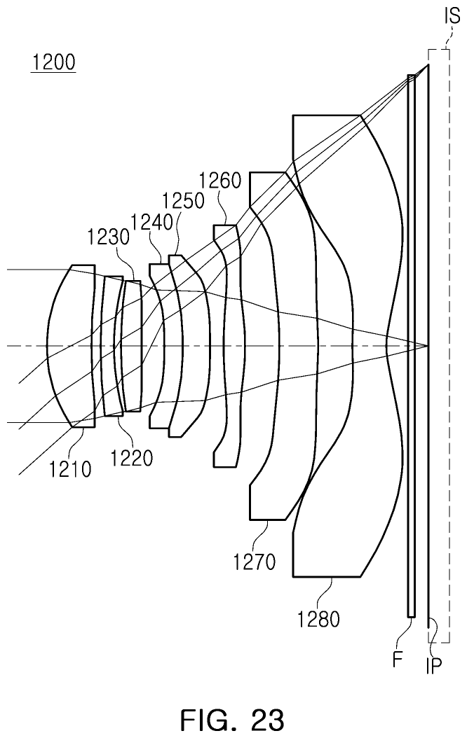

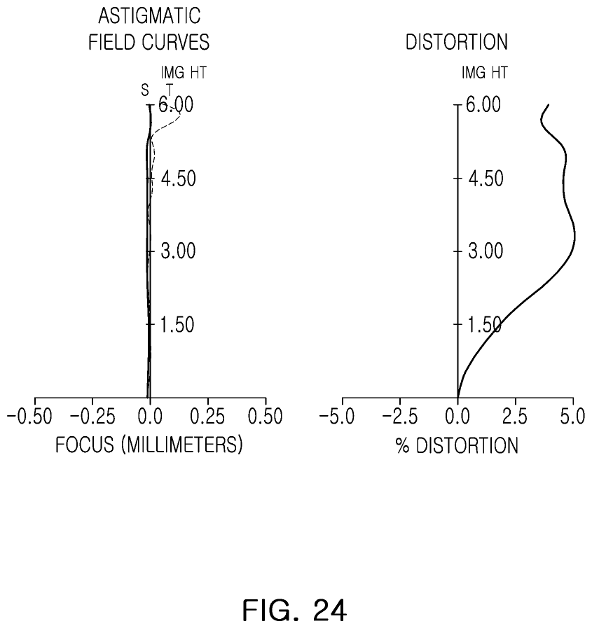

FIG. 23 is a configuration diagram of an imaging lens system according to a twelfth embodiment of the present disclosure, and FIG. 24 illustrates aberration curves of the imaging lens system illustrated in FIG. 23.

Referring to FIG. 23, an imaging lens system 1200 may include a first lens 1210, a second lens 1220, a third lens 1230, a fourth lens 1240, a fifth lens 1250, a sixth lens 1260, a seventh lens 1270, and an eighth lens 1280.

The first lens 1210 may have a positive refractive power, a convex object-side surface in a paraxial region thereof, and a concave image-side surface in a paraxial region thereof. The second lens 1220 may have a negative refractive power, a convex object-side surface in a paraxial region thereof, and a concave image-side surface in a paraxial region thereof. The third lens 1230 may have a positive refractive power, a convex object-side surface in a paraxial region thereof, and a convex image-side surface in a paraxial region thereof. The fourth lens 1240 may have a positive refractive power, a concave object-side surface in a paraxial region thereof, and a convex image-side surface in a paraxial region thereof. The fifth lens 1250 may have a negative refractive power, a concave object-side surface in a paraxial region thereof, and a convex image-side surface in a paraxial region thereof. The sixth lens 1260 may have a positive refractive power, a convex object-side surface in a paraxial region thereof, and a convex image-side surface in a paraxial region thereof. The seventh lens 1270 may have a negative refractive power, a concave object-side surface in a paraxial region thereof, and a convex image-side surface in a paraxial region thereof. The eighth lens 1280 may have a negative refractive power, a convex object-side surface in a paraxial region thereof, and a concave image-side surface in a paraxial region thereof.

In the imaging lens system 1200 according to the present embodiment, the fourth lens 1240 and the fifth lens 1250 are bonded to each other. To elaborate, the image side surface of the fourth lens 1240 is in contact with and bonded to the object side surface of the fifth lens 1250.

The imaging lens system 1200 may further include a filter IF and an imaging plane IP. The imaging plane IP may be formed on an image sensor IS, and the filter IF may be disposed between the eighth lens 1280 and the imaging plane IP.

Tables 23 and 24 below list lens characteristics and aspherical values of the imaging lens system 1200.

TABLE 23

| Surface | | Radius of | Thickness/ | Refractive | Abbe | Focal |
|---|---|---|---|---|---|---|
| No. | Component | Curvature | Distance | Index | No. | Length |
| S1 | 1st Lens | 2.81 | 0.935 | 1.536 | 65.7 | 7.100 |
| S2 | | 9.33 | 0.176 | | | |
| S3 | 2nd Lens | 12.91 | 0.276 | 1.720 | 25.6 | −16.750 |
| S4 | | 6.21 | 0.135 | | | |
| S5 | 3rd Lens | 9.00 | 0.438 | 1.568 | 62.4 | 14.110 |
| S6 | | −74.44 | 0.462 | | | |
| S7 | 4th Lens | −8.49 | 0.380 | 1.706 | 31.5 | 25.480 |
| S8 | | −5.89 | 0.000 | | | |
| S9 | 5th Lens | −5.89 | 0.572 | 1.538 | 53.3 | −11.020 |
| S10 | | −612.37 | 0.311 | | | |
| S11 | 6th Lens | 11.18 | 0.418 | 1.544 | 56.0 | 6.560 |
| S12 | | −5.21 | 0.726 | | | |
| S13 | 7th Lens | −6.67 | 0.790 | 1.671 | 19.2 | −25.790 |
| S14 | | −11.29 | 0.746 | | | |
| S15 | 8th Lens | 12.71 | 0.689 | 1.535 | 55.7 | −5.760 |
| S16 | | 2.44 | 0.440 | | | |
| S17 | Filter | Infinity | 0.142 | 1.517 | 64.2 | |
| S18 | | Infinity | 0.319 | | | |
| S19 | Imaging | Infinity | 0.012 | | | |
| | Plane | | | | | |

TABLE 24

| Surface | | | | | | | | |
|---|---|---|---|---|---|---|---|---|
| No. | S1 | S2 | S3 | S4 | S5 | S6 | S7 | S8 |
| K | −2.210E+00 | −4.531E+01 | 3.214E+01 | 1.228E+01 | 1.425E+01 | 6.658E+01 | −5.094E+01 | 9.718E−01 |
| A | 1.329E−02 | −4.861E−03 | −1.867E−02 | −9.292E−03 | −9.664E−04 | −1.177E−02 | −5.868E−02 | 7.235E−03 |
| B | −8.398E−03 | 1.571E−02 | 7.664E−02 | 1.742E−02 | −4.519E−02 | 2.812E−02 | 1.832E−01 | −8.888E−03 |
| C | 7.157E−03 | −8.433E−02 | −3.840E−01 | −1.324E−01 | 3.295E−01 | −8.796E−02 | −8.482E−01 | 1.529E−01 |
| D | 1.252E−02 | 2.301E−01 | 1.294E+00 | 7.470E−01 | −1.479E+00 | 1.047E−01 | 2.567E+00 | −8.413E−01 |
| E | −4.522E−02 | −3.967E−01 | −2.914E+00 | −2.630E+00 | 4.365E+00 | 1.968E−01 | −5.315E+00 | 2.172E+00 |
| F | 6.186E−02 | 4.621E−01 | 4.550E+00 | 6.179E+00 | −8.790E+00 | −1.031E+00 | 7.773E+00 | −3.382E+00 |
| G | −5.013E−02 | −3.770E−01 | −5.045E+00 | −1.013E+01 | 1.238E+01 | 2.049E+00 | −8.185E+00 | 3.507E+00 |
| H | 2.656E−02 | 2.195E−01 | 4.024E+00 | 1.185E+01 | −1.237E+01 | −2.475E+00 | 6.263E+00 | −2.529E+00 |
| J | −9.501E−03 | −9.154E−02 | −2.313E+00 | −9.948E+00 | 8.812E+00 | 1.996E+00 | −3.479E+00 | 1.290E+00 |
| L | 2.294E−03 | 2.712E−02 | 9.492E−01 | 5.941E+00 | −4.437E+00 | −1.100E+00 | 1.387E+00 | −4.642E−01 |
| M | −3.643E−04 | −5.559E−03 | −2.711E−01 | −2.462E+00 | 1.542E+00 | 4.096E−01 | −3.861E−01 | 1.155E−01 |
| N | 3.568E−05 | 7.491E−04 | 5.116E−02 | 6.721E−01 | −3.515E−01 | −9.875E−02 | 7.121E−02 | −1.889E−02 |
| O | −1.877E−06 | −5.960E−05 | −5.734E−03 | −1.086E−01 | 4.729E−02 | 1.392E−02 | −7.815E−03 | 1.829E−03 |
| P | 3.670E−08 | 2.120E−06 | 2.889E−04 | 7.869E−03 | −2.843E−03 | −8.703E−04 | 3.861E−04 | −7.947E−05 |

| Surface | | | | | | | | |
|---|---|---|---|---|---|---|---|---|
| No. | S9 | S10 | S11 | S12 | S13 | S14 | S15 | S16 |
| K | 9.718E−01 | 0.000E+00 | −1.236E+01 | −9.669E+00 | −4.241E+00 | −1.624E+01 | −5.279E+01 | −5.283E+00 |
| A | 7.235E−03 | −6.316E−02 | −1.686E−02 | 2.077E−02 | 2.682E−02 | 1.582E−02 | −6.212E−02 | −3.052E−02 |
| B | −8.888E−03 | 3.222E−02 | 1.503E−02 | 1.030E−02 | 4.449E−03 | 6.658E−03 | 2.125E−02 | 8.327E−03 |
| C | 1.529E−01 | −5.635E−02 | −2.083E−02 | −1.304E−02 | −1.526E−02 | −8.615E−03 | −5.851E−03 | −1.475E−03 |
| D | −8.413E−01 | 8.775E−02 | 1.900E−02 | 6.325E−03 | 1.184E−02 | 4.027E−03 | 8.734E−04 | 1.255E−04 |
| E | 2.172E+00 | −1.001E−01 | −1.299E−02 | −1.678E−03 | −5.767E−03 | −1.196E−03 | −2.519E−05 | 3.927E−06 |
| F | −3.382E+00 | 8.113E−02 | 6.637E−03 | 2.064E−04 | 1.957E−03 | 2.521E−04 | −1.286E−05 | −2.347E−06 |
| G | 3.507E+00 | −4.682E−02 | −2.470E−03 | 9.839E−06 | −4.730E−04 | −3.909E−05 | 2.456E−06 | 2.921E−07 |
| H | −2.529E+00 | 1.933E−02 | 6.573E−04 | −7.888E−06 | 8.179E−05 | 4.494E−06 | −2.340E−07 | −2.030E−08 |
| J | 1.290E+00 | −5.709E−03 | −1.239E−04 | 1.342E−06 | −1.008E−05 | −3.811E−07 | 1.411E−08 | 8.842E−10 |
| L | −4.642E−01 | 1.192E−03 | 1.636E−05 | −1.221E−07 | 8.755E−07 | 2.347E−08 | −5.697E−10 | −2.442E−11 |
| M | 1.155E−01 | −1.715E−04 | −1.474E−06 | 6.251E−09 | −5.223E−08 | −1.019E−09 | 1.547E−11 | 4.075E−13 |
| N | −1.889E−02 | 1.613E−05 | 8.623E−08 | −1.516E−10 | 2.034E−09 | 2.955E−11 | −2.720E−13 | −3.488E−15 |
| O | 1.829E−03 | −8.911E−07 | −2.950E−09 | 7.868E−14 | −4.656E−11 | −5.135E−13 | 2.809E−15 | 5.954E−18 |
| P | −7.947E−05 | 2.189E−08 | 4.473E−11 | 4.912E−14 | 4.748E−13 | 4.044E−15 | −1.295E−17 | 7.730E−20 |

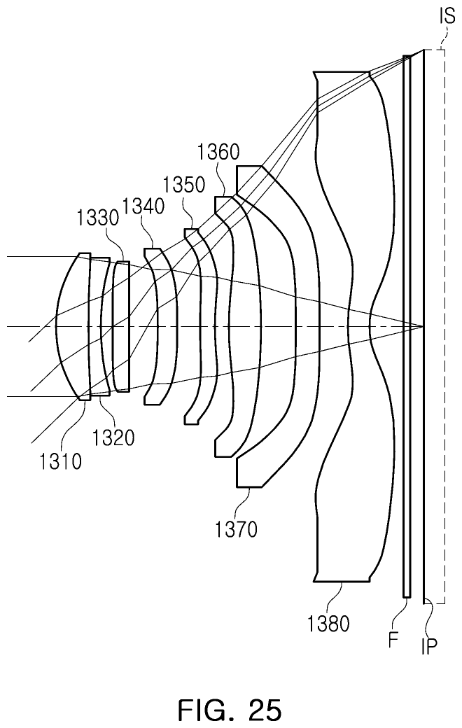

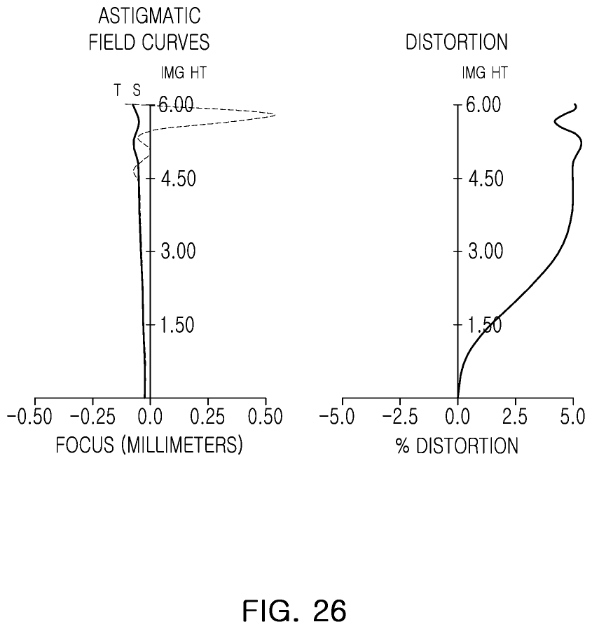

FIG. 25 is a configuration diagram of an imaging lens system according to a thirteenth embodiment of the present disclosure, and FIG. 26 illustrates aberration curves of the imaging lens system illustrated in FIG. 25.

Referring to FIG. 25, an imaging lens system 1300 may include a first lens 1310, a second lens 1320, a third lens 1330, a fourth lens 1340, a fifth lens 1350, a sixth lens 1360, a seventh lens 1370, and an eighth lens 1380.

The first lens 1310 may have a positive refractive power, a convex object-side surface in a paraxial region thereof, and a concave image-side surface in a paraxial region thereof. The second lens 1320 may have a negative refractive power, a convex object-side surface in a paraxial region thereof, and a concave image-side surface in a paraxial region thereof. The third lens 1330 may have a positive refractive power, a convex object-side surface in a paraxial region thereof, and a concave image-side surface in a paraxial region thereof. The fourth lens 1340 may have a negative refractive power, a concave object-side surface in a paraxial region thereof, and a convex image-side surface in a paraxial region thereof. The fifth lens 1350 may have a negative refractive power, a convex object-side surface in a paraxial region thereof, and a concave image-side surface in a paraxial region thereof. The sixth lens 1360 may have a positive refractive power, a convex object-side surface in a paraxial region thereof, and a convex image-side surface in a paraxial region thereof. The seventh lens 1370 may have a positive refractive power, a concave object-side surface in a paraxial region thereof, and a convex image-side surface in a paraxial region thereof. The eighth lens 1380 may have a negative refractive power, a convex object-side surface in a paraxial region thereof, and a concave image-side surface in a paraxial region thereof.

In the imaging lens system 1300 according to the present embodiment, the first lens 1310 and the second lens 1320 are bonded to each other. To elaborate, the image-side surface of the first lens 1310 is in contact with and bonded to the object-side surface of the second lens 1320.

The imaging lens system 1300 may further include a filter IF and an imaging plane IP. The imaging plane IP may be formed on an image sensor IS, and the filter IF may be disposed between the eighth lens 1380 and the imaging plane IP.

Tables 25 and 26 below list lens characteristics and aspherical values of the imaging lens system 1300.

TABLE 25

| Surface | | Radius of | Thickness/ | Refractive | Abbe | Focal |
|---|---|---|---|---|---|---|
| No. | Component | Curvature | Distance | Index | No. | Length |
| S1 | 1st Lens | 2.91 | 0.648 | 1.548 | 64.8 | 6.160 |
| S2 | | 19.15 | 0.000 | | | |
| S3 | 2nd Lens | 19.15 | 0.260 | 1.755 | 27.6 | −11.020 |
| S4 | | 5.80 | 0.212 | | | |
| S5 | 3rd Lens | 9.85 | 0.395 | 1.603 | 61.3 | 16.620 |
| S6 | | 470.68 | 0.585 | | | |
| S7 | 4th Lens | −17.37 | 0.377 | 1.747 | 38.9 | −253.750 |
| S8 | | −19.29 | 0.499 | | | |
| S9 | 5th Lens | 9.21 | 0.292 | 1.567 | 37.4 | −19.810 |
| S10 | | 5.02 | 0.289 | | | |
| S11 | 6th Lens | 7.21 | 0.673 | 1.544 | 56.0 | 6.020 |
| S12 | | −5.84 | 0.730 | | | |
| S13 | 7th Lens | −6.00 | 0.465 | 1.671 | 19.2 | 70.640 |
| S14 | | −5.50 | 0.590 | | | |
| S15 | 8th Lens | 3.13 | 0.442 | 1.535 | 55.7 | −5.020 |
| S16 | | 1.38 | 0.700 | | | |
| S17 | Filter | Infinity | 0.142 | 1.517 | 64.2 | |
| S18 | | Infinity | 0.280 | | | |
| S19 | Imaging | Infinity | 0.020 | | | |
| | Plane | | | | | |

TABLE 26

| Surface | | | | | | | | |
|---|---|---|---|---|---|---|---|---|
| No. | S1 | S2 | S3 | S4 | S5 | S6 | S7 | S8 |
| K | −1.875E+00 | 1.609E+01 | 1.609E+01 | 1.131E+01 | 1.817E+01 | 9.900E+01 | −6.021E+01 | −7.420E+01 |
| A | 1.108E−02 | 1.175E−02 | 1.175E−02 | 1.278E−02 | −5.013E−03 | −7.631E−03 | −2.502E−02 | −2.323E−02 |
| B | −1.400E−02 | −4.360E−02 | −4.360E−02 | −1.843E−01 | −2.205E−02 | −2.536E−02 | −1.783E−02 | −1.435E−02 |
| C | 4.745E−02 | −1.015E−01 | −1.015E−01 | 9.738E−01 | 1.599E−01 | 1.683E−01 | 2.579E−02 | 2.908E−02 |
| D | −1.003E−01 | 1.048E+00 | 1.048E+00 | −3.214E+00 | −6.449E−01 | −6.054E−01 | 1.579E−02 | −4.343E−02 |
| E | 1.435E−01 | −3.118E+00 | −3.118E+00 | 6.876E+00 | 1.650E+00 | 1.290E+00 | −2.158E−01 | 3.663E−02 |
| F | −1.454E−01 | 4.811E+00 | 4.811E+00 | −9.572E+00 | −2.849E+00 | −1.686E+00 | 5.786E−01 | −7.478E−03 |
| G | 1.065E−01 | −3.770E+00 | −3.770E+00 | 8.160E+00 | 3.458E+00 | 1.294E+00 | −8.806E−01 | −2.007E−02 |
| H | −5.670E−02 | 3.362E−01 | 3.362E−01 | −3.019E+00 | −3.025E+00 | −4.140E−01 | 8.742E−01 | 2.678E−02 |
| J | 2.186E−02 | 2.363E+00 | 2.363E+00 | −1.666E+00 | 1.932E+00 | −2.073E−01 | −5.920E−01 | −1.781E−02 |
| L | −6.007E−03 | −2.554E+00 | −2.554E+00 | 2.966E+00 | −9.029E−01 | 3.051E−01 | 2.763E−01 | 7.467E−03 |
| M | 1.142E−03 | 1.378E+00 | 1.378E+00 | −1.883E+00 | 3.036E−01 | −1.607E−01 | −8.749E−02 | −2.058E−03 |
| N | −1.424E−04 | −4.303E−01 | −4.303E−01 | 6.593E−01 | −7.005E−02 | 4.625E−02 | 1.796E−02 | 3.643E−04 |
| O | 1.044E−05 | 7.416E−02 | 7.416E−02 | −1.260E−01 | 9.952E−03 | −7.195E−03 | −2.155E−03 | −3.779E−05 |
| P | −3.405E−07 | −5.484E−03 | −5.484E−03 | 1.031E−02 | −6.546E−04 | 4.750E−04 | 1.146E−04 | 1.756E−06 |

| Surface | | | | | | | | |
|---|---|---|---|---|---|---|---|---|
| No. | S9 | S10 | S11 | S12 | S13 | S14 | S15 | S16 |
| K | −2.361E+01 | 1.637E+00 | 5.674E−01 | −3.456E+00 | 6.278E−01 | −8.830E+00 | −1.875E+01 | −4.354E+00 |
| A | −7.008E−02 | −1.015E−01 | −2.481E−02 | 1.072E−02 | 7.046E−02 | 8.716E−02 | −3.123E−02 | −2.747E−02 |
| B | 6.501E−02 | 7.471E−02 | 2.339E−02 | 8.194E−03 | −4.341E−02 | −4.752E−02 | 1.190E−03 | 5.695E−03 |
| C | −1.180E−01 | −9.160E−02 | −1.555E−02 | −7.934E−03 | 1.401E−02 | 1.052E−02 | −1.656E−03 | −1.429E−03 |
| D | 1.954E−01 | 1.031E−01 | 5.012E−03 | 6.518E−03 | −4.406E−03 | −3.554E−04 | 1.067E−03 | 3.800E−04 |
| E | −2.447E−01 | −9.776E−02 | −9.590E−04 | −4.794E−03 | 1.774E−03 | −3.413E−04 | −2.782E−04 | −7.537E−05 |
| F | 2.223E−01 | 7.220E−02 | 2.848E−04 | 2.421E−03 | −6.180E−04 | 6.363E−05 | 4.221E−05 | 1.021E−05 |
| G | −1.453E−01 | −3.948E−02 | −1.593E−04 | −8.165E−04 | 1.421E−04 | 2.867E−06 | −4.212E−06 | −9.522E−07 |
| H | 6.840E−02 | 1.567E−02 | 6.024E−05 | 1.879E−04 | −2.040E−05 | −2.877E−06 | 2.908E−07 | 6.205E−08 |
| J | −2.311E−02 | −4.474E−03 | −1.390E−05 | −2.996E−05 | 1.739E−06 | 5.511E−07 | −1.417E−08 | −2.846E−09 |
| L | 5.534E−03 | 9.062E−04 | 2.048E−06 | 3.310E−06 | −7.014E−08 | −5.942E−08 | 4.867E−10 | 9.143E−11 |
| M | −9.143E−04 | −1.268E−04 | −1.951E−07 | −2.489E−07 | −1.108E−09 | 4.050E−09 | −1.154E−11 | −2.012E−12 |
| N | 9.881E−05 | 1.163E−05 | 1.165E−08 | 1.214E−08 | 2.620E−10 | −1.738E−10 | 1.797E−13 | 2.886E−14 |
| O | −6.267E−06 | −6.289E−07 | −3.964E−10 | −3.470E−10 | −1.129E−11 | 4.306E−12 | −1.654E−15 | −2.432E−16 |
| P | 1.763E−07 | 1.517E−08 | 5.859E−12 | 4.405E−12 | 1.729E−13 | −4.709E−14 | 6.814E−18 | 9.129E−19 |

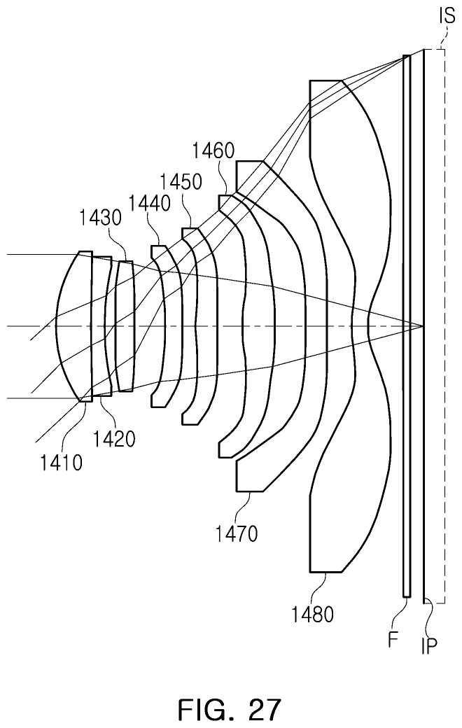

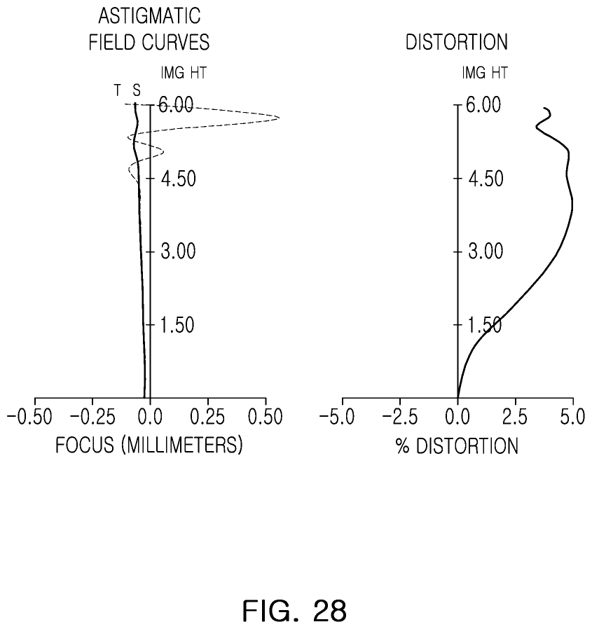

FIG. 27 is a configuration diagram of an imaging lens system according to a fourteenth embodiment of the present disclosure, and FIG. 28 illustrates aberration curves of the imaging lens system illustrated in FIG. 27.

Referring to FIG. 27, an imaging lens system 1400 may include a first lens 1410, a second lens 1420, a third lens 1430, a fourth lens 1440, a fifth lens 1450, a sixth lens 1460, a seventh lens 1470, and an eighth lens 1480.

The first lens 1410 may have a positive refractive power, a convex object-side surface in a paraxial region thereof, and a concave image-side surface in a paraxial region thereof. The second lens 1420 may have a negative refractive power, a convex object-side surface in a paraxial region thereof, and a concave image-side surface in a paraxial region thereof. The third lens 1430 may have a positive refractive power, a convex object-side surface in a paraxial region thereof, and a concave image-side surface in a paraxial region thereof. The fourth lens 1440 may have a negative refractive power, a concave object-side surface in a paraxial region thereof, and a convex image-side surface in a paraxial region thereof. The fifth lens 1450 may have a positive refractive power, a convex object-side surface in a paraxial region thereof, and a concave image-side surface in a paraxial region thereof. The sixth lens 1460 may have a positive refractive power, a convex object-side surface in a paraxial region thereof, and a convex image-side surface in a paraxial region thereof. The seventh lens 1470 may have a negative refractive power, a concave object-side surface in a paraxial region thereof, and a convex image-side surface in a paraxial region thereof. The eighth lens 1480 may have a negative refractive power, a convex object-side surface in a paraxial region thereof, and a concave image-side surface in a paraxial region thereof.

In the imaging lens system 1400 according to the present embodiment, the first lens 1410 and the second lens 1420 are bonded to each other. To elaborate, the image-side surface of the first lens 1410 is in contact with and bonded to the object-side surface of the second lens 1420.

The imaging lens system 1400 may further include a filter IF and an imaging plane IP. The imaging plane IP may be formed on an image sensor IS, and the filter IF may be disposed between the eighth lens 1480 and the imaging plane IP.

Tables 27 and 28 below list lens characteristics and aspherical values of the imaging lens system 1400.

TABLE 27

| Surface | | Radius of | Thickness/ | Refractive | Abbe | Focal |
|---|---|---|---|---|---|---|
| No. | Component | Curvature | Distance | Index | No. | Length |
| S1 | 1st Lens | 2.91 | 0.700 | 1.571 | 63.2 | 5.780 |
| S2 | | 21.78 | 0.000 | | | |
| S3 | 2nd Lens | 21.78 | 0.280 | 1.755 | 27.6 | −10.460 |
| S4 | | 5.80 | 0.228 | | | |
| S5 | 3rd Lens | 10.32 | 0.404 | 1.620 | 60.3 | 17.140 |
| S6 | | 303.36 | 0.640 | | | |
| S7 | 4th Lens | −15.27 | 0.373 | 1.754 | 29.1 | −26.460 |
| S8 | | −64.15 | 0.265 | | | |
| S9 | 5th Lens | 6.50 | 0.425 | 1.567 | 37.4 | 55.070 |
| S10 | | 8.00 | 0.568 | | | |
| S11 | 6th Lens | 13.13 | 0.649 | 1.544 | 56.0 | 6.530 |
| S12 | | −4.81 | 0.626 | | | |
| S13 | 7th Lens | −5.45 | 0.440 | 1.671 | 19.2 | −47.630 |
| S14 | | −6.76 | 0.489 | | | |
| S15 | 8th Lens | 2.57 | 0.372 | 1.535 | 55.7 | −4.980 |
| S16 | | 1.24 | 0.700 | | | |
| S17 | Filter | Infinity | 0.142 | 1.517 | 64.2 | |
| S18 | | Infinity | 0.280 | | | |
| S19 | Imaging | Infinity | 0.020 | | | |
| | Plane | | | | | |

TABLE 28

| Surface | | | | | | | | |
|---|---|---|---|---|---|---|---|---|
| No. | S1 | S2 | S3 | S4 | S5 | S6 | S7 | S8 |
| K | −1.783E+00 | −1.725E+00 | −1.725E+00 | 1.114E+01 | 1.830E+01 | 9.900E+01 | −7.571E+01 | 9.900E+01 |
| A | 8.746E−03 | 9.882E−03 | 9.882E−03 | 1.066E−02 | 4.005E−05 | −7.765E−03 | −3.082E−02 | −4.815E−02 |
| B | −2.235E−03 | −2.275E−02 | −2.275E−02 | −1.862E−01 | −8.348E−02 | −3.683E−03 | −1.960E−02 | 1.856E−02 |
| C | 7.599E−03 | −2.636E−01 | −2.636E−01 | 1.094E+00 | 5.774E−01 | 7.631E−03 | 1.595E−01 | 3.701E−02 |
| D | −1.898E−02 | 1.880E+00 | 1.880E+00 | −4.135E+00 | −2.395E+00 | 5.786E−02 | −6.288E−01 | −1.658E−01 |
| E | 3.474E−02 | −5.975E+00 | −5.975E+00 | 1.055E+01 | 6.492E+00 | −4.086E−01 | 1.518E+00 | 2.990E−01 |
| F | −4.472E−02 | 1.144E+01 | 1.144E+01 | −1.877E+01 | 1.207E+01 | 1.196E+00 | −2.501E+00 | −3.384E−01 |
| G | 3.973E−02 | −1.441E+01 | −1.441E+01 | 2.374E+01 | 1.588E+01 | −2.066E+00 | 2.939E+00 | 2.649E−01 |
| H | −2.437E−02 | 1.232E+01 | 1.232E+01 | −2.146E+01 | −1.501E+01 | 2.329E+00 | −2.506E+00 | −1.486E−01 |
| J | 1.034E−02 | −7.189E+00 | −7.189E+00 | 1.379E+01 | 1.022E+01 | −1.781E+00 | 1.555E+00 | 6.028E−02 |
| L | −3.017E−03 | 2.801E+00 | 2.801E+00 | −6.167E+00 | −4.976E+00 | 9.328E−01 | −6.940E−01 | −1.752E−02 |
| M | 5.924E−04 | −6.866E−01 | −6.866E−01 | 1.843E+00 | 1.688E+00 | −3.296E−01 | 2.168E−01 | 3.545E−03 |
| N | −7.466E−05 | 9.096E−02 | 9.096E−02 | −3.388E−01 | −3.787E−01 | 7.509E−02 | −4.490E−02 | −4.705E−04 |
| O | 5.449E−06 | −3.373E−03 | −3.373E−03 | 3.213E−02 | 5.050E−02 | −9.957E−03 | 5.536E−03 | 3.637E−05 |
| P | −1.749E−07 | −3.349E−04 | −3.349E−04 | −9.162E−04 | −3.028E−03 | 5.835E−04 | −3.072E−04 | −1.212E−06 |

| Surface | | | | | | | | |
|---|---|---|---|---|---|---|---|---|
| No. | S9 | S10 | S11 | S12 | S13 | S14 | S15 | S16 |
| K | −2.046E+01 | 8.669E+00 | 6.446E+00 | −1.514E+00 | 6.678E−01 | −4.245E+00 | −2.429E+01 | −5.661E+00 |
| A | −8.344E−02 | −8.246E−02 | −1.248E−02 | 2.833E−02 | 1.004E−01 | 9.862E−02 | −7.461E−02 | −4.215E−02 |
| B | 7.160E−02 | 4.042E−02 | −6.864E−03 | −2.394E−02 | −1.088E−01 | −8.870E−02 | 2.881E−02 | 1.652E−02 |
| C | −7.168E−02 | −2.087E−02 | 1.641E−02 | 2.167E−02 | 8.534E−02 | 5.494E−02 | −1.344E−02 | −6.015E−03 |
| D | 8.083E−02 | 1.308E−02 | −1.272E−02 | −9.895E−03 | −5.097E−02 | −2.648E−02 | 4.899E−03 | 1.668E−03 |
| E | −9.713E−02 | −1.640E−02 | 4.328E−03 | 7.475E−04 | 2.212E−02 | 9.472E−03 | −1.165E−03 | −3.223E−04 |
| F | 9.604E−02 | 1.778E−02 | −1.906E−04 | 1.367E−03 | −6.990E−03 | −2.466E−03 | 1.844E−04 | 4.327E−05 |
| G | −6.921E−02 | −1.250E−02 | −4.207E−04 | −7.565E−04 | 1.627E−03 | 4.674E−04 | −2.017E−05 | −4.091E−06 |
| H | 3.540E−02 | 5.802E−03 | 1.858E−04 | 2.099E−04 | −2.808E−04 | −6.474E−05 | 1.561E−06 | 2.753E−07 |
| J | −1.279E−02 | −1.834E−03 | −4.229E−05 | −3.654E−05 | 3.596E−05 | 6.547E−06 | −8.628E−08 | −1.321E−08 |
| L | 3.234E−03 | 3.981E−04 | 6.045E−06 | 4.217E−06 | −3.375E−06 | −4.783E−07 | 3.390E−09 | 4.479E−10 |
| M | −5.582E−04 | −5.845E−05 | −5.621E−07 | −3.234E−07 | 2.254E−07 | 2.458E−08 | −9.259E−11 | −1.047E−11 |
| N | 6.244E−05 | 5.546E−06 | 3.312E−08 | 1.589E−08 | −1.011E−08 | −8.424E−10 | 1.672E−12 | 1.601E−13 |
| O | −4.062E−06 | −3.068E−07 | −1.125E−09 | −4.534E−10 | 2.727E−10 | 1.729E−11 | −1.795E−14 | −1.443E−15 |
| P | 1.161E−07 | 7.512E−09 | 1.680E−11 | 5.724E−12 | −3.330E−12 | −1.605E−13 | 8.682E−17 | 5.801E−18 |

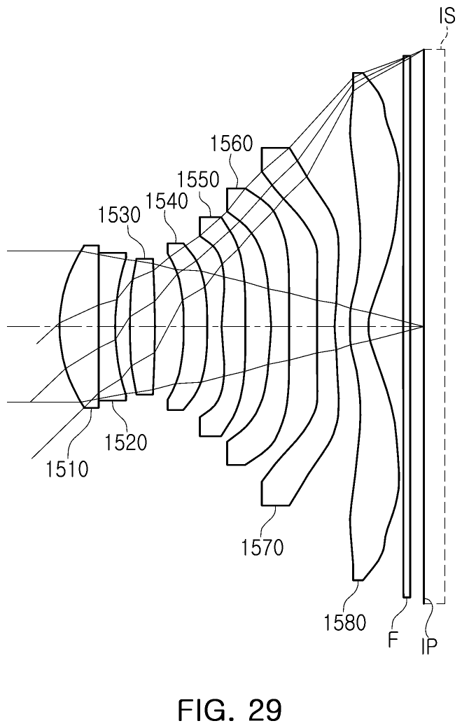

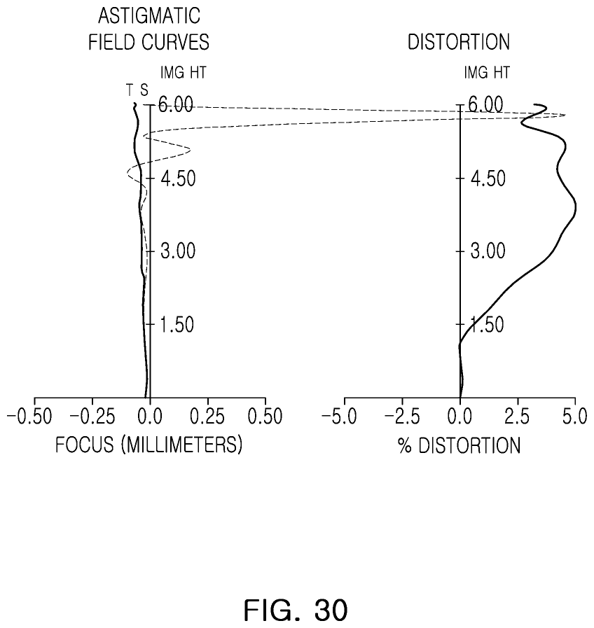

FIG. 29 is a configuration diagram of an imaging lens system according to a fifteenth embodiment of the present disclosure, and FIG. 30 illustrates aberration curves of the imaging lens system illustrated in FIG. 29.

Referring to FIG. 29, an imaging lens system 1500 may include a first lens 1510, a second lens 1520, a third lens 1530, a fourth lens 1540, a fifth lens 1550, a sixth lens 1560, a seventh lens 1570, and an eighth lens 1580.

The first lens 1510 may have a positive refractive power, a convex object-side surface in a paraxial region thereof, and a concave image-side surface in a paraxial region thereof. The second lens 1520 may have a negative refractive power, a convex object-side surface in a paraxial region thereof, and a concave image-side surface in a paraxial region thereof. The third lens 1530 may have a positive refractive power, a convex object-side surface in a paraxial region thereof, and a convex image-side surface in a paraxial region thereof. The fourth lens 1540 may have a negative refractive power, a concave object-side surface in a paraxial region thereof, and a convex image-side surface in a paraxial region thereof. The fifth lens 1550 may have a positive refractive power, a convex object-side surface in a paraxial region thereof, and a concave image-side surface in a paraxial region thereof. The sixth lens 1560 may have a negative refractive power, a concave object-side surface in a paraxial region thereof, and a convex image-side surface in a paraxial region thereof. The seventh lens 1570 may have a positive refractive power, a convex object-side surface in a paraxial region thereof, and a convex image-side surface in a paraxial region thereof. The eighth lens 1580 may have a negative refractive power, a convex object-side surface in a paraxial region thereof, and a concave image-side surface in a paraxial region thereof.

In the imaging lens system 1500 according to the present embodiment, the first lens 1510 and the second lens 1520 are bonded to each other. To elaborate, the image-side surface of the first lens 1510 is in contact with and bonded to the object-side surface of the second lens 1520.

The imaging lens system 1500 may further include a filter IF and an imaging plane IP. The imaging plane IP may be formed on an image sensor IS, and the filter IF may be disposed between the eighth lens 1580 and the imaging plane IP.

Tables 29 and 30 below list lens characteristics and aspherical values of the imaging lens system 1500.

TABLE 29

| Surface | | Radius of | Thickness/ | Refractive | Abbe | Focal |
|---|---|---|---|---|---|---|
| No. | Component | Curvature | Distance | Index | No. | Length |
| S1 | 1st Lens | 2.89 | 0.841 | 1.599 | 61.2 | 5.030 |
| S2 | | 56.25 | 0.000 | | | |
| S3 | 2nd Lens | 56.25 | 0.354 | 1.755 | 27.6 | −8.170 |
| S4 | | 5.59 | 0.315 | | | |
| S5 | 3rd Lens | 10.31 | 0.503 | 1.620 | 60.3 | 14.340 |
| S6 | | −65.48 | 0.583 | | | |
| S7 | 4th Lens | −13.94 | 0.496 | 1.751 | 32.4 | −51.840 |
| S8 | | −21.96 | 0.318 | | | |
| S9 | 5th Lens | 6.44 | 0.454 | 1.567 | 37.4 | 13.950 |
| S10 | | 32.77 | 0.548 | | | |
| S11 | 6th Lens | −14.40 | 0.386 | 1.544 | 56.0 | −30.830 |
| S12 | | −100.00 | 0.568 | | | |
| S13 | 7th Lens | 169.86 | 0.389 | 1.671 | 19.2 | 47.970 |
| S14 | | −40.26 | 0.302 | | | |
| S15 | 8th Lens | 2.25 | 0.394 | 1.535 | 55.7 | −6.880 |
| S16 | | 1.31 | 0.700 | | | |
| S17 | Filter | Infinity | 0.142 | 1.517 | 64.2 | |
| S18 | | Infinity | 0.280 | | | |
| S19 | Imaging | Infinity | 0.020 | | | |
| | Plane | | | | | |

TABLE 30

| Surface | | | | | | | | |
|---|---|---|---|---|---|---|---|---|
| No. | S1 | S2 | S3 | S4 | S5 | S6 | S7 | S8 |
| K | −1.643E+00 | −9.900E+01 | −9.900E+01 | 1.089E+01 | 2.577E+01 | −1.084E+01 | −6.851E+01 | 5.492E+01 |
| A | 8.634E−03 | 4.963E−03 | 4.963E−03 | 7.518E−03 | −9.972E−03 | −1.378E−02 | −3.849E−02 | −5.617E−02 |
| B | −1.005E−02 | 1.577E−03 | 1.578E−03 | −1.725E−01 | 7.344E−02 | 4.188E−02 | 2.998E−02 | 3.969E−02 |
| C | 2.993E−02 | −3.524E−01 | −3.524E−01 | 1.034E+00 | −5.948E−01 | −2.188E−01 | −1.288E−01 | −7.793E−02 |
| D | −5.646E−02 | 1.986E+00 | 1.986E+00 | −3.951E+00 | 2.753E+00 | 7.528E−01 | 4.357E−01 | 1.363E−01 |
| E | 7.146E−02 | −5.712E+00 | −5.712E+00 | 1.016E+01 | −8.038E+00 | −1.769E+00 | −1.098E+00 | −2.134E−01 |
| F | −6.306E−02 | 1.033E+01 | 1.033E+01 | −1.828E+01 | 1.583E+01 | 2.929E+00 | 1.993E+00 | 2.798E−01 |
| G | 3.946E−02 | −1.269E+01 | −1.269E+01 | 2.353E+01 | −2.186E+01 | −3.473E+00 | −2.593E+00 | −2.835E−01 |
| H | −1.761E−02 | 1.094E+01 | 1.094E+01 | −2.190E+01 | 2.160E+01 | 2.972E+00 | 2.424E+00 | 2.121E−01 |
| J | 5.585E−03 | −6.710E+00 | −6.710E+00 | 1.476E+01 | −1.536E+01 | −1.832E+00 | −1.627E+00 | −1.147E−01 |
| L | −1.243E−03 | 2.917E+00 | 2.917E+00 | −7.119E+00 | 7.805E+00 | 8.033E−01 | 7.761E−01 | 4.408E−02 |
| M | 1.892E−04 | −8.786E−01 | −8.786E−01 | 2.394E+00 | −2.764E+00 | −2.436E−01 | −2.563E−01 | −1.172E−02 |
| N | −1.868E−05 | 1.745E−01 | 1.745E−01 | −5.322E−01 | 6.478E−01 | 4.841E−02 | 5.568E−02 | 2.046E−03 |
| O | 1.076E−06 | −2.056E−02 | −2.056E−02 | 7.023E−02 | −9.032E−02 | −5.659E−03 | −7.152E−03 | −2.112E−04 |
| P | −2.744E−08 | 1.089E−03 | 1.089E−03 | −4.160E−03 | 5.669E−03 | 2.944E−04 | 4.111E−04 | 9.762E−06 |

| Surface | | | | | | | | |
|---|---|---|---|---|---|---|---|---|
| No. | S9 | S10 | S11 | S12 | S13 | S14 | S15 | S16 |
| K | −1.703E+01 | 5.104E+01 | −9.284E+01 | −9.900E+01 | −6.877E+01 | 2.301E+00 | −6.735E+00 | −4.489E+00 |
| A | −7.226E−02 | −6.134E−02 | −9.622E−02 | −7.151E−02 | 8.860E−02 | 1.757E−01 | −3.189E−02 | −5.717E−02 |
| B | 1.139E−01 | 8.689E−02 | 1.460E−01 | 1.313E−01 | −1.105E−01 | −2.147E−01 | −4.091E−03 | 3.099E−02 |
| C | −2.557E−01 | −1.061E−01 | −1.244E−01 | −1.155E−01 | 7.236E−02 | 1.531E−01 | 6.033E−03 | −1.214E−02 |
| D | 4.440E−01 | 8.454E−02 | 5.182E−02 | 5.988E−02 | −2.852E−02 | −7.384E−02 | −2.163E−03 | 3.219E−03 |
| E | −5.922E−01 | −4.555E−02 | −2.293E−03 | −1.977E−02 | 5.205E−03 | 2.485E−02 | 4.461E−04 | −5.775E−04 |
| F | 5.917E−01 | 1.758E−02 | −9.074E−03 | 4.137E−03 | 5.764E−04 | −5.982E−03 | −6.036E−05 | 7.144E−05 |
| G | −4.365E−01 | −5.249E−03 | 5.301E−03 | −4.788E−04 | −5.911E−04 | 1.047E−03 | 5.630E−06 | −6.206E−06 |
| H | 2.359E−01 | 1.314E−03 | −1.645E−03 | 2.697E−06 | 1.640E−04 | −1.344E−04 | 3.708E−07 | 3.830E−07 |
| J | −9.261E−02 | −2.857E−04 | 3.289E−04 | 9.239E−06 | −2.625E−05 | 1.266E−05 | 1.738E−08 | −1.683E−08 |
| L | 2.604E−02 | 5.135E−05 | −4.430E−05 | −1.684E−06 | 2.694E−06 | −8.633E−07 | −5.766E−10 | 5.222E−10 |
| M | −5.100E−03 | −6.908E−06 | 4.008E−06 | 1.603E−07 | −1.797E−07 | 4.151E−08 | 1.323E−11 | −1.116E−11 |
| N | 6.593E−04 | 6.253E−07 | −2.340E−07 | −9.016E−09 | 7.526E−09 | −1.333E−09 | −1.999E−13 | 1.564E−13 |
| O | −5.052E−05 | −3.330E−08 | 7.974E−09 | 2.835E−10 | −1.788E−10 | 2.565E−11 | 1.787E−15 | −1.291E−15 |
| P | 1.735E−06 | 7.821E−10 | −1.206E−10 | −3.858E−12 | 1.823E−12 | −2.235E−13 | −7.170E−18 | 4.763E−18 |

Tables 31 to 35 below list optical characteristic values and conditional expression values of the imaging lens systems according to the first to fifteenth embodiments.

TABLE 31

| | Ex. 1 | Ex. 2 | Ex. 3 | Ex. 4 | Ex. 5 | Ex. 6 | Ex. 7 | Ex. 8 |
|---|---|---|---|---|---|---|---|---|
| TTL | 7.595 | 7.599 | 7.801 | 7.799 | 7.131 | 7.126 | 8.910 | 8.784 |
| f | 5.670 | 5.680 | 5.880 | 5.880 | 5.610 | 5.600 | 6.760 | 6.630 |
| f-number | 1.953 | 1.956 | 1.894 | 1.895 | 1.947 | 1.947 | 1.954 | 1.954 |
| IMG HT | 6.000 | 6.000 | 6.000 | 6.000 | 6.000 | 6.000 | 6.000 | 6.000 |
| FOV | 90.200 | 90.200 | 88.300 | 88.400 | 90.900 | 91.100 | 81.800 | 82.800 |

| | Ex. 9 | Ex. 10 | Ex. 11 | Ex. 12 | Ex. 13 | Ex. 14 | Ex. 15 |
|---|---|---|---|---|---|---|---|
| TTL | 8.552 | 8.513 | 7.926 | 7.968 | 7.600 | 7.600 | 7.594 |
| f | 6.480 | 6.510 | 6.340 | 6.310 | 5.940 | 6.030 | 6.340 |
| f-number | 1.893 | 1.895 | 1.948 | 1.947 | 1.956 | 1.956 | 1.953 |
| IMG HT | 6.000 | 6.000 | 6.000 | 6.000 | 6.000 | 6.000 | 6.000 |
| FOV | 84.000 | 84.000 | 85.300 | 84.800 | 87.700 | 87.600 | 84.900 |

TABLE 32

| Conditional | | | | | | | | |
|---|---|---|---|---|---|---|---|---|
| Expression | Ex. 1 | Ex. 2 | Ex. 3 | Ex. 4 | Ex. 5 | Ex. 6 | Ex. 7 | Ex. 8 |
| \|Va − Vb\| | 43.340 | 43.420 | 36.320 | 36.290 | 23.610 | 22.100 | 40.390 | 42.170 |
| \|Na − Nb\| | 0.209 | 0.209 | 0.150 | 0.150 | 0.157 | 0.167 | 0.199 | 0.208 |
| \|fa/Va − fb/Vb\| | 0.738 | 0.722 | 0.726 | 0.727 | 0.762 | 0.834 | 0.697 | 0.800 |
| f1/f | 1.277 | 1.269 | 1.291 | 1.291 | 1.128 | 1.138 | 1.148 | 1.240 |
| f2/f | −2.697 | −2.657 | −2.189 | −2.192 | −2.713 | −2.721 | −2.207 | −2.554 |
| f3/f | 3.086 | 3.081 | 2.378 | 2.379 | 2.287 | 2.282 | 3.031 | 3.060 |
| f4/(f × 100) | 0.605 | 0.616 | −0.828 | −0.831 | 0.033 | 0.036 | −1.084 | 1.980 |
| f5/f | −5.372 | −5.213 | −4.730 | −4.731 | −1.613 | −1.700 | −3.783 | −4.112 |
| f6/f | 1.009 | 1.000 | 0.893 | 0.893 | 1.052 | 1.055 | 0.885 | 0.923 |
| f7/f | −5.194 | −5.081 | −4.099 | −4.099 | −4.046 | −3.904 | −5.399 | −5.819 |
| f8/f | −1.056 | −1.056 | −0.980 | −0.978 | −0.870 | −0.895 | −0.873 | −0.896 |
| TTL/f | 1.339 | 1.338 | 1.327 | 1.326 | 1.271 | 1.273 | 1.318 | 1.325 |
| BFL/f | 0.148 | 0.148 | 0.133 | 0.133 | 0.129 | 0.130 | 0.153 | 0.157 |
| TTL/(2 × IMG HT) | 0.633 | 0.633 | 0.650 | 0.650 | 0.594 | 0.594 | 0.742 | 0.732 |

| Conditional | | | | | | | |
|---|---|---|---|---|---|---|---|
| Expression | Ex. 9 | Ex. 10 | Ex. 11 | Ex. 12 | Ex. 13 | Ex. 14 | Ex. 15 |
| \|Va − Vb\| | 33.420 | 31.660 | 22.060 | 21.770 | 37.260 | 35.610 | 33.660 |
| \|Na − Nb\| | 0.150 | 0.161 | 0.155 | 0.168 | 0.207 | 0.184 | 0.156 |
| \|fa/Va − fb/Vb\| | 0.770 | 0.671 | 0.875 | 1.016 | 0.495 | 0.471 | 0.378 |
| f1/f | 1.284 | 1.233 | 1.101 | 1.125 | 1.037 | 0.959 | 0.793 |
| f2/f | −2.156 | −1.908 | −2.636 | −2.655 | −1.855 | −1.735 | −1.289 |
| f3/f | 2.344 | 2.160 | 2.226 | 2.236 | 2.798 | 2.842 | 2.262 |
| f4/(f × 100) | −0.990 | −1.210 | 0.033 | 0.040 | −0.427 | −0.044 | −0.082 |
| f5/f | −4.660 | −4.267 | −1.579 | −1.746 | −3.335 | 9.133 | 2.200 |
| f6/f | 0.886 | 0.866 | 1.024 | 1.040 | 1.013 | 1.083 | −4.863 |
| f7/f | −3.995 | −3.931 | −4.175 | −4.087 | 11.892 | −7.899 | 7.566 |
| f8/f | −0.884 | −0.836 | −0.803 | −0.913 | −0.845 | −0.826 | −1.085 |
| TTL/f | 1.320 | 1.308 | 1.250 | 1.263 | 1.279 | 1.260 | 1.198 |
| BFL/f | 0.128 | 0.125 | 0.139 | 0.145 | 0.192 | 0.189 | 0.180 |
| TTL/(2 × IMG HT) | 0.713 | 0.709 | 0.660 | 0.664 | 0.633 | 0.633 | 0.633 |

TABLE 33

| Conditional | | | | | | | | |
|---|---|---|---|---|---|---|---|---|
| Expression | Ex. 1 | Ex. 2 | Ex. 3 | Ex. 4 | Ex. 5 | Ex. 6 | Ex. 7 | Ex. 8 |
| f1/f8 | −1.209 | −1.202 | −1.318 | −1.320 | −1.297 | −1.271 | −1.315 | −1.384 |
| f2/f3 | −0.874 | −0.862 | −0.921 | −0.921 | −1.186 | −1.192 | −0.728 | −0.834 |
| f5/f7 | 1.034 | 1.026 | 1.154 | 1.154 | 0.399 | 0.435 | 0.701 | 0.707 |
| f6/f8 | −0.955 | −0.947 | −0.911 | −0.913 | −1.209 | −1.180 | −1.014 | −1.030 |
| f1/f8 + f5/f7 | −0.174 | −0.176 | −0.164 | −0.166 | −0.898 | −0.836 | −0.615 | −0.677 |
| f2/f3 + f6/f8 | −1.829 | −1.809 | −1.832 | −1.834 | −2.395 | −2.372 | −1.742 | −1.865 |

| Conditional | | | | | | | |
|---|---|---|---|---|---|---|---|
| Expression | Ex. 9 | Ex. 10 | Ex. 11 | Ex. 12 | Ex. 13 | Ex. 14 | Ex. 15 |
| f1/f8 | −1.452 | −1.476 | −1.371 | −1.233 | −1.227 | −1.161 | −0.731 |
| f2/f3 | −0.920 | −0.883 | −1.184 | −1.187 | −0.663 | −0.610 | −0.570 |
| f5/f7 | 1.166 | 1.086 | 0.378 | 0.427 | −0.280 | −1.156 | 0.291 |
| f6/f8 | −1.002 | −1.037 | −1.275 | −1.139 | −1.199 | −1.311 | 4.481 |
| f1/f8 + f5/f7 | −0.286 | −0.391 | −0.993 | −0.805 | −1.508 | −2.317 | −0.440 |
| f2/f3 + f6/f8 | −1.921 | −1.920 | −2.459 | −2.326 | −1.862 | −1.922 | 3.911 |

TABLE 34

| Conditional Expression | Ex. 1 | Ex. 2 | Ex. 3 | Ex. 4 | Ex. 5 | Ex. 6 | Ex. 7 | Ex. 8 |
|---|---|---|---|---|---|---|---|---|
| (R2 + R3 + R4)/(R7 + R8 + R9) | −2.504 | −2.525 | −0.591 | −0.591 | −1.468 | −1.441 | −2.445 | −2.441 |
| (R2 + R4 + R8)/(R3 + R5 + R9) | 0.179 | 0.183 | −0.601 | −0.602 | 0.613 | 0.609 | 0.221 | 0.181 |
| (R2 − R3 + R4 − R5)/(R8 + R9) | −11.494 | −12.974 | 0.368 | 0.368 | 0.588 | 0.567 | 1.645 | 8.243 |

| Conditional Expression | Ex. 9 | Ex. 10 | Ex. 11 | Ex. 12 | Ex. 13 | Ex. 14 | Ex. 15 |
|---|---|---|---|---|---|---|---|
| (R2 + R3 + R4)/(R7 + R8 + R9) | −0.574 | −0.580 | −1.463 | −1.403 | −1.606 | −0.677 | −4.009 |
| (R2 + R4 + R8)/(R3 + R5 + R9) | −0.615 | −0.619 | 0.606 | 0.602 | 0.148 | −0.947 | 0.546 |
| (R2 − R3 + R4 − R5)/(R8 + R9) | 0.346 | 0.392 | 0.593 | 0.540 | 0.401 | 0.078 | 0.305 |

TABLE 35

| Conditional Expression | Ex. 1 | Ex. 2 | Ex. 3 | Ex. 4 | Ex. 5 | Ex. 6 | Ex. 7 | Ex. 8 |
|---|---|---|---|---|---|---|---|---|
| (AG12 + AG23)/T2 | 0.725 | 0.718 | 0.749 | 0.749 | 1.155 | 1.137 | 0.629 | 0.747 |
| TL12/(T1 + T2) + TL23/(T2 + T3) | 2.282 | 2.281 | 2.177 | 2.177 | 2.341 | 2.338 | 2.251 | 2.300 |
| sumAG/TTL | 0.371 | 0.371 | 0.369 | 0.369 | 0.326 | 0.327 | 0.362 | 0.362 |
| sumAG/f | 0.497 | 0.497 | 0.490 | 0.490 | 0.414 | 0.416 | 0.477 | 0.479 |

| Conditional Expression | Ex. 9 | Ex. 10 | Ex. 11 | Ex. 12 | Ex. 13 | Ex. 14 | Ex. 15 |
|---|---|---|---|---|---|---|---|
| (AG12 + AG23)/T2 | 0.777 | 0.825 | 1.193 | 1.128 | 0.816 | 0.814 | 0.890 |
| TL12/(T1 + T2) + TL23/(T2 + T3) | 2.181 | 2.187 | 2.350 | 2.335 | 2.324 | 2.333 | 2.368 |
| sumAG/TTL | 0.371 | 0.371 | 0.317 | 0.321 | 0.382 | 0.371 | 0.347 |
| sumAG/f | 0.489 | 0.485 | 0.397 | 0.405 | 0.489 | 0.467 | 0.416 |

The imaging lens system according to the present embodiment may have a specific numerical ranges for the focal lengths of the first to eighth lenses. For example, a focal length of the first lens may be in a range of 5.0 mm to 9.0 mm, a focal length of the second lens may be in a range of −18.0 mm to −8.0 mm, a focal length of the third lens may be in a range of 10.0 mm to 24.0 mm, a focal length of the fifth lens may be in a range of −32.0 mm to −8.0 mm or in a range of 10 mm or more, a focal length of the sixth lens may be in a range of 5.0 mm to 7.0 mm or in a range of −25 mm or less, a focal length of the seventh lens may be in a range of −50.00 mm to −20.0 mm or in a range of 40 mm or more, and a focal length of the eighth lens may be in a range of −7.0 mm to −4.0 mm.

The present invention can provide an imaging lens system that may achieve a high resolution.

While this disclosure includes specific examples, it will be apparent after an understanding of the disclosure of this application that various changes in form and details may be made in these examples without departing from the spirit and scope of the claims and their equivalents. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An imaging lens system comprising:
a first lens having a positive refractive power,
a second lens having a refractive power,
a third lens having a positive refractive power,
a fourth lens having a refractive power and a convex image-side surface in a paraxial region thereof,
a fifth lens having a refractive power;
a sixth lens having a refractive power,
a seventh lens having a refractive power and a convex image-side surface in a paraxial region thereof, and
an eighth lens having a refractive power, a convex object-side surface in a paraxial region thereof, and an image-side surface having an inflection point,
wherein the first to eighth lenses are sequentially arranged in ascending numerical order along an optical axis of the imaging lens system from an object side of the imaging lens system toward an imaging plane of the imaging lens system, and
the imaging lens system satisfies the following conditional expression:
−5.0<f6/f<2.0
where f6 is a focal length of the sixth lens, and f is a focal length of the imaging lens system.

2. The imaging lens system of claim 1, wherein the first lens has a convex object-side surface in a paraxial region thereof.

3. The imaging lens system of claim 1, wherein the second lens has a convex object-side surface in a paraxial region thereof.

4. The imaging lens system of claim 1, wherein the third lens has a convex object-side surface in a paraxial region thereof.

5. The imaging lens system of claim 1, wherein the fourth lens has a concave object-side surface in a paraxial region thereof.

6. The imaging lens system of claim 1, wherein the fifth lens has a convex object-side surface in a paraxial region thereof.

7. The imaging lens system of claim 1, wherein the sixth lens has a convex object-side surface in a paraxial region thereof.

8. The imaging lens system of claim 1, wherein the sixth lens has a convex image-side surface in a paraxial region thereof.

9. The imaging lens system of claim 1, wherein the seventh lens has a concave object-side surface in a paraxial region thereof.

10. The imaging lens system of claim 1, wherein the image-side surface of the eighth lens is concave in a paraxial region thereof.

11. An imaging lens system comprising:
a first lens, a second lens, a third lens, a fourth lens, a fifth lens, a sixth lens, a seventh lens, and an eighth lens sequentially arranged in ascending numerical order along an optical axis of the imaging lens system from an object side of the imaging lens system toward an imaging plane of the imaging lens system,
wherein two adjacent lenses among the first to eighth lenses are bonded to each other, and
the imaging lens system satisfies the following conditional expression:
0.36<sumAG/f<0.50
where sumAG is a sum of air gaps along the optical axis between the first to eighth lenses, and f is a focal length of the imaging lens system.

12. The imaging lens system of claim 11, wherein the first lens has a convex object-side surface in a paraxial region thereof.

13. The imaging lens system of claim 11, wherein the second lens has a convex object-side surface in a paraxial region thereof.

14. The imaging lens system of claim 11, wherein the third lens has a convex object-side surface in a paraxial region thereof.

15. The imaging lens system of claim 11, wherein the fourth lens has a concave object-side surface in a paraxial region thereof.

16. The imaging lens system of claim 11, wherein the fifth lens has a convex object-side surface in a paraxial region thereof.

17. The imaging lens system of claim 11, wherein the sixth lens has a convex object-side surface in a paraxial region thereof.

18. The imaging lens system of claim 11, wherein the sixth lens has a convex image-side surface in a paraxial region thereof.

19. The imaging lens system of claim 11, wherein the seventh lens has a concave object-side surface in a paraxial region thereof.

20. The imaging lens system of claim 11, wherein the seventh lens has a convex image-side surface in a paraxial region thereof.
